(19) United States
(12) Patent Application Publication
(10) Pub. No.: US 2026/0094207 A1
(43) Pub. Date: Apr. 2, 2026

(54) COMPUTER-IMPLEMENTED SYSTEM AND METHOD FOR FACILITATING LOAN RECONCILIATION OF ORGANIZATIONS

(71) Applicant: iCreditWorks, Iselin, NJ (US)

(72) Inventors: Shankar R Iyer, East Windsor, NJ (US); Suresh G Nair, Robbinsville Twp, NJ (US); Stephen E Sweeney, Mahwah, NJ (US)

(21) Appl. No.: 19/413,055

(22) Filed: Dec. 9, 2025

Related U.S. Application Data
(63) Continuation-in-part of application No. 18/054,929, filed on Nov. 14, 2022.

(51) Int. Cl. G06Q 40/03

(52) U.S. Cl. CPC G06Q 40/034

(57) ABSTRACT

A computer-implemented system and method for facilitating loan reconciliation for multiple organizations is disclosed. The computer-implemented method includes receiving proof sheet templates, proof sheet rulebooks and proof sheet configurations of a loan settlement process from electronic devices, creating the proof sheets, and obtaining financial data defined in a rulebook. Further, the computer-implemented method includes creating a dynamic workbook, and loading workbook data as additional sheets. The computer-implemented method includes generating an interim fee for partners, detecting exceptions in the loan reconciliation, and outputting the generated interim fee, the created proof sheets and the detected exceptions on graphical user interface screen of the electronic devices. The computer-implemented system (i.e., a data loader subsystem and a data processing subsystem) is configured to be controlled through a no-code configuration interface for defining source criteria and dynamically generating rules associated with financial operations, without programming input.

### CROSS-REFERENCE TO RELATED APPLICATIONS

The present application is a continuation-in-part of U.S. patent application Ser. No. 18/054,929, filed on Nov. 14, 2022, and titled “SYSTEM AND METHOD FOR FACILITATING LOAN RECONCILIATION OF ORGANIZATIONS”, the above-identified application is fully incorporated herein by reference.

### FIELD OF INVENTION

Embodiments of the present disclosure relate to loan management systems, and more particularly relates to a computer-implemented system and method for facilitating loan reconciliation of organizations.

### BACKGROUND

Loan reconciliation is a crucial process for an organization as it helps the organization to track different types of loans on their balance sheet and ensure that their financial statements are accurate. Reconciliation verifies accuracy of a balance sheet by comparing a number on the company's general ledger to other forms of documentation, such as loans statements, bank statements, amortization schedules, and the like. Generally, the loan reconciliation is performed manually by multiple operators. However, manual loan reconciliation process is monotonous, expensive, time-consuming and error prone. Conventionally, there are multiple platforms to automatically reconcile loan process. However, conventional multiple platforms fail to provide full services loan application and administration capabilities in the mobile devices natively.

The complexity of modern loan reconciliation has increased significantly due to the involvement of multiple financial entities in loan transactions, including banks, capital partners, payment processors, and various intermediaries. Organizations must reconcile transactions across diverse channels such as Automated Clearing House (ACH) transfers, VISA payment networks, and other electronic payment systems, each with different data formats and timing requirements. The manual reconciliation process typically involves operators working with spreadsheet-based templates and custom formulas to validate loan funding flows, verify partner fee distributions, calculate settlement amounts, and detect exceptions such as duplicate transactions, missing entries, or timing discrepancies.

This manual approach becomes particularly challenging when handling high transaction volumes, multiple data sources with varying formats, and complex business rules that differ by loan product type or partner agreement. Additionally, the need to account for federal holidays, weekends, and partner-specific transaction timing further complicates the reconciliation process, often requiring specialized knowledge and creating bottlenecks in financial reporting cycles. The lack of integrated, mobile-native solutions means that financial operators cannot efficiently manage reconciliation processes remotely or access real-time exception handling capabilities, limiting organizational agility and responsiveness in today's fast-paced financial environment.

Hence, there is a need for an improved computer-implemented system and method for facilitating loan reconciliation of organizations, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented system for facilitating loan reconciliation for multiple organizations is disclosed. The computer-implemented system includes one or more hardware processors and a memory coupled to the one or more hardware processors. The memory includes a plurality of subsystems in the form of programmable instructions executable by the one or more hardware processors. The plurality of subsystems include an input receiver subsystem configured to receive at least one of: one or more proof sheet templates, one or more proof sheet rulebooks, and one or more proof sheet configurations of a loan settlement process from one or more electronic devices associated with one or more operators for modeling one or more proof sheets. The one or more proof sheet rulebooks include one or more rules to handle at least one of: one or more products differently, breakdown of fees, and final settlement amount to a bank and a provider. The plurality of subsystems also includes a proof sheet modeling subsystem configured to create the one or more proof sheets based on the received at least one of: one or more proof sheet definitions and reconciliation of one or more specific parts of the loan settlement process. The one or more rules for each line item in the one or more proof sheets are authored by the one or more operators one of: semantically and using one or more formulas.

The plurality of subsystems also include a data loader subsystem configured to obtain financial data defined in a rulebook for each of the created one or more proof sheets from one or more data sources based on configuration for each source using one or more adapters. In an embodiment, the one or more adapters comprise: a File Transfer Protocol (FTP) adapter, a Secure File Transfer Protocol (SFTP), an Application Program Interface (API) adapter, a Simple Storage Service (S3) adapter, a Relational Database Management System (RDBMS), and a script adapter. The one or more data sources comprise an Application Programming Interface (API), one or more ingest outbound files, and one or more inbound files, and wherein the one or more data sources are easily configured to obtain transactions and settlement files from the one or more data sources using one of a Graphical User Interface (GUI) file and a configuration file

Furthermore, the plurality of subsystems also include a data processing subsystem configured to create a dynamic workbook using the received at least one of: the one or more proof sheet templates, the one or more proof sheet rulebooks, and the one or more proof sheet configurations of the loan settlement process upon obtaining the financial data. For generating the dynamic workbook, the data processing subsystem is configured to: (a) load a copy of a template into the reconciliation engine, (b) generate a new dynamic workbook using a compiler and a parser, (c) parse each cell in the template to copy customized formats and formulas into the new dynamic workbook using the parser, (d) load data as reference sheets based on the one or more proof sheet configurations using the parser, (e) compile default formulas and convert each of the one or more rules to formulas using the compiler, (f) apply the one or more rules and the formulas to the reference data, (g) execute the formulas and copy the resulting data into the new dynamic workbook in the memory, and (h) generate the data for the new dynamic workbook in the memory.

The data processing subsystem is further configured to load workbook data as additional sheets from the one or more data sources into the generated dynamic workbook for updating the generated new dynamic workbook. Each of the one or more data sources is queried and filtered as per the one or more proof sheet configurations and formatted for consistencies based on or more formats to be added as sheets to the generated dynamic workbook. The one or more formats include datetime formats, and currency formats. Further, the data processing subsystem is further configured to generate an interim fee for one or more partners based on one or more fee parameters upon loading the workbook data. The one or more fee parameters include: federal holidays and weekends. Each rule for the one or more proof sheet rulebooks are loaded, parsed, and executed. The one or more rules correspond to semantic rules. The one or more rules are parsed and converted to machine-readable formulas and applied to a dataset and the output is applied to a target cell.

The data processing subsystem is further configured to evaluate the machine-readable formulas. The machine-readable formulas are interpreted in a machine-readable language. The data processing subsystem is further configured to apply the evaluated machine-readable formulas on the data dynamically to detect one or more data issues. The data processing subsystem is further configured to one of: include and exclude transactions based on one of: when the transactions are handled by each of the one or more partners and where the transactions are in process of money movement. The data processing subsystem is further configured to store the proof sheet templates, proof sheet rulebooks, proof sheet configurations, financial data defined in the rulebook, the dynamic workbook, the interim fee, and the one or more exceptions in cloud storage buckets.

The data loader subsystem and the data processing subsystem are configured to be controlled through a no-code configuration interface for defining source criteria and dynamically generating the one or more rules associated with financial operations, without programming input, by: (a) providing a graphical user interface comprising visual selection tools for specifying connections of the one or more data sources from the one or more adapters without requiring code syntax; (b) generating one or more configuration files in one or more financial formats based on user selections made through dropdown menus, forms, and point-and-click selections, for each of the one or more data sources; (c) adapting semantic rule authoring through a visual rule builder that accepts business terminology input and converts one or more semantic expressions into machine-readable rule definitions; (d) automatically translating the semantic rules into executable formulas using the rule parser and compiler without manual code generation; (e) providing real-time rule validation and syntax checking to determine whether the semantic rules conform to supported logic patterns; (f) adapting dynamic modification of the source criteria and rules through the graphical user interface without requiring at least one of: system restart and developer intervention; (g) storing one or more configuration parameters and the machine-readable rule definitions in the cloud storage buckets for persistent access across reconciliation sessions; and (h) automatically applying updated configurations and rules to subsequent proof sheet generation processes without manual code deployment.

The plurality of subsystems a data aggregator subsystem configured to detect one or more exceptions in the loan reconciliation by aggregating the one or more proof sheets based on the obtained financial data and the updated dynamic workbook. For detecting the one or more exceptions in the loan reconciliation, the data aggregator subsystem is configured to: (a) extract output values from the one or more proof sheets and integrate the extracted output values into final accounting statements and portfolio activity, (b) monitor transactions and files received from the one or more partners and the bank to orchestrate timing of creation of the one or more proof sheets, (c) identify the one or more exceptions based on the extracted output values, and the monitored transactions and files, by combining the one or more proof sheets, and (d) persist the identified one or more exceptions separately based on configuration-driven output and scheduling, by combining the one or more proof sheets. The reconciliation engine further comprises a dynamic script executor configured to inject runtime code for handling the one or more exceptions and computing one or more complex formulas associated with the one or more exceptions.

Furthermore, the plurality of subsystems a data output subsystem configured to provide the generated interim fee, the created one or more proof sheets and the detected one or more exceptions, as an output, on graphical user interface screen of the one or more electronic devices. The detected one or more exceptions are outputted in one or more output formats for allowing the one or more operators to handle exceptions and one or more aged reconciliation issues. The one or more output formats comprise native excel sheets with transaction data, Portable Document Formats (PDFs), dashboards and reports.

In an embodiment, the one or more proof sheets comprise a funding statement, and wherein the funding statement is configured to reconcile by: (a) verifying every loan funded is issued by the bank, involves tracing money transfers through one or more channels; and (b) validating loans purchased from the bank by capital partners of a firm, in compliance with one or more underwriting rules.

In another embodiment, for creating the one or more proof sheets, the proof sheet modeling subsystem is configured to: (a) receive the one or more proof sheet definitions from the input receiver subsystem, wherein the one or more proof sheet definitions indicate structural templates and formatting requirements for loan settlement reconciliation documents; (b) identify the one or more specific parts of the loan settlement process requiring the reconciliation, wherein the one or more specific parts comprise at least one of: loan funding flows, partner fee distributions, settlement amount computations, and transaction timing validations; (c) generate one or more proof sheet structures, by mapping each identified specific part of the loan settlement process to corresponding line items within the proof sheet framework, establishing data field relationships between one or more line items and the one or more available data sources, and generating computation hierarchies for interdependent line item computations; (d) adapt dual-mode rule authoring for each line item by providing a semantic authoring interface wherein the one or more operators define one or more logics using natural language expressions and financial terminology without programming syntax, and providing a formula-based authoring interface wherein the one or more operators create mathematical expressions and computational formulas using spreadsheet-like syntax; (e) process the semantically authored rules by parsing one or more semantic expressions to extract one or more logic components, converting the one or more logic components into machine-readable rule definitions indicating semantic rule syntax, and validating the semantic rule syntax against supported logic patterns; (f) process formula-based authored rules by validating mathematical formula syntax for computational accuracy, verifying one or more data field references within formulas correspond to the one or more available data sources, and checking formula dependencies to prevent circular computation references; (g) integrate the semantically authored rules and the formula-based authored rules, into the one or more proof sheet structures by associating each authored rule with its corresponding line item within the one or more proof sheets, establishing execution order for interdependent rule computations, and configuring one or more rule parameters based on the one or more specific parts of the loan settlement process being reconciled; (h) create the one or more proof sheets by applying the semantically authored rules and the formula-based authored rules, to populate the one or more line items with computed values, formatting line item presentations according to proof sheet definition requirements, and generating proof sheet metadata including creation timestamp, operator identification, and rule version information; and (i) validate the generated one or more proof sheets by verifying the one or more line items comprising at least one of: appropriate computed values and data references, confirming the one or more proof sheet structures match the received proof sheet definitions, and determining whether the generated one or more proof sheets accurately represent the reconciliation of the identified one or more specific parts of the loan settlement process.

In yet another embodiment, for loading the workbook data as the additional sheets into the generated new dynamic workbook for updating the generated new dynamic workbook, the data processing subsystem is further configured to: (a) identify the one or more data sources specified in the one or more proof sheet configurations for workbook data integration; (b) establish the one or more connections to each of the one or more data sources using the corresponding one or more adapters; (c) query each of the one or more data sources by applying one or more query parameters specified in the one or more proof sheet configurations to retrieve relevant financial data, executing data extraction operations based on the one or more proof sheet configurations for each source, and retrieving raw workbook data from each connected data source; (d) filter the retrieved workbook data by applying filtering criteria defined in the one or more proof sheet configurations to exclude irrelevant data records, selecting one or more data records that match the reconciliation requirements for the dynamic workbook, and removing duplicate and invalid data entries based on predefined data quality rules; (e) format the filtered workbook data for consistency by standardizing datetime formats across the one or more data sources to determine uniform temporal representation, normalizing currency formats to maintain consistent monetary value presentation, and applying additional formatting rules specified in the one or more formats to determine data compatibility; (f) generate the additional sheets within the generated new dynamic workbook by generating separate worksheet tabs for each data source to maintain data source traceability, structuring each additional sheet with appropriate column headers and data organization, and preserving data source metadata within each additional sheet for audit purposes; (g) populate the additional sheets by loading the formatted workbook data into the corresponding additional sheets within the generated new dynamic workbook, maintaining data integrity during the loading process to prevent data corruption, and establishing data relationships between the additional sheets and existing workbook content; (h) update the generated new dynamic workbook by integrating the additional sheets comprising the workbook data with existing dynamic workbook structure, refreshing formula computations that depend on newly loaded workbook data, and updating cross-sheet references to incorporate data from the additional sheets; and (i) validate the updated dynamic workbook by verifying successful integration of the additional sheets from the one or more data sources, confirming data consistency and format compliance across the additional sheets within the updated dynamic workbook, and determining whether the updated dynamic workbook maintains structural integrity for subsequent reconciliation processing.

In yet another embodiment, for generating the interim fee for the one or more partners based on the one or more fee parameters, the data processing subsystem is configured to: (a) identify the one or more partners who are active and eligible for interim fee computations from the loaded workbook data, based on partner-specific fee agreements; (b) extract transaction data associated with each of the one or more partners from the dynamic workbook, wherein the transaction data comprises at least one of: loan amounts, processing dates, and settlement timing information; (c) determine applicable fee computation periods by analyzing transaction processing dates against a federal holiday calendar to identify one or more transactions processed on the federal holidays, identifying the one or more transactions processed on the weekends by comparing the transaction processing dates against one or more weekend date patterns, and categorizing the one or more transactions into business day transactions, weekend transactions, and federal holiday transactions; (d) apply partner-specific fee rate structures based on the categorized one or more transactions, wherein the business day transactions are assessed standard fee rates, the weekend transactions are assessed premium fee rates higher than the assessed standard fee rates, the federal holiday transactions are assessed holiday premium rates; (e) determine the interim fee for each partner by multiplying one or more transaction amounts by applicable fee rates for each transaction category, aggregating fee amounts across the categorized one or more transaction for each partner, and applying at least one of: partner-specific fee caps, minimums, and adjustment factors, to determine the interim fee for each partner; (f) validate the determined interim fee against one or more predefined rules and one or more partner agreement parameters to determine fee accuracy; (g) generate one or more interim fee records comprising partner identification, fee amount, calculation basis, and applicable time period; and (h) store the generated interim fee records in the cloud storage buckets for subsequent reconciliation and partner settlement processes.

In yet another embodiment, the financial data comprises a set of financial files of the one or more financial formats.

In yet another embodiment, the one or more exceptions comprise duplicate transactions, missing transactions, transactions posted to a wrong account, accounting errors, timing differences, and lender errors.

In yet another embodiment, the data aggregator subsystem is configured to run the one or more proof sheet configurations based on one or more configuration parameters, and wherein the one or more configuration parameters comprise time, holiday rules, weekend rules and transaction timing of the one or more partners.

In yet another embodiment, the plurality of subsystems further comprises a loan reconciliation management subsystem configured to: (a) determine successful completion of the loan reconciliation process using the created one or more proof sheets, the obtained financial data and the updated dynamic workbook; and (b) output a notification corresponding to the successful completion of the loan reconciliation process on graphical user interface screen of the one or more electronic devices.

In accordance with another embodiment of the present disclosure, a computer-implemented method for facilitating loan reconciliation for multiple organizations is disclosed. The computer-implemented method includes receiving at least one of: one or more proof sheet templates, one or more proof sheet rulebooks, and one or more proof sheet configurations of a loan settlement process from one or more electronic devices associated with one or more operators for modeling one or more proof sheets. The one or more proof sheet rulebooks include one or more rules to handle at least one of: one or more products differently, breakdown of fees, and final settlement amount to a bank and a provider. The computer-implemented method further creating the one or more proof sheets based on the received at least one of: one or more proof sheet definitions and reconciliation of one or more specific parts of the loan settlement process. The one or more rules for each line item in the one or more proof sheets are authored by the one or more operators one of: semantically and using one or more formulas.

Further, the computer-implemented method includes obtaining financial data defined in a rulebook for each of the created one or more proof sheets from one or more data sources based on configuration for each source using one or more adapters. The one or more adapters comprise: a File Transfer Protocol (FTP) adapter, a Secure File Transfer Protocol (SFTP), an Application Program Interface (API) adapter, a Simple Storage Service (S3) adapter, a Relational Database Management System (RDBMS), and a script adapter. The one or more data sources comprise an Application Programming Interface (API), one or more ingest outbound files, and one or more inbound files, and wherein the one or more data sources are easily configured to obtain transactions and settlement files from the one or more data sources using one of a Graphical User Interface (GUI) file and a configuration file. Furthermore, the computer-implemented method includes generating a dynamic workbook using the received at least one of: the one or more proof sheet templates, the one or more proof sheet rulebooks, and the one or more proof sheet configurations of the loan settlement process upon obtaining the financial data. In an embodiment, generating the dynamic workbook is implemented by a container orchestration cluster using steps comprising: (a) loading a copy of a template into the reconciliation engine, (b) generating a new dynamic workbook using a compiler and a parser, (c) loading data as reference sheets based on the one or more proof sheet configurations using the parser, (d) compiling default formulas and convert each of the one or more rules to formulas using the compiler, (e) applying the one or more rules and the formulas to the reference data, (f) executing the formulas and copy the resulting data into the new dynamic workbook in the memory, and (g) generating the data for the new dynamic workbook in the memory.

Further, the computer-implemented method includes loading workbook data as additional sheets from the one or more data sources into the generated dynamic workbook for updating the generated new dynamic workbook. Each of the one or more data sources is queried and filtered as per the one or more proof sheet configurations and formatted for consistencies based on or more formats to be added as sheets to the generated dynamic workbook. The one or more formats comprise: datetime formats, and currency formats.

The computer-implemented method further includes generating an interim fee for one or more partners based on one or more fee parameters upon loading the workbook data. The one or more fee parameters include: federal holidays and weekends. Each rule for the one or more proof sheet rulebooks are loaded, parsed, and executed. The one or more rules correspond to semantic rules. The one or more rules are parsed and converted to machine-readable formulas and applied to a dataset and the output is applied to a target cell. The computer-implemented method further includes evaluating the machine-readable formulas. The machine-readable formulas are interpreted in a machine-readable language. The computer-implemented method further includes applying the evaluated machine-readable formulas on the data dynamically to detect one or more data issues. The computer-implemented method further includes one of: including and excluding transactions based on one of: when the transactions are handled by each of the one or more partners and where the transactions are in process of money movement. The computer-implemented method further includes storing the proof sheet templates, proof sheet rulebooks, proof sheet configurations, financial data defined in the rulebook, the dynamic workbook, the interim fee, and the one or more exceptions in cloud storage buckets.

In an embodiment, obtaining the financial data and processing the dynamic workbook, are configured to be controlled through a no-code configuration interface for defining source criteria and dynamically generating the one or more rules associated with financial operations, without programming input, by: (a) providing a graphical user interface comprising visual selection tools for specifying connections of the one or more data sources from the one or more adapters without requiring code syntax, (b) generating one or more configuration files in one or more financial formats based on user selections made through dropdown menus, forms, and point-and-click selections, for each of the one or more data sources, (c) adapting semantic rule authoring through a visual rule builder that accepts business terminology input and converts one or more semantic expressions into machine-readable rule definitions, (d) automatically translating the semantic rules into executable formulas using the rule parser and compiler without manual code generation, (e) providing real-time rule validation and syntax checking to determine whether the semantic rules conform to supported logic patterns, (f) adapting dynamic modification of the source criteria and rules through the graphical user interface without requiring at least one of: system restart and developer intervention, (g) storing one or more configuration parameters and the machine-readable rule definitions in the cloud storage buckets for persistent access across reconciliation sessions, and (h) automatically applying updated configurations and rules to subsequent proof sheet generation processes without manual code deployment.

The computer-implemented method includes detecting one or more exceptions in the loan reconciliation by aggregating the one or more proof sheets based on the obtained financial data and the updated dynamic workbook. In an embodiment, detecting the one or more exceptions comprises: (a) extracting output values from the one or more proof sheets and integrating the extracted output values into final accounting statements and portfolio activity, (b) monitoring transactions and files received from the one or more partners and the bank to orchestrate timing of creation of the one or more proof sheets, (c) identifying the one or more exceptions based on the extracted output values, and the monitored transactions and files, by combining the one or more proof sheets, and (d) persisting the identified one or more exceptions separately based on configuration-driven output and scheduling, by combining the one or more proof sheets. The reconciliation engine further comprises a dynamic script executor configured to inject runtime code for handling the one or more exceptions and computing one or more complex formulas associated with the one or more exceptions.

Furthermore, the computer-implemented method includes providing the generated interim fee, the created one or more proof sheets and the detected one or more exceptions, as an output, on graphical user interface screen of the one or more electronic devices. The detected one or more exceptions are outputted in one or more output formats for allowing the one or more operators to handle exceptions and one or more aged reconciliation issues. The one or more output formats comprise native excel sheets with transaction data, Portable Document Formats (PDFs), dashboards and reports.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment depicting a computer-implemented system for facilitating loan reconciliation for one or more organizations, in accordance with an embodiment of the present disclosure;

FIG. 2 is a detailed view of the computer-implemented system for facilitating the loan reconciliation of the one or more organizations, in accordance with an embodiment of the present disclosure;

FIG. 3A is a block diagram illustrating an exemplary operation of the computer-implemented system for facilitating the loan reconciliation of the one or more organizations, in accordance with an embodiment of the present disclosure;

FIG. 3B is a pictorial depiction illustrating an exemplary operation of the computer-implemented system for facilitating the loan reconciliation of the one or more organizations, in accordance with an embodiment of the present disclosure;

FIG. 4 is a pictorial depiction illustrating an exemplary proof sheet, in accordance with an embodiment of the present disclosure; and

FIG. 5 is a process flow diagram illustrating an exemplary computer-implemented method for facilitating the loan reconciliation of one or more organizations, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

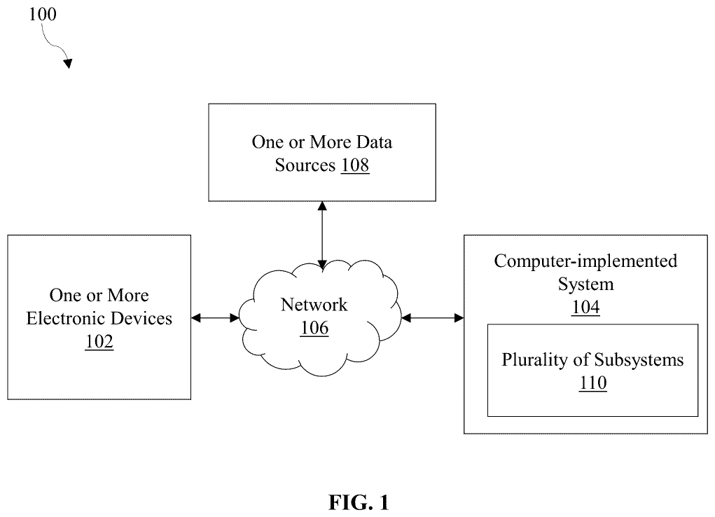

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating a computing environment 100 depicting a computer-implemented system 104 for facilitating loan reconciliation for one or more organizations, in accordance with an embodiment of the present disclosure. According to FIG. 1, the computing environment 100 includes one or more electronic devices 102 associated with one or more operators communicatively coupled to a computer-implemented system 104 via a network 106. The one or more electronic devices 102 are configured to provide one or more proof sheet templates, one or more proof sheet rulebooks, one or more proof sheet configurations or a combination thereof, of a loan settlement process to the computer-implemented system 104. In an embodiment of the present disclosure, the one or more electronic devices 102 are also used to receive an interim fee, one or more proof sheets and one or more exceptions from the computer-implemented system 104. In an exemplary embodiment of the present disclosure, the one or more electronic devices 102 may include laptop computer, desktop computer, tablet computer, smartphone, wearable device, a digital camera and the like. Further, the network 106 may be internet or any other wireless network 106. The computer-implemented system 104 may be hosted on a central server, such as cloud server or a remote server.

Further, the computing environment 100 includes one or more data sources 108 communicatively coupled to the computer-implemented system 104 via the network 106. In an embodiment of the present disclosure, financial data defined in a rulebook is obtained for each of the one or more proof sheets from the one or more data sources 108 using one or more adapters.

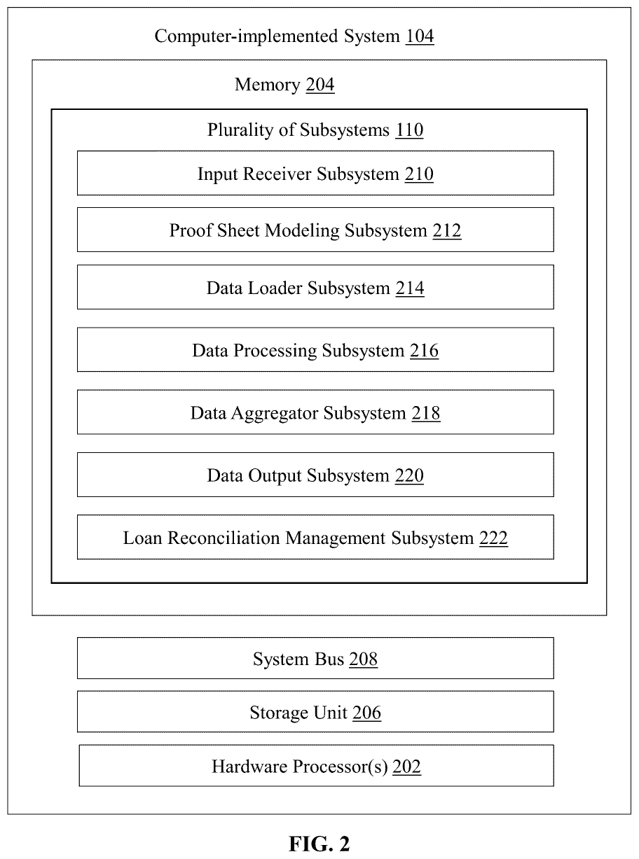

Furthermore, the one or more electronic devices 102 include a local browser, a mobile application or a combination thereof. Furthermore, the one or more operators may use a web application via the local browser, the mobile application or a combination thereof to communicate with the computer-implemented system 104. In an exemplary embodiment of the present disclosure, the mobile application may be compatible with any mobile operating system, such as android, iOS, and the like. In an embodiment of the present disclosure, the computer-implemented system 104 includes a plurality of subsystems 110. Details on the plurality of subsystems 110 have been elaborated in subsequent paragraphs of the present description with reference to FIG. 2.

In an embodiment of the present disclosure, the computer-implemented system 104 is configured to receive one or more proof sheet templates, one or more proof sheet rulebooks, one or more proof sheet configurations, or any combination thereof, of the loan settlement process from the one or more electronic devices 102 associated with the one or more operators for modeling the one or more proof sheets. The one or more proof sheet rulebooks include one or more rules to handle one or more products differently, breakdown of fees, final settlement amount to a bank and a provider, or any combination thereof. Further, the computer-implemented system 104 is configured to create the one or more proof sheets based on the received at least one of: one or more proof sheet definitions, reconciliation of one or more specific parts of the loan settlement process, or a combination thereof. The one or more rules for each line item in the one or more proof sheets are authored by the one or more operators semantically or using one or more formulas.

Furthermore, the computer-implemented system 104 is configured to obtain financial data defined in a rulebook for each of the created one or more proof sheets from one or more data sources 108 based on configuration for each source using one or more adapters. In an embodiment, the one or more adapters may include at least one of: a File Transfer Protocol (FTP) adapter, a Secure File Transfer Protocol (SFTP), an Application Program Interface (API) adapter, a Simple Storage Service (S3) adapter, a Relational Database Management System (RDBMS), and a script adapter. In an embodiment, the one or more data sources 108 may include at least one of: an Application Programming Interface (API), one or more ingest outbound files, and one or more inbound files. The one or more data sources are easily configured to obtain transactions and settlement files from the one or more data sources 108 using one of a Graphical User Interface (GUI) file and a configuration file. The computer-implemented system 104 is further configured to generate a dynamic workbook using the received at least one of: the one or more proof sheet templates, the one or more proof sheet rulebooks, and the one or more proof sheet configurations of the loan settlement process, or any combination thereof upon obtaining the financial data. For generating the dynamic workbook, the computer-implemented system 104 is configured to: (a) load a copy of a template into the reconciliation engine, (b) generate a new dynamic workbook using a compiler and a parser, (c) parse each cell in the template to copy customized formats and formulas into the new dynamic workbook using the parser, (d) load data as reference sheets based on the one or more proof sheet configurations using the parser, (e) compile default formulas and convert each of the one or more rules to formulas using the compiler, (f) apply the one or more rules and the formulas to the reference data, (g) execute the formulas and copy the resulting data into the new dynamic workbook in the memory, and (h) generate the data for the new dynamic workbook in the memory.

The computer-implemented system 104 loads workbook data as additional sheets from the one or more data sources 108 into the generated dynamic workbook for updating the generated new dynamic workbook. Each of the one or more data sources 108 is queried and filtered as per the one or more proof sheet configurations and formatted for consistencies based on or more formats to be added as sheets to the generated dynamic workbook. The one or more formats include datetime formats, and currency formats. Further, the computer-implemented system 104 is configured to generate an interim fee for one or more partners based on one or more fee parameters upon loading the workbook data. The one or more fee parameters include federal holidays and weekends. Each rule for the one or more proof sheet rulebooks are loaded, parsed, and executed. The one or more rules correspond to semantic rules. The one or more rules are parsed and converted to machine-readable formulas and applied to a dataset and the output is applied to a target cell. The computer-implemented system 104 is further configured to evaluate the machine-readable formulas. The machine-readable formulas are interpreted in a machine-readable language. The computer-implemented system 104 is further configured to apply the evaluated machine-readable formulas on the data dynamically to detect one or more data issues. The computer-implemented system 104 is further configured to one of: include and exclude transactions based on one of: when the transactions are handled by each of the one or more partners and where the transactions are in process of money movement. The computer-implemented system 104 is further configured to store the proof sheet templates, proof sheet rulebooks, proof sheet configurations, financial data defined in the rulebook, the dynamic workbook, the interim fee, and the one or more exceptions in cloud storage buckets.

In an embodiment, obtaining the financial data and processing the dynamic workbook, are configured to be controlled through a no-code configuration interface for defining source criteria and dynamically generating the one or more rules associated with financial operations, without programming input, by: (a) providing a graphical user interface comprising visual selection tools for specifying connections of the one or more data sources from the one or more adapters without requiring code syntax; (b) generating one or more configuration files in one or more financial formats based on user selections made through dropdown menus, forms, and point-and-click selections, for each of the one or more data sources; (c) adapting semantic rule authoring through a visual rule builder that accepts business terminology input and converts one or more semantic expressions into machine-readable rule definitions; (d) automatically translating the semantic rules into executable formulas using the rule parser and compiler without manual code generation; (e) providing real-time rule validation and syntax checking to determine whether the semantic rules conform to supported logic patterns; (f) adapting dynamic modification of the source criteria and rules through the graphical user interface without requiring at least one of: system restart and developer intervention; (g) storing one or more configuration parameters and the machine-readable rule definitions in the cloud storage buckets for persistent access across reconciliation sessions; and (h) automatically applying updated configurations and rules to subsequent proof sheet generation processes without manual code deployment.

The computer-implemented system 104 is configured to detect one or more exceptions in the loan reconciliation by aggregating the one or more proof sheets based on the obtained financial data and the updated dynamic workbook. For detecting the one or more exceptions in the loan reconciliation, the data aggregator subsystem is configured to: (a) extract output values from the one or more proof sheets and integrate the extracted output values into final accounting statements and portfolio activity, (b) monitor transactions and files received from the one or more partners and the bank to orchestrate timing of creation of the one or more proof sheets, (c) identify the one or more exceptions based on the extracted output values, and the monitored transactions and files, by combining the one or more proof sheets, and (d) persist the identified one or more exceptions separately based on configuration-driven output and scheduling, by combining the one or more proof sheets. The reconciliation engine further comprises a dynamic script executor configured to inject runtime code for handling the one or more exceptions and computing one or more complex formulas associated with the one or more exceptions.

Further, the computer-implemented system 104 is configured to provide the generated interim fee, the created one or more proof sheets and the detected one or more exceptions, as an output, on graphical user interface screen of the one or more electronic devices 102. The detected one or more exceptions are outputted in one or more output formats for allowing the one or more operators to handle exceptions and one or more aged reconciliation issues. In an exemplary embodiment of the present disclosure, the one or more output formats comprise native excel sheets with transaction data, Portable Document Formats (PDFs), dashboards, reports, and the like.

FIG. 2 is a detailed view of the computer-implemented system 104 for facilitating the loan reconciliation of the one or more organizations, in accordance with an embodiment of the present disclosure. Further, the computer-implemented system 104 includes one or more hardware processors 202, a memory 204 and a storage unit 206. The one or more hardware processors 202, the memory 204, and the storage unit 206, are communicatively coupled through a system bus 208 or any similar mechanism. The memory 204 comprises the plurality of subsystems 110 in the form of programmable instructions executable by the one or more hardware processors 202. Further, the plurality of subsystems 110 includes an input receiver subsystem 210, a proof sheet modeling subsystem 212, a rulebook authoring subsystem (not shown in FIG. 2), a data loader subsystem 214, a data processing subsystem 216, a data aggregator subsystem 218, a data output subsystem 220, and a loan reconciliation management subsystem 222.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of subsystems 110 stored in the form of machine-readable instructions on any of the above-mentioned storage media and may be in communication with and executed by the one or more hardware processors 202.

In an embodiment of the present disclosure, the storage unit 206 may be a cloud storage. The storage unit 206 may store the one or more proof sheet templates, the one or more proof sheet rulebooks, the one or more proof sheet configurations, the financial data defined in the rulebook, the dynamic workbook, the interim fee, the one or more exceptions, and the like.

The plurality of subsystems 110 includes the input receiver subsystem 210 that is communicatively connected to the one or more hardware processors 202. The input receiver subsystem 210 is configured to receive the one or more proof sheet templates, the one or more proof sheet rulebooks, the one or more proof sheet configurations of the loan settlement process, or any combination thereof from the one or more electronic devices 102 associated with the one or more operators for modeling the one or more proof sheets. The one or more proof sheet templates correspond to standard excel templates for each money movement step. For example, the funding statement template relates to the flow of money between various partners and the borrower. Further, the one or more proof sheet rulebooks correspond to custom iCreditWorks excel formulas written for each line item in the template. Furthermore, the one or more proof sheet configurations correspond to each of the configurations mapped to each proof sheet for the formulas to pull relevant datasets for execution. In an exemplary embodiment of the present disclosure, the one or more proof sheet rulebooks include one or more rules to handle one or more products differently, breakdown of fees, final settlement amount to a bank and a provider, or any combination thereof. The one or more rules are configurable business logic instructions that define how financial data should be processed, calculated, and validated during the loan reconciliation process, encompassing conditional statements, mathematical formulas, and decision criteria that govern the automated handling of loan transactions, fee calculations, and settlement determinations. The one or more products define that the one or more rules which apply distinct processing logic, calculations, or validation criteria based on the specific type of loan product being reconciled, such as mortgages, personal loans, auto loans, or business loans, where each product type may have unique fee structures, settlement timelines, or regulatory requirements. The breakdown of fees defines that the one or more rules specify how various charges and fees associated with loan transactions should be calculated, allocated, and distributed among different parties (banks, partners, providers), including processing fees, origination fees, service fees, and other transaction-related costs. The final settlement amount defines that the one or more rules determine the ultimate monetary amount owed to a bank and a provider after all loan transactions, fees, adjustments, and reconciliation calculations have been processed and validated, representing the net financial obligation between parties in the loan settlement process.

In an exemplary embodiment of the present disclosure, the one or more rules include transaction rules such as, the transaction posting to clearing window should be equal to 3 business days. If a funding is authorized after 4 PM the purchase is wired to the next business day and the like. In an exemplary embodiment of the present disclosure, the one or more electronic devices 102 may include a laptop computer, desktop computer, tablet computer, smartphone, wearable device, a digital camera and the like.

For example, consider a daily loan reconciliation scenario where a financial organization uses the one or more proof sheet templates such as a blank “Funding Statement” Excel spreadsheet with predefined columns for Loan ID, Amount, Bank, Partner, and Fees that serves as the structural framework. The one or more proof sheet rulebooks contain business logic like “if loan amount exceeds $50,000, apply 1.5% processing fee” or “if transaction occurs on weekend, charge premium rate of 2%” which define how calculations should be performed. The one or more proof sheet configurations specify operational parameters such as “run reconciliation daily at 6 AM,” “pull data from Bank API and Partner FTP server,” “exclude federal holidays,” and “output results in Excel and PDF formats” which control when and how the reconciliation process executes. Together, these three components work as an integrated system where the template provides the structure, the rulebook provides the calculation logic, and the configuration provides the execution parameters, enabling the computer-implemented system 104 to automatically generate a completed funding statement each morning that shows all loan transactions with calculated fees, detected exceptions, and proper formatting for the loan settlement process between banks, partners, and borrowers.

The plurality of subsystems 110 further includes the proof sheet modeling subsystem 212 that is communicatively connected to the one or more hardware processors 202. The proof sheet modeling subsystem 212 is configured to create the one or more proof sheets based on the received at least one of: one or more proof sheet definitions, reconciliation of one or more specific parts of the loan settlement process, or a combination thereof. The one or more proof sheet definitions are structural specifications that define the format, layout, and data requirements for reconciliation documents, such as a “Funding Statement Definition” that specifies columns for loan ID, amount, bank partner, processing date, and fee calculations with required data types and formatting rules. The reconciliation of one or more specific parts of the loan settlement process refers to the validation and verification of distinct components within the overall loan transaction lifecycle, such as reconciling the loan funding flow (verifying that every loan funded by ABC Bank matches the borrower's account credits), reconciling partner fee distributions (ensuring XYZ Capital Partner received correct 1.5% processing fees), or reconciling settlement timing (confirming that weekend transactions were processed with appropriate premium rates). For example, when creating proof sheets, the proof sheet modeling subsystem 212 takes a “Daily Funding Statement Definition” that requires loan amount, partner name, and fee calculation columns, then applies this structure to reconcile the specific loan funding flow part of the settlement process by verifying that $100,000 loan funded by WebBank to Borrower Smith matches the ACH transfer records and that Capital Partner DEF correctly purchased this loan with a 2% weekend premium fee, ultimately generating a completed proof sheet that serves as evidence that this specific part of the loan settlement process has been properly reconciled and validated.

The creation of the one or more proof sheets adheres to the following method. Initially the Reconciliation engine loads the template, leverages the configurations, and pulls all data or transactions from various files and systems. Further, the reconciliation engine applies the rules on the data and populates the template with the values using the formulas thereby creating the one or more proof sheets. In an embodiment of the present disclosure, the one or more rules for each line item in the one or more proof sheets are authored by the one or more operators semantically or using one or more formulas based on two modes of creation. The first mode of creation includes authoring of simple formulas in excel using empty datasets semantically creating complex rules. For example $funding. $partner. $status. The second mode of creation includes interpreting the complex rules by the engine at runtime before populating the template. For example, the one or more proof sheets include a funding statement. In an embodiment of the present disclosure, the funding statement reconciles if every loan funded is issued by the bank by tracing money transfers via one or more channels. Further, the funding statement reconciles if capital partners of a firm purchased one or more loans from the bank based on one or more underwriting rules. In an exemplary embodiment of the present disclosure, the one or more channels include Automated Clearing House (ACH), Visa International Service Association (VISA), and the like. In an embodiment of the present disclosure, the proof sheet modeling subsystem 212 defines output template of how reconciliation should look like. For example, the funding statement reconciles if every loan funded is issued by WebBank by tracing the money transfers via different channels, such as ACH, VISA, and the like and if capital partners purchased the loans from the WebBank based on the underwriting rules.

In other aspect, for creating the one or more proof sheets, the proof sheet modeling subsystem 212 is configured to receive the one or more proof sheet definitions from the input receiver subsystem 210. The one or more proof sheet definitions indicate structural templates and formatting requirements for loan settlement reconciliation documents. The structural templates are predefined organizational frameworks that specify the layout, column arrangements, and data field positioning for loan reconciliation documents. The formatting requirements are specifications that dictate the visual presentation standards, data type formats, and display criteria that reconciliation documents must adhere to for consistency and compliance.

For example, when the proof sheet modeling subsystem 212 receives proof sheet definitions from the input receiver subsystem 210, the proof sheet modeling subsystem 212 might receive a “Daily Funding Reconciliation Definition” that specifies structural templates requiring a header section with company logo and report date, followed by data columns arranged as Loan ID, Borrower Name, Loan Amount, Funding Bank, Capital Partner, Processing Date, Fee Amount, and Settlement Status, concluded by a summary section showing total loans funded and net settlement amounts, along with formatting requirements that dictate loan amounts must appear in currency format with dollar signs and two decimal places ($50,000.00), processing dates must follow MM/DD/YYYY format (01/15/2025), fee percentages must display three decimal places (1.500%), headers must use bold 14-point Arial font, data rows must alternate between white and light grey backgrounds for readability, monetary values must be right-aligned while text fields remain left-aligned, and required fields must appear in bold with red asterisks, ensuring that the resulting loan settlement reconciliation documents maintain professional presentation standards and regulatory compliance formatting across all generated proof sheets.

For creating the one or more proof sheets, the proof sheet modeling subsystem 212 is further configured to identify the one or more specific parts of the loan settlement process requiring the reconciliation. The one or more specific parts may include at least one of: loan funding flows, partner fee distributions, settlement amount computations, and transaction timing validations. The one or more specific parts are individual components or segments within the overall loan settlement process that require separate validation and reconciliation, such as funding verification, fee calculations, or payment timing checks. The loan funding flows are the movement of money from lenders to borrowers and between financial institutions during loan origination and settlement. The partner fee distributions are the allocation and payment of various charges among banks, capital partners, and service providers involved in loan transactions. The settlement amount computations are the calculations that determine final net amounts owed between parties after all transactions, fees, and adjustments. The transaction timing validations are verifications that ensure all loan-related activities occur within proper timeframes and business day constraints.

The proof sheet modeling subsystem 212 systematically analyzes the loan settlement workflow to pinpoint which specific components require reconciliation by examining transaction data patterns, partner agreements, regulatory requirements, and business rules to determine whether loan funding needs verification (checking money movement accuracy), partner fees need validation (ensuring correct fee calculations and distributions), settlement amounts need computation (calculating final balances), or transaction timing needs validation (confirming proper processing schedules), then maps these identified requirements to corresponding proof sheet structures and rule sets. For example, in a typical loan settlement scenario, the proof sheet modeling subsystem 212 might identify that a $100,000 mortgage transaction requires reconciliation of loan funding flows (verifying that Wells Fargo funded the loan and the borrower received the correct amount via ACH transfer), partner fee distributions (ensuring that Capital Partner ABC received their 1.5% acquisition fee of $1,500 and the loan servicer received their $200 processing fee), settlement amount computations (calculating that Wells Fargo should receive $98,300 net settlement after deducting partner fees), and transaction timing validations (confirming the loan funded on a business day and settlement occurred within the required 3-day clearing window, not on a federal holiday), with each identified component becoming a specific section within the generated proof sheet that provides documented evidence of proper reconciliation.

For creating the one or more proof sheets, the proof sheet modeling subsystem 212 is configured to generate one or more proof sheet structures, by mapping each identified specific part of the loan settlement process to corresponding line items within the proof sheet framework, establishing data field relationships between one or more line items and the one or more available data sources, and generating computation hierarchies for interdependent line item computations. The proof sheet structures are organized frameworks that define how reconciliation data will be arranged and presented in the final document. Generating the one or more proof sheet structures is the process of creating organized document frameworks that systematically arrange loan settlement data into a coherent reconciliation format. Mapping each identified specific part to corresponding line items means assigning each loan settlement component (like funding verification or fee calculation) to a specific row or entry position within the proof sheet document. Establishing the data field relationships means creating direct connections between each line item and the specific data sources that will provide the information needed to populate that line item. Generating the computation hierarchies means organizing line items into a logical calculation sequence where dependent computations are performed in the correct order. The proof sheet framework is the overall document structure that contains all line items in an organized format. The one or more available data sources are the various databases, APIs, files, and systems that contain the financial information needed for reconciliation. The interdependent line item computations are calculations where one line item's result is required as input for another line item's calculation.

The proof sheet modeling subsystem 212 systematically transforms abstract loan settlement requirements into concrete document structures by first taking each identified settlement component (such as “verify loan principal disbursement” or “calculate partner acquisition fee”) and assigning it to a numbered line item position within the proof sheet (creating “Line Item 3: Principal Disbursed” and “Line Item 7: Partner Fee”), then establishing precise data field relationships by connecting each line item to its required data source (linking Line Item 3 to the bank's loan database field “disbursement_amount” and Line Item 7 to the partner agreement table field “fee_percentage”), and finally analyzing interdependencies between line items to generate computation hierarchies that ensure calculations occur in proper sequence (determining that Line Item 3 must retrieve principal amount before Line Item 7 can calculate percentage-based fees, and both must complete before Line Item 12 can compute net settlement amounts).

For example, when processing a $75,000 mortgage settlement, the proof sheet modeling subsystem 212 maps the loan funding verification component to “Line Item 6: Mortgage Principal Disbursed” within the proof sheet framework, establishes data field relationships by connecting Line Item 6 to First National Bank's mortgage\_loans.principal\_amount database field, maps the mortgage broker fee component to “Line Item 10: Broker Commission (2.5%)” and connects it to the broker\_agreements.commission\_rate table, maps the title company fee to “Line Item 11: Title Fee ($500)” and connects it to the title\_services. standard\_fee configuration file, then generates computation hierarchies by determining that Line Item 6 must execute first to retrieve $75,000 from the bank database, followed by Line Item 10 which depends on Line Item 6's value to calculate the $1,875 broker commission (2.5% of $75,000), while Line Item 11 can execute independently to retrieve the $500 title fee, and finally Line Item 15 “Net Amount to Lender” requires Line Items 6, 10, and 11 to be completed before computing the final settlement amount of $72,625 ($75,000-$1,875-$500), creating a structured proof sheet where each mortgage settlement component is properly mapped to specific line items, connected to appropriate data sources, and organized in correct computational dependency order that respects both mathematical relationships and business logic requirements.

For creating the one or more proof sheets, the proof sheet modeling subsystem 212 is configured to adapt dual-mode rule authoring for each line item by providing a semantic authoring interface wherein the one or more operators define one or more logics using natural language expressions and financial terminology without programming syntax, and providing a formula-based authoring interface wherein the one or more operators create mathematical expressions and computational formulas using spreadsheet-like syntax. Adapting the dual-mode rule authoring for each line item means implementing two distinct methods for operators to create business rules that will govern how each line item in the proof sheet calculates its values. The semantic authoring interface is a user-friendly system that allows operators to write business rules using plain English and financial terminology without requiring programming knowledge. The natural language expressions are rule statements written in everyday business language that describe logic conditions and actions. The financial terminology refers to industry-specific terms like “funding,” “settlement,” “partner,” and “fee” that operators naturally use in their work. The formula-based authoring interface is a technical system that enables operators to create mathematical expressions using spreadsheet-like syntax similar to Excel formulas. mathematical expressions are numerical calculations and logical operations written in formula format. The computational formulas are structured mathematical statements that perform calculations on data values using spreadsheet-like syntax.

The proof sheet modeling subsystem 212 enables flexible rule creation by providing two complementary authoring modes for each line item, where the semantic authoring interface allows business-oriented operators to define logic using familiar financial language such as writing “if funding partner is ABC Bank and transaction occurs on weekend then apply premium rate of 2%” without needing to understand programming syntax, while simultaneously offering a formula-based authoring interface that enables technically-skilled operators to create precise mathematical expressions using spreadsheet-like syntax such as “=IF(AND(Partner=‘ABC Bank’, WEEKDAY(ProcessDate)>5), Amount0.02, Amount0.015)” for the same business rule, with both interfaces targeting the same line item but accommodating different operator skill levels and preferences.

For example, when configuring Line Item 8 “Partner Processing Fee” in a loan reconciliation proof sheet, an operations manager using the semantic authoring interface might write the rule as “If loan amount exceeds fifty thousand dollars and partner is Capital Finance Group and processing occurs during weekend then calculate fee as two point five percent of loan amount otherwise use standard rate of one point eight percent,” while a financial analyst using the formula-based authoring interface would create the same logic as “=IF(AND(LoanAmount>50000, Partner=‘Capital Finance Group’, WEEKDAY(ProcessDate) IN (1,7)), LoanAmount0.025, LoanAmount0.018),” with both approaches ultimately generating identical computational results for Line Item 8 but allowing operators to author rules using their preferred method—natural language expressions with financial terminology for business users or mathematical expressions with spreadsheet-like syntax for technical users—ensuring that all operators can effectively contribute to rule creation regardless of their technical background while maintaining consistent line item calculation logic across the proof sheet.

For creating the one or more proof sheets, the proof sheet modeling subsystem 212 is configured to process the semantically authored rules by parsing one or more semantic expressions to extract one or more logic components, converting the one or more logic components into machine-readable rule definitions indicating semantic rule syntax, and validating the semantic rule syntax against supported logic patterns. Processing the semantically authored rules means systematically analyzing and transforming business rules written in natural language into executable computer instructions. Parsing one or more semantic expressions involves breaking down natural language rule statements into their individual logical components and identifying key elements like conditions, actions, and operators. Extracting one or more logic components means isolating specific parts of the semantic expression such as conditional statements, comparison operators, data references, and action instructions. Converting the one or more logic components into machine-readable rule definitions involves translating the extracted logical elements into structured computer code or formula syntax that the proof sheet modeling subsystem 212 can execute. The semantic rule syntax refers to the standardized format and structure that semantic expressions must follow to be properly interpreted by the proof sheet modeling subsystem 212. Validating the semantic rule syntax against supported logic patterns means checking that the converted rules conform to predefined templates and logical structures that the system can reliably process.

The proof sheet modeling subsystem 212 processes semantically authored rules through a systematic transformation pipeline that begins by parsing natural language expressions to identify and extract discrete logic components such as conditional clauses (“if loan amount exceeds fifty thousand”), comparison operators (“greater than,” “equals,” “during”), data field references (“loan amount,” “partner name,” “processing date”), and action statements (“apply premium rate,” “calculate fee”), then converts these extracted components into machine-readable rule definitions by mapping natural language terms to system variables and translating business logic into executable syntax while maintaining the semantic rule structure, and finally validates the converted syntax against a library of supported logic patterns to ensure the rule can be properly executed without errors or ambiguities. For example, when processing the semantically authored rule “If loan amount exceeds fifty thousand dollars and partner is Capital Finance Group and processing occurs during weekend then calculate fee as two point five percent of loan amount otherwise use standard rate of one point eight percent,” the proof sheet modeling subsystem 212 parses this semantic expression to extract logic components including three conditional clauses (loan amount>50000, partner=‘Capital Finance Group’, processing date is weekend), two action statements (calculate 2.5% fee, calculate 1.8% fee), and logical operators (AND, IF-THEN-ELSE), then converts these components into machine-readable rule definitions such as “IF(AND(LoanAmount>50000, Partner=‘Capital Finance Group’, WEEKDAY(ProcessDate) IN (1,7)), LoanAmount0.025, LoanAmount0.018)” while indicating the semantic rule syntax structure as a conditional statement with compound conditions and alternative actions, and finally validates this converted syntax against supported logic patterns to confirm it matches the system's recognized template for “conditional fee calculation with multiple criteria and alternative outcomes,” ensuring the rule can be reliably executed during proof sheet processing while maintaining the original business intent expressed in the semantic authoring interface.

For creating the one or more proof sheets, the proof sheet modeling subsystem 212 is configured to process formula-based authored rules by validating mathematical formula syntax for computational accuracy, verifying one or more data field references within formulas correspond to the one or more available data sources, and checking formula dependencies to prevent circular computation references. Processing the formula-based authored rules means systematically analyzing and validating mathematical expressions created by operators using spreadsheet-like syntax to ensure they can be properly executed. Validating the mathematical formula syntax for computational accuracy involves checking that formulas follow correct mathematical structure, use proper operators, have balanced parentheses, and contain valid function calls that will produce accurate calculations. Verifying the one or more data field references within formulas correspond to the one or more available data sources means confirming that every data field name referenced in the formula (such as LoanAmount, Partner, ProcessDate) actually exists in the connected databases, APIs, or files that the proof sheet modeling subsystem 212 can access. Checking the formula dependencies to prevent circular computation references involves analyzing the relationships between formulas to ensure that no formula depends on the result of another formula that, in turn, depends on the first formula's result, creating an infinite calculation loop. The mathematical formula syntax refers to the structured format and rules that mathematical expressions must follow (proper operators, function names, parentheses, data references). The data field references are the specific variable names or column identifiers used in formulas to pull information from data sources. The available data sources are the databases, files, and systems that contain the actual data needed for calculations. The circular computation references occur when Formula A depends on Formula B, but Formula B also depends on Formula A, creating an unsolvable loop.

The proof sheet modeling subsystem 212 processes formula-based authored rules through a comprehensive validation pipeline that first examines each mathematical expression to verify proper syntax by checking for balanced parentheses, valid mathematical operators (+, −,, /, =, <, >), correct function names (SUM, IF, AND, OR), and proper data type usage, then systematically verifies that every data field reference within the formula corresponds to actual fields in available data sources by cross-checking formula variables like “LoanAmount” against database column names, API response fields, and file headers to ensure data can be retrieved during execution, and finally analyzes formula dependencies by mapping the relationships between all formulas to detect potential circular references where Formula X uses the result of Formula Y, but Formula Y also requires the result of Formula X, preventing infinite calculation loops that would crash the proof sheet modeling subsystem 212.

For example, when processing the formula-based rule “=IF(AND(LoanAmount>50000, Partner=‘Capital Finance’), LoanAmount0.025, NetSettlement0.018)” for Line Item 8 “Partner Processing Fee,” the system validates mathematical formula syntax by confirming proper IF function structure with balanced parentheses, valid AND function with two conditions, correct comparison operators (> and =), and appropriate mathematical operations (for multiplication), then verifies data field references by checking that “LoanAmount” exists in the bank database loan_table.principal_amount field, “Partner” corresponds to the partner_agreements.company_name field, and “NetSettlement” matches the calculated_values.net_amount field in available data sources, and finally checks formula dependencies by analyzing that this formula references “NetSettlement” which is calculated by Line Item 12, while Line Item 12's formula “=LoanAmount-PartnerFee-TitleFee” references “PartnerFee” which would be the result of Line Item 8, creating a circular computation reference where Line Item 8 depends on Line Item 12 but Line Item 12 depends on Line Item 8, prompting the system to flag this dependency error and require the operator to restructure the formulas to eliminate the circular reference and ensure proper sequential calculation order.

For creating the one or more proof sheets, the proof sheet modeling subsystem 212 is configured to integrate the semantically authored rules and the formula-based authored rules, into the one or more proof sheet structures by associating each authored rule with its corresponding line item within the one or more proof sheets, establishing execution order for interdependent rule computations, and configuring one or more rule parameters based on the one or more specific parts of the loan settlement process being reconciled. Integrating the semantically authored rules and the formula-based authored rules into the one or more proof sheet structures means combining both types of rules (natural language and mathematical formulas) into a unified system within the proof sheet framework. Associating each authored rule with its corresponding line item within the one or more proof sheets involves linking each individual rule to the specific row or entry in the proof sheet where that rule will be applied to calculate or validate data. Establishing the execution order for interdependent rule computations means determining the sequence in which rules must be processed when one rule's output serves as input for another rule's calculation. Configuring the one or more rule parameters based on the one or more specific parts of the loan settlement process being reconciled involves adjusting rule settings, variables, and conditions to match the particular requirements of different loan settlement components being processed. The corresponding line item refers to the specific proof sheet entry that a rule is designed to populate or validate; interdependent rule computations are calculations where one rule depends on the results of another rule. The rule parameters are the configurable settings within rules that can be adjusted based on the type of loan settlement process being handled.

The proof sheet modeling subsystem 212 integrates both semantic and formula-based rules into a cohesive operational framework by first taking each processed rule (whether originally written as “if loan amount exceeds fifty thousand then apply premium rate” or as “=IF(LoanAmount>50000, Amount0.025, Amount0.018)”) and associating it with its designated line item position within the proof sheet structure (linking the premium rate rule to Line Item 8 “Partner Processing Fee”), then analyzing all rules to establish proper execution order by identifying dependencies where Rule A's output feeds into Rule B's calculation and organizing them sequentially to prevent calculation errors, and finally configuring rule parameters by adjusting variables, thresholds, and conditions based on the specific loan settlement component being reconciled (setting different fee percentages for mortgage settlements versus auto loan settlements, or adjusting holiday calendars for different geographic regions). For example, when integrating rules for a mortgage settlement proof sheet, the system associates the semantic rule “if loan amount exceeds two hundred thousand and borrower credit score above seven hundred then reduce origination fee to one percent” with Line Item 6 “Origination Fee Calculation” and the formula-based rule “=LoanAmount-OriginationFee-TitleFee-BrokerFee” with Line Item 12 “Net Settlement Amount,” then establishes execution order by determining that Line Item 6 must execute before Line Item 12 since the net settlement calculation depends on the origination fee result, and configures rule parameters by setting the loan amount threshold to $200,000 for mortgage products (versus $50,000 for auto loans), the credit score threshold to 700 for prime mortgages (versus 650 for subprime), and the reduced fee rate to 1% for qualified borrowers (versus standard 1.5%), ensuring that both semantic and formula-based rules work together seamlessly within the proof sheet structure while adapting their behavior to the specific requirements of mortgage settlement reconciliation versus other loan types.

For creating the one or more proof sheets, the proof sheet modeling subsystem 212 is configured to create the one or more proof sheets by applying the semantically authored rules and the formula-based authored rules, to populate the one or more line items with computed values, formatting line item presentations according to proof sheet definition requirements, and generating proof sheet metadata including creation timestamp, operator identification, and rule version information. Creating the one or more proof sheets means generating the final reconciliation documents by executing all integrated rules and populating them with actual data. Applying the semantically authored rules and the formula-based authored rules involves executing both natural language-based business logic and mathematical formula calculations to process financial data. Populating the one or more line items with computed values means filling each designated row or entry in the proof sheet with the calculated results from rule execution. Formatting line item presentations according to proof sheet definition requirements involves applying visual styling, data type formatting, alignment, and display standards specified in the original proof sheet definitions. Generating the proof sheet metadata means creating supplementary information that documents the proof sheet's creation details (e.g., creation date, creation time, generated by, rulebook version, and template version). The creation timestamp is the exact date and time when the proof sheet was generated. The operator identification refers to recording which user or system account initiated the proof sheet creation process. The rule version information involves documenting which specific versions of the business rules were used during proof sheet generation. The computed values are the numerical or text results produced by executing rules on financial data. The line item presentations refer to how individual entries appear visually within the proof sheet. The proof sheet definition requirements are the formatting standards and display specifications established during the proof sheet structure creation phase.

The proof sheet modeling subsystem 212 creates finalized reconciliation documents by systematically executing all integrated rules (both semantic and formula-based) against actual financial data to generate computed values for each line item, then applying formatting specifications from the original proof sheet definitions to ensure proper visual presentation including currency formatting for monetary values, date formatting for timestamps, percentage formatting for rates, appropriate column alignment, font styling, and color coding, while simultaneously generating comprehensive metadata that records the exact creation timestamp (such as “2025-01-15 14:32:07 EST”), operator identification (such as “UserID: jsmith, Role: Senior Reconciliation Analyst”), and rule version information (such as “Rulebook v2.3.1, Template v1.8.2”) to provide complete audit trail and version control for regulatory compliance and troubleshooting purposes. For example, when creating a daily funding reconciliation proof sheet for $500,000 in mortgage loans, the proof sheet modeling subsystem 212 applies the semantically authored rule “if loan amount exceeds two hundred thousand and processing occurs on business day then calculate standard origination fee of one point five percent” and the formula-based rule “=SUM(LoanAmount)-SUM(OriginationFee)-SUM(BrokerFee)” to populate Line Item 8 “Total Origination Fees” with the computed value of $7,500 (1.5% of $500,000) and Line Item 15 “Net Settlement Amount” with $485,000, then formats these line item presentations according to proof sheet definition requirements by displaying the origination fee as “$7,500.00” in currency format with right alignment, the net settlement as “$485,000.00” in bold currency format, and applying alternating row colors for readability, while generating proof sheet metadata including creation timestamp “2025-01-15 09:15:23 EST,” operator identification “Created by: Sarah Johnson (Employee ID: SJ4429, Role: Lead Reconciliation Specialist),” and rule version information “Generated using Mortgage Rulebook v3.1.4, Funding Template v2.0.7, Configuration Set v1.9.2,” ensuring the final proof sheet contains accurate computed values with professional formatting and complete documentation for audit and compliance purposes.

For creating the one or more proof sheets, the proof sheet modeling subsystem 212 is configured to validate the generated one or more proof sheets by verifying the one or more line items comprising at least one of: appropriate computed values and data references, confirming the one or more proof sheet structures match the received proof sheet definitions, and determining whether the generated one or more proof sheets accurately represent the reconciliation of the identified one or more specific parts of the loan settlement process. Validating the generated one or more proof sheets means performing systematic checks to ensure the completed reconciliation documents are accurate, complete, and properly formatted. Verifying the one or more line items comprising at least one of appropriate computed values and data references involves checking that each line item contains correct calculated results and proper connections to data sources. The appropriate computed values are numerical or text results that accurately reflect the intended calculations based on the applied business rules. The data references are the connections between line items and their source data fields that ensure information is pulled from the correct databases or files. Confirming the one or more proof sheet structures match the received proof sheet definitions means validating that the final document layout, formatting, and organization conform to the original structural specifications. The proof sheet structures refer to the overall document organization including headers, line item arrangement, summary sections, and visual formatting. The received proof sheet definitions are the original specifications that defined how the proof sheet should be structured and formatted. Determining whether the generated one or more proof sheets accurately represent the reconciliation of the identified one or more specific parts of the loan settlement process, involves verifying that each component of the loan settlement (funding verification, fee calculations, settlement amounts) has been properly reconciled and documented in the proof sheet.

The proof sheet modeling subsystem 212 performs comprehensive validation by systematically examining each line item to verify that computed values are mathematically correct (checking that a 1.5% fee calculation on $100,000 equals $1,500), data references are properly connected (confirming that Line Item 5 “Loan Principal” successfully retrieved data from the bank database field “loan_amount”), and all calculations follow the intended business logic, then comparing the final proof sheet structure against the original proof sheet definitions to ensure headers are properly formatted, line items are in correct positions, currency values display with appropriate decimal places, dates follow specified formats, and visual elements like fonts and colors match requirements, and finally conducting end-to-end validation to confirm that each identified loan settlement component has been accurately reconciled by checking that funding flows are properly traced, partner fees are correctly calculated and allocated, settlement amounts reflect all adjustments, and exception conditions are appropriately flagged. For example, when validating a mortgage settlement proof sheet for a $250,000 loan, the proof sheet modeling subsystem 212 verifies line items by checking that Line Item 6 “Origination Fee (1.5%)” contains the appropriate computed value of $3,750 (1.5% of $250,000) and confirms its data reference successfully connected to the bank's loan database field “principal_amount,” then confirms the proof sheet structure matches received definitions by validating that the document header displays “Mortgage Settlement Reconciliation” in 14-point bold Arial font as specified, line items are arranged in the defined sequence with alternating row colors, monetary values appear in currency format with two decimal places ($3,750.00), and the summary section totals are right-aligned as required, and finally determines accurate representation by verifying that the loan funding component shows proper reconciliation with $250,000 disbursed from First National Bank matching the borrower's account credit, the partner fee component correctly allocates $3,750 to the originating broker and $500 to the title company, and the settlement amount component accurately calculates the net $245,750 due to the lender after all fees and adjustments, ensuring the generated proof sheet provides complete and accurate documentation that the mortgage settlement process has been properly reconciled across all identified components.

In an embodiment of the present disclosure, the plurality of subsystems 110 further includes the rulebook authoring subsystem (not shown in FIG. 2) that is communicatively connected to the one or more hardware processors 202. The rulebook authoring subsystem is configured to define source data and write semantic rules to process the data. The process of defining source data and writing semantic rules to process the data is based on two modes of creation. The first mode of creation includes authoring of simple formulas in excel using empty datasets semantically creating complex rules. For example $funding. $partner. $status. The second mode of creation includes interpreting the complex rules by the engine at runtime before populating the template.

The plurality of subsystems 110 further includes the data loader subsystem 214 that is communicatively connected to the one or more hardware processors 202. The data loader subsystem 214 is configured to obtain the financial data defined in the rulebook for each of the created one or more proof sheets from one or more data sources 108 based on configuration for each source using the one or more adapters. In an embodiment of the present disclosure, the one or more data sources 108 include an Application Programming Interface (API), one or more ingest outbound files, one or more inbound files, and the like. Further, the one or more data sources 108 are easily configured to simply pull/obtain all required transactions and settlement files from the one or more data sources 108 using a simple Graphical User Interface (GUI) file or a configuration file. For example, the rules for each line item in the proof sheet can be authored by the operations team semantically or using formulas. The data source required can be easily configured to simply pull all required transactions and settlement files from various sources using a simple GUI/Config file. In an embodiment of the present disclosure, rules for each cell are also stored in a rule store and converted to formulas dynamically. All the rules for a proof sheet are embedded into the templates, versioned and persisted in s3 storage for on-demand retrieval. In an embodiment of the present disclosure, the financial data includes a set of financial files of one or more financial formats. For example, the one or more financial formats include National Automated Clearing House Association (NACHA), VISA, Bank Administration Institute (BAI), JavaScript Object Notation (JSON), Comma-Separated Values (CSV), excel files, Hypertext Markup Language (HTML) tables, and the like. In an exemplary embodiment of the present disclosure, the one or more adapters include a File Transfer Protocol (FTP) adapter, a Secure File Transfer Protocol (SFTP), an API adapter, a Simple Storage Service (S3) adapter, a Relational Database Management System (RDBMS), a script adapter, or a combination thereof. In an embodiment of the present disclosure, the data loader subsystem 214 allows configuration driven data load. For example, the configuration for each source dictates if the data needs to be pulled from an API using specific criteria, or ingest outbound files sent from our systems to servicing partners/banks and inbound files from servicing partner, banks and VISA.

Obtaining the financial data (e.g., Loan amount: $100,000, borrower fee: $1,500, settlement date: 01/15/2025.) defined in the rulebook means retrieving specific financial information that has been specified in the business rules documentation as necessary for proof sheet calculations. The Financial data refers to monetary information, transaction records, and numerical values related to loan operations, including loan amounts, interest rates, payment schedules, settlement figures, partner fees, transaction dates, account balances, and other quantitative information used in loan processing and reconciliation activities. In an embodiment, the financial data comprises a set of financial files of the one or more financial formats. The set of financial files refers to a collection of digital documents and data files that contain monetary information and transaction records related to loan operations. The financial files are structured digital documents that store and organize financial data in various standardized formats, including transaction logs, account statements, settlement reports, fee schedules, loan documentation, payment records, reconciliation reports, and regulatory filings. These files may be stored in different formats such as spreadsheets (Excel, CSV), database files, text files, XML documents, JSON files, PDF reports, or proprietary financial industry formats, and they serve as the primary data sources for loan reconciliation, accounting, auditing, and regulatory compliance activities.

The one or more data sources are the various systems, databases, files, and services that contain the required financial information. The configuration for each source refers to the specific settings, parameters, and connection details that define how to access and retrieve data from each individual data source. The one or more adapters are specialized software components that handle the technical details of connecting to and extracting data from different types of data sources. The File Transfer Protocol (FTP) adapter is a component that connects to FTP servers to download files containing financial data. The Secure File Transfer Protocol (SFTP) adapter is a component that securely connects to SFTP servers using encryption to download sensitive financial files. The Application Program Interface (API) adapter is a component that makes real-time requests to web services and APIs to retrieve current financial data. The Simple Storage Service (S3) adapter is a component that connects to cloud storage services like Amazon S3 to access stored financial files. The Relational Database Management System (RDBMS) adapter is a component that connects to SQL databases to query and extract financial records. The script adapter is a component that executes custom scripts or programs to retrieve data from specialized or proprietary systems. The API is a software interface that enables real-time communication between the loan reconciliation system and external financial services, allowing the system to programmatically request and receive current transaction data, settlement information, and account balances through standardized web-based calls. The one or more ingest outbound files are data files that are generated and sent out from the loan reconciliation system to external partners, banks, or service providers, containing transaction records, settlement requests, or reconciliation reports that need to be transmitted to other parties in the loan settlement process. the one or more inbound files are data files that are received by the loan reconciliation system from external sources such as banks, payment processors, or partner organizations, containing transaction confirmations, settlement data, fee schedules, or other financial information needed for reconciliation processing. The transaction and settlement files are digital records containing detailed information about loan-related financial activities, including loan disbursements, fee payments, partner commissions, and final settlement amounts that need to be reconciled and validated during the loan settlement process. The GUI file is a visual configuration tool that allows operators to set up data source connections through point-and-click interactions, dropdown menus, and form-based inputs without requiring technical programming knowledge or manual file editing. The configuration file is a structured text document (such as JSON, XML, or properties file) that contains technical parameters, connection settings, and operational instructions for accessing and processing data from various sources, typically edited by technical personnel or system administrators.

The data loader subsystem 214 systematically retrieves all financial information required for proof sheet generation by first consulting the rulebook to identify exactly what data is needed (such as loan amounts, partner fees, transaction dates, settlement amounts), then examining the configuration for each data source to determine connection parameters (server addresses, authentication credentials, file paths, query parameters), and finally deploying the appropriate adapter based on the data source type, where the FTP adapter handles standard file transfers from partner systems, the SFTP adapter securely downloads encrypted files from banks, the API adapter makes real-time calls to payment processors for current transaction status, the S3 adapter retrieves archived financial documents from cloud storage, the RDBMS adapter executes SQL queries against internal databases for historical loan records, and the script adapter runs custom programs to extract data from legacy systems or proprietary formats, with each adapter handling the technical complexities of its specific protocol while presenting a standardized interface to the data loader subsystem 214.

For example, when generating a daily loan reconciliation proof sheet that requires loan principal amounts, partner fee rates, and settlement timing data, the data loader subsystem 214 consults the rulebook which specifies “retrieve loan amounts from Bank Database, partner rates from Partner FTP server, and settlement dates from Payment API,” then examines configurations showing “Bank Database: server=db.bank.com, credentials=encrypted, table=loan_records,” “Partner FTP: server=ftp.partner.com, path=/daily_rates/, username=reconcile_user,” and “Payment API: endpoint=https://api.payments.com/settlements, token=auth_12345,” and deploys the RDBMS adapter to execute “SELECT loan_id, principal_amount FROM loan_records WHERE date=‘2025-01-15’” against the bank database retrieving $2.5M in loan data, the FTP adapter to download the “partner_rates_20250115.csv” file containing fee percentages from the partner server, the API adapter to make GET requests to the payment service retrieving settlement timestamps for 150 transactions, the S3 adapter to access archived transaction logs from “s3://financial-archive/settlements/2025/01/” for historical comparison, and the script adapter to run a custom Python program that extracts data from the legacy mainframe system using proprietary protocols, with all adapters working simultaneously to gather the complete dataset needed for accurate proof sheet generation while handling the unique technical requirements of each data source type.

The plurality of subsystems 110 further includes the data processing subsystem 216 that is communicatively connected to the one or more hardware processors 202. The data processing subsystem 216 is configured to generate the dynamic workbook using the received at least one of: the received one or more proof sheet templates, the received one or more proof sheet rulebooks, the received one or more proof sheet configurations of the loan settlement process, or any combination thereof upon obtaining the financial data. The process of generation of the dynamic workbook includes the following method. Initially, a copy of the template is loaded into the engine (i.e., reconciliation engine), and a new dynamic workbook is created using python excel compiler and parser. The parser runs through each cell in the template, copies the format and formulas in the new workbook and loads data as reference sheets based on the configuration. Further, on loading the data to the reference sheets, the engine uses the compiler to compile the default excel formulas and for custom rules the engine executes python parser to convert custom rules to python pandas formulas. Furthermore, the engine applies the rules and formulas on the reference data. Finally, the engine runs/executes the formulas and copies the resulting data onto the workbook in memory, to generate the data for the new dynamic workbook in the memory.

The data processing subsystem 216 is a specialized software component that handles the computational aspects of loan reconciliation. The reconciliation engine is the core processing unit that executes reconciliation logic and calculations. The container orchestration cluster is a distributed computing environment that manages multiple containerized applications for scalable processing. The dynamic workbook is a spreadsheet-like document that is generated and populated with data in real-time. The template refers to a pre-designed spreadsheet structure with predefined layouts and formulas. The compiler is a software component that converts rules and formulas into executable code. The parser is a software component that analyzes and interprets text, formulas, and data structures. The customized formats are specific visual styling and data presentation rules. The reference sheets are additional data tabs within the workbook that contain source data for calculations. The default formulas are standard mathematical expressions built into the template. The resulting data refers to the calculated values produced by executing formulas on the source data.

The data processing subsystem 216 operates through a systematic eight-step process where it first loads a copy of the proof sheet template (such as a “Daily Funding Statement Template”) into the reconciliation engine's memory, then generates a new empty dynamic workbook structure using the compiler to create the framework and the parser to interpret the template structure, followed by parsing each individual cell in the original template to copy customized formats (currency symbols, decimal places, font styles) and formulas (calculation expressions) into corresponding cells of the new dynamic workbook. Further, the data processing subsystem 216 loads financial data as reference sheets based on proof sheet configurations that specify which data sources to include (bank transactions, partner fees, settlement records), compiles default formulas from the template and converting business rules into executable mathematical expressions using the compiler, applies both the compiled formulas and converted rules to the reference data to perform calculations, executes all formulas to generate computed results and copies this resulting data into appropriate cells within the new dynamic workbook stored in memory, and finally generates the complete data structure for the new dynamic workbook in memory ready for further processing or output.

For example, when processing a mortgage settlement for $200,000, the data processing subsystem 216 loads the “Mortgage Settlement Template” containing predefined sections for loan details, fees, and settlement amounts into the reconciliation engine running on an AWS ECS cluster, generates a new dynamic workbook structure using the compiler to create the framework and parser to interpret the template's 15 columns and 25 rows, parses each cell to copy customized formats like “$200,000.00” currency formatting and formulas like “=LoanAmount0.015” for origination fees into the new workbook, loads reference sheets containing bank data (loan amounts, borrower info), partner data (fee rates, commission schedules), and transaction data (funding dates, settlement timing) based on configurations specifying “load from BankAPI, PartnerFTP, and TransactionDB,” compiles default formulas such as “=SUM(OriginationFee+BrokerFee+TitleFee)” and converts the business rule “if loan amount exceeds $150,000 then apply 1.5% origination fee” into the executable formula “=IF(LoanAmount>150000, LoanAmount0.015, LoanAmount0.01),” applies these formulas to the reference data calculating $3,000 origination fee (1.5% of $200,000), $4,000 broker commission, and $800 title fee, executes all formulas to generate the computed results and copies this data into the new dynamic workbook showing loan amount $200,000 in cell B5, total fees $7,800 in cell B15, and net settlement $192,200 in cell B20, and finally generates the complete dynamic workbook data structure in memory containing all calculated values, formatted cells, and reference relationships ready for exception detection and output processing.

For generating the dynamic workbook, the data processing subsystem 216 is configured to load the workbook data as additional sheets from the one or more data sources 108 into the generated new dynamic workbook for updating the generated dynamic workbook. In an embodiment of the present disclosure, each of the one or more data sources 108 is queried and filtered as per the one or more proof sheet configurations and formatted for consistencies based on or more formats to be added as sheets to the generated dynamic workbook. In an exemplary embodiment of the present disclosure, the one or more formats include datetime formats, currency formats, and the like.

Loading the workbook data as the additional sheets means importing the financial data from external sources and creating separate worksheet tabs within the dynamic workbook to organize different types of information. The generated new dynamic workbook is the spreadsheet-like document that was previously created and now needs to be populated with actual data. Updating the generated new dynamic workbook means adding new data sheets and refreshing the workbook with current information. Querying the one or more data sources refers to the process of requesting specific data from databases or systems using search criteria. Filtering the one or more data sources means applying selection criteria to retrieve only relevant data records that match specified conditions. Formatting for the consistencies means standardizing data presentation to ensure uniform appearance and structure across all data sheets. The one or more formats are the standardized presentation rules applied to different data types. The datetime formats are standardized ways of displaying dates and times (such as MM/DD/YYYY or DD-MMM-YYYY). The currency formats are standardized ways of displaying monetary values (such as $1,234.56 or €1.234,56). The sheets refer to individual worksheet tabs within the workbook that contain organized data.

The data processing subsystem 216 enhances the dynamic workbook by systematically retrieving data from multiple external sources and organizing it into separate worksheet tabs, where each data source is accessed through specific queries that request only relevant information (such as “SELECT loan_amount, borrower_name FROM loans WHERE date >=‘2025-01-01’”), then filtered according to proof sheet configurations that specify criteria like date ranges, loan types, or partner categories to ensure only pertinent records are included, followed by applying consistent formatting rules where datetime information is standardized to a uniform format like “01/15/2025 14:30:00” regardless of how different sources originally stored the dates, and currency values are formatted consistently as “$150,000.00” with dollar signs and two decimal places even if source systems used different currency representations, with each processed dataset becoming a separate sheet within the dynamic workbook (such as “Bank_Transactions,” “Partner_Fees,” “Settlement_Data”) that maintains consistent formatting while preserving the unique data from each source. For example, when loading workbook data for a daily loan reconciliation covering $2.5 million in transactions, the data processing subsystem 216 queries the bank database using “SELECT loan_id, principal_amount, funding_date FROM loan_records WHERE funding_date=‘2025-01-15’” and filters results to include only loans above $50,000 as specified in the proof sheet configuration, then queries the partner FTP server for fee schedules and filters to include only active partners, and queries the payment API for settlement data filtered by transaction status “completed,” with each dataset being formatted for consistency where funding dates from the bank appear as “01/15/2025” (MM/DD/YYYY format), partner fee dates are converted from “15-Jan-2025” to the same “01/15/2025” format, loan amounts from the bank display as “$150,000.00” (currency format with dollar sign and two decimals), partner fees are converted from “1500.0” to “$1,500.00” format, and settlement amounts are standardized from various source formats to “$485,750.00,” with the processed data being added as separate sheets named “Bank_Loans” containing 247 loan records, “Partner_Fees” containing 15 fee schedules, and “Settlement_Data” containing 150 completed transactions, all within the updated dynamic workbook that now contains both the original calculation framework and the additional data sheets with consistently formatted information ready for reconciliation processing.

For loading the workbook data in the process of updating the generated new dynamic workbook, the data processing subsystem 216 is configured to identify the one or more data sources specified in the one or more proof sheet configurations for workbook data integration. Identifying the one or more data sources means systematically discovering and cataloguing all external systems, databases, files, and services that contain financial information required for the reconciliation process. The workbook data integration is the process of combining data from multiple sources into a unified dynamic workbook structure for reconciliation analysis.

The data processing subsystem 216 begins workbook data integration by systematically examining each proof sheet configuration file to locate and catalog all data source specifications, where configurations contain structured entries that explicitly name each required data source along with connection parameters, access credentials, and data selection criteria, such as a mortgage reconciliation configuration that might specify “BankDatabase: server=mortgage.bank.com, table=loan_records,” “PartnerAPI: endpoint=https://partner.com/api/fees,” and “SettlementFTP: server=ftp.settlement.com, path=/daily_files/,” with the system parsing these configuration entries to create a comprehensive inventory of all data sources that must be accessed, including their technical connection requirements, authentication methods, and the specific data elements to be retrieved from each source. For example, when processing a “Daily Commercial Loan Reconciliation” proof sheet, the data processing subsystem 216 identifies data sources by examining the configuration file “commercial_loan_config.json” which specifies five distinct data sources: “CommercialBank_DB” with connection string “jdbc: postgresql://commercial.bank.com:5432/loans” for retrieving loan principal amounts and borrower information, “CapitalPartner_API” with endpoint “https://api.capitalpartner.com/v2/acquisitions” for accessing partner purchase data and fee schedules, “Settlement_SFTP” with server “sftp.settlement.com” and path “/commercial/daily/” for downloading settlement confirmation files, “RiskAssessment_S3” with bucket “s3://risk-data/commercial-loans/” for accessing credit scoring and risk evaluation data, and “Regulatory_FTP” with server “ftp.regulator.gov” for retrieving compliance reporting requirements, with each data source specification including detailed connection parameters, authentication credentials, query filters (such as “WHERE loan_type=‘commercial’ AND date=‘2025-01-15’”), and data formatting instructions, allowing the system to systematically identify and prepare for integration of loan amounts from the bank database, partner fees from the API service, settlement confirmations from the SFTP server, risk assessments from cloud storage, and regulatory data from the government FTP server into a unified dynamic workbook structure for comprehensive commercial loan reconciliation analysis.

For loading the workbook data in the process of updating the generated new dynamic workbook, the data processing subsystem 216 is further configured to establish the one or more connections to each of the one or more data sources using the corresponding one or more adapters. Establishing the one or more connections means creating active communication links and authenticated sessions between the loan reconciliation system and external data repositories. The data processing subsystem 216 systematically creates active communication channels by deploying the appropriate adapter for each identified data source, where the FTP adapter establishes connections to file transfer protocol servers using username/password authentication and navigates to specified directories, the SFTP adapter creates secure encrypted connections to secure file transfer servers using SSH keys or certificates, the API adapter initiates HTTP/HTTPS connections to web services using authentication tokens or API keys and establishes session management, the S3 adapter connects to cloud storage services using access keys and bucket permissions, the RDBMS adapter establishes database connections using connection strings and database credentials, and the script adapter executes custom connection protocols for proprietary or legacy systems, with each adapter handling the specific technical requirements, authentication methods, error handling, and data format translations needed for its corresponding data source type.

For example, when establishing connections for a mortgage reconciliation process requiring data from five different sources, the data processing subsystem 216 deploys the RDBMS adapter to connect to “MortgageBank Database” using connection string “jdbc:postgresql://mortgage.bank.com:5432/loans” with username “recon_user” and encrypted password, creating an active database session that enables SQL queries, simultaneously the API adapter establishes an HTTPS connection to “CapitalPartner API” at “https://api.capitalpartner.com/v2/loans” using bearer token “Bearer abc123xyz789” and maintains session state for real-time data requests, the SFTP adapter creates a secure encrypted connection to “Settlement Server” at “sftp.settlement.com:22” using SSH private key authentication and navigates to the “/daily_settlements/” directory, the S3 adapter connects to “AWS S3 Bucket” named “loan-documents-archive” using access key “AKIA . . . ” and secret key authentication with read permissions for the “2025/mortgage/” folder, and the script adapter executes a custom Python connection script that interfaces with the legacy mainframe system using proprietary protocols and terminal emulation, with all five adapters maintaining active, authenticated connections that enable the data processing subsystem 216 to simultaneously query the mortgage database for loan amounts, request partner fee data through the API, download settlement files via SFTP, access archived documents from S3 storage, and retrieve historical data from the mainframe system, ensuring comprehensive data integration from all required sources for accurate mortgage reconciliation processing.

For loading the workbook data in the process of updating the generated new dynamic workbook, the data processing subsystem 216 is further configured to query each of the one or more data sources by applying one or more query parameters specified in the one or more proof sheet configurations to retrieve relevant financial data, executing data extraction operations based on the one or more proof sheet configurations for each source, and retrieving raw workbook data from each connected data source. Querying each of the one or more data sources means sending structured requests or commands to each connected external system to request specific information. Applying the one or more query parameters involves using specific search criteria, filters, and conditions that define what data to retrieve. The query parameters are the specific criteria used to filter and select data, such as date ranges, loan amounts, partner names, or transaction types. The specified one or more query parameters in the one or more proof sheet configurations refers to the predefined search criteria and data selection rules documented within the configuration files for each proof sheet type. Retrieving the relevant financial data means obtaining only the specific financial information that matches the query criteria and is needed for reconciliation. Executing the data extraction operations involves running the actual data retrieval processes using the appropriate technical methods for each data source type. the data extraction operations are the specific technical procedures used to pull data from each source, such as SQL queries for databases, HTTP requests for APIs, or file downloads for FTP servers, following the specific extraction instructions and parameters defined in the configuration files for each individual data source. Retrieving the raw workbook data involves obtaining the unprocessed, original financial information in its native format before any formatting or transformation. The raw workbook data refers to the original, unformatted financial information as it exists in the source systems before any processing or standardization.

The data processing subsystem 216 performs targeted data retrieval by systematically sending customized requests to each connected data source using query parameters defined in the proof sheet configurations, where database sources receive SQL queries with specific WHERE clauses filtering by date ranges, loan types, and partner criteria, API sources receive HTTP requests with URL parameters or JSON payloads specifying the desired data elements and filtering conditions, file-based sources receive directory listings and file selection criteria to identify relevant files, and cloud storage sources receive object queries with metadata filters, with each data source being queried according to its specific configuration that defines what data elements to retrieve (loan amounts, fees, dates), what filtering criteria to apply (date ranges, partner names, transaction statuses), and what format to expect in return, resulting in the collection of raw financial data from each source in its original, unprocessed format ready for subsequent filtering and formatting operations. For example, when querying the data sources for a daily commercial loan reconciliation covering January 15, 2025, the data processing subsystem 216 applies query parameters from the proof sheet configuration to send a SQL query “SELECT loan_id, principal_amount, borrower_name, funding_date FROM commercial_loans WHERE funding_date=‘2025-01-15’ AND loan_amount>=100000” to the bank database retrieving raw data for 45 commercial loans totalling $8.2 million, simultaneously sends an HTTP GET request to the partner API “https: //api.partner.com/fees?date=2025-01-15&loan_type=commercial&min_amount=100000” with authentication headers retrieving raw JSON data containing fee schedules and commission rates for 12 active partners, executes an FTP directory listing and file download operation to retrieve the raw settlement file “commercial_settlements_20250115.csv” containing 38 settlement records with original timestamps and amounts in various formats, queries the S3 bucket using parameters “prefix=commercial/2025/01/15/” and “file_type=. xlsx” to retrieve raw Excel files containing risk assessment data for 45 loans with unformatted credit scores and evaluation metrics, and executes a custom script that queries the legacy mainframe system using terminal commands to extract raw transaction history data in fixed-width text format, with all query operations following their respective proof sheet configurations to collect comprehensive raw workbook data including loan principals ranging from $100,000 to $2.5 million, partner fees in various currency formats, settlement amounts with different decimal precision, and transaction dates in multiple timestamp formats, providing the complete unprocessed dataset needed for subsequent filtering and formatting operations.

For loading the workbook data in the process of updating the generated new dynamic workbook, the data processing subsystem 216 is further configured to filter the retrieved workbook data by applying filtering criteria defined in the one or more proof sheet configurations to exclude irrelevant data records, selecting one or more data records that match the reconciliation requirements for the dynamic workbook, and removing duplicate and invalid data entries based on predefined data quality rules. Filtering the retrieved workbook data means systematically processing and refining the raw financial data obtained from external sources to retain only relevant information. Applying the filtering criteria defined in the one or more proof sheet configurations involves using specific rules and conditions that have been predefined in configuration files to determine which data records should be kept or excluded. Filtering the criteria are the specific conditions, rules, and parameters used to evaluate and select data records. Excluding the irrelevant data records means removing data entries that do not meet the specified criteria or are not needed for the current reconciliation process. The irrelevant data records are data entries that fall outside the scope, date range, or criteria requirements for the specific reconciliation being performed. Selecting the one or more data records that match the reconciliation requirements involves identifying and retaining only those data entries that meet all specified criteria for the dynamic workbook. The reconciliation requirements are the specific data characteristics and criteria that records must meet to be included in the reconciliation process. Removing the duplicate and invalid data entries means eliminating repeated records and data entries that contain errors, inconsistencies, or fail validation checks; duplicate data entries are identical or substantially similar records that appear multiple times in the dataset. The invalid data entries are records containing errors, missing required fields, or data that fails validation rules. The predefined data quality rules are established standards and validation criteria that determine whether data entries are acceptable for processing.

The data processing subsystem 216 performs comprehensive data refinement by systematically applying multiple layers of filtering logic, starting with criteria-based filtering where configuration-defined rules eliminate records that fall outside specified parameters (such as excluding loans below minimum amounts, transactions outside date ranges, or partners not involved in current reconciliation), followed by requirement-based selection that identifies and retains only records meeting all reconciliation specifications (such as keeping only funded loans with complete settlement data and active partner relationships), and concluding with data quality filtering that removes duplicate entries by comparing key fields like loan IDs and transaction numbers while eliminating invalid records that contain missing required fields, impossible values (negative loan amounts), or data that fails validation checks (invalid dates, malformed account numbers), ensuring the filtered dataset contains only clean, relevant, and unique records suitable for accurate reconciliation processing. For example, when filtering the workbook data for a mortgage reconciliation covering $15 million in loans, the data processing subsystem 216 applies filtering criteria from the proof sheet configuration to exclude 150 irrelevant data records including personal loans (outside mortgage scope), loans funded before January 1, 2025 (outside date range), and inactive partner transactions (not part of current reconciliation), then selects 275 data records that match reconciliation requirements by retaining only mortgage loans between $100,000-$500,000 funded in January 2025 with complete borrower information and active partner relationships, and removes duplicate and invalid data entries by eliminating 25 duplicate records where the same loan appeared multiple times due to system updates, 15 invalid entries with missing required fields like borrower names or loan amounts, 8 records with impossible negative loan amounts, and 12 entries with invalid dates like “02/30/2025” or future dates beyond the processing period, resulting in a clean filtered dataset of 215 unique, valid mortgage loan records totalling $12.8 million with complete data fields, proper date ranges, appropriate loan amounts, and verified partner relationships, ensuring the dynamic workbook contains only high-quality, relevant data suitable for accurate mortgage reconciliation analysis and fee calculations.

For loading the workbook data in the process of updating the generated new dynamic workbook, the data processing subsystem 216 is further configured to format the filtered workbook data for consistency by standardizing datetime formats across the one or more data sources to determine uniform temporal representation, normalizing currency formats to maintain consistent monetary value presentation, and applying additional formatting rules specified in the one or more formats to determine data compatibility. Formatting the filtered workbook data for consistency means applying standardized presentation rules to ensure all data appears in uniform formats regardless of its original source. Standardizing the datetime formats across the one or more data sources involves converting all date and time information from various source systems into a single, consistent format. The datetime formats are the specific ways dates and times are displayed, such as MM/DD/YYYY, DD-MMM-YYYY, or YYYY-MM-DD HH:MM:SS. Determining the uniform temporal representation means establishing a single, consistent way to display all date and time information throughout the workbook. the uniform temporal representation refers to having all dates and times appear in exactly the same format structure. Normalizing the currency formats involves converting all monetary values into a standardized presentation format. the currency formats are the specific ways monetary values are displayed, including currency symbols, decimal places, and thousands separators. Maintaining the consistent monetary value presentation means ensuring all financial amounts appear with the same currency symbol, decimal precision, and formatting style. Applying the additional formatting rules involves implementing other standardization requirements beyond dates and currency. The additional formatting rules specified in the one or more formats refers to formatting requirements that have been predefined in configuration settings. The one or more formats are the collection of formatting standards that define how different data types should appear. Determining the data compatibility means ensuring all formatted data can work together seamlessly within the dynamic workbook.

The data processing subsystem 216 performs comprehensive formatting standardization by systematically converting all temporal data from various source formats (such as “01/15/2025” from bank systems, “15-Jan-2025” from partner APIs, and “2025-01-15 14:30:00” from settlement servers) into a single uniform datetime format like “01/15/2025 14:30:00” to ensure consistent temporal representation across all data sources, simultaneously normalizing all monetary values from different currency presentations (such as “150000” from database queries, “$150,000.00” from API responses, and “150000.00 USD” from file downloads) into a standardized currency format like “$150,000.00” with dollar signs, comma thousands separators, and two decimal places to maintain consistent monetary value presentation, and applying additional formatting rules specified in configuration settings such as converting percentage values to consistent decimal notation (0.025 instead of 2.5%), standardizing text fields to proper case formatting, ensuring numeric fields have appropriate precision, and applying color coding or conditional formatting rules, with all formatting operations designed to create seamless data compatibility where every data element follows the same presentation standards regardless of its original source format. For example, when formatting filtered workbook data containing mortgage information from five different sources, the data processing subsystem 216 standardizes datetime formats by converting bank database dates from “2025-01-15” format, partner API timestamps from “15/01/2025 2:30 PM” format, and settlement file dates from “Jan 15, 2025” format all into the uniform temporal representation of “01/15/2025 14:30:00,” simultaneously normalizes currency formats by converting loan amounts from the bank's “250000” format, partner fees from the API's “3750.0” format, and settlement amounts from files' “$247,250.00” format all into consistent monetary presentation of “$250,000.00,” “$3,750.00,” and “$247,250.00” respectively, and applies additional formatting rules including converting interest rates from various formats like “4.25%,” “0.0425,” and “4.25 percent” into the standardized “4.25%” format, standardizing borrower names from “JOHN SMITH,” “john smith,” and “John Smith” into proper case “John Smith,” ensuring loan IDs follow the consistent format “LN-2025-001234” regardless of source variations like “LN2025001234” or “Loan_001234_2025,” and applying conditional formatting that highlights weekend processing dates in yellow and federal holiday dates in red, resulting in a completely standardized dataset where all 215 mortgage records display dates as “01/15/2025 14:30:00,” loan amounts as “$250,000.00,” interest rates as “4.25%,” and borrower names in proper case, ensuring perfect data compatibility throughout the dynamic workbook for accurate reconciliation processing and professional presentation.

For loading the workbook data in the process of updating the generated new dynamic workbook, the data processing subsystem 216 is further configured to generate the additional sheets within the generated new dynamic workbook by generating separate worksheet tabs for each data source to maintain data source traceability, structuring each additional sheet with appropriate column headers and data organization, and preserving data source metadata within each additional sheet for audit purposes. Generating the additional sheets within the generated new dynamic workbook means creating new worksheet tabs inside the existing dynamic workbook structure to hold imported data. Generating the separate worksheet tabs for each data source involves creating individual, named tabs within the workbook where each tab corresponds to one specific external data source. The worksheet tabs are the individual sheet pages within a workbook, similar to tabs in a filing system, that can be clicked to access different sets of data. Maintaining the data source traceability means preserving the ability to identify which external system each piece of data originated from. The data source traceability is the capability to track and identify the original source of any data element for audit and verification purposes. Structuring each additional sheet with appropriate column headers involves organizing each worksheet with descriptive column titles that clearly identify what type of information each column contains. The appropriate column headers are descriptive titles placed at the top of each column that clearly identify the data type and content; data organization refers to the logical arrangement and structure of information within each worksheet. Preserving the data source metadata within each additional sheet means including supplementary information about the data source itself within each worksheet. The data source metadata is descriptive information about the data source including connection details, extraction timestamp, record counts, and source system identification. The audit purposes refers to the need to provide complete documentation and traceability for regulatory compliance, verification, and troubleshooting.

The data processing subsystem 216 creates organized data storage within the dynamic workbook by systematically generating individual worksheet tabs for each connected data source (creating tabs named after their sources like “BankDB_Loans,” “PartnerAPI_Fees,” “SettlementFTP_Files”), then structuring each sheet with descriptive column headers that clearly identify the data content (such as “Loan_ID,” “Principal_Amount,” “Funding_Date,” “Borrower_Name” for bank data, or “Partner_Name,” “Fee_Rate,” “Commission_Amount,” “Effective_Date” for partner data), organizing the data in logical row-and-column format with consistent data types in each column, and embedding comprehensive metadata information within each sheet including source system identification, data extraction timestamp, total record count, connection parameters used, any filtering criteria applied, and data quality statistics, ensuring complete traceability and audit compliance while maintaining clear separation and organization of data from different sources. For example, when generating additional sheets for a commercial loan reconciliation involving data from four sources, the data processing subsystem 216 creates separate worksheet tabs including “CommercialBank_DB” containing loan data with column headers “Loan_ID,” “Principal_Amount,” “Interest_Rate,” “Funding_Date,” “Borrower_Name” and metadata showing “Source: Commercial Bank Database, Extracted: 01/15/2025 09:30:15, Records: 125, Query: SELECT FROM loans WHERE date=‘2025-01-15’,” a “CapitalPartner_API” tab with headers “Partner_Name,” “Acquisition_Fee,” “Commission_Rate,” “Transaction_ID” and metadata “Source: Capital Partner API v2.1, Extracted: 01/15/2025 09:32:22, Records: 45, Endpoint: /api/fees?date=2025-01-15,” a “Settlement_SFTP” tab with headers “Settlement_ID,” “Amount,” “Settlement_Date,” “Status,” “Bank_Reference” and metadata “Source: Settlement SFTP Server, File: settlements_20250115.csv, Downloaded: 01/15/2025 09:35:10, Records: 89,” and a “RiskData_S3” tab with headers “Loan_ID,” “Credit_Score,” “Risk_Rating,” “Assessment_Date” and metadata “Source: AWS S3 Bucket risk-assessments, Object: commercial_risk_20250115.xlsx, Retrieved: 01/15/2025 09:38:45, Records: 125,” with each sheet maintaining complete data source traceability through its tab name, structured organization through appropriate column headers that clearly identify loan amounts, partner fees, settlement details, and risk assessments, and comprehensive audit documentation through preserved metadata that enables complete tracking of data origin, extraction timing, record counts, and source system parameters for regulatory compliance and verification purposes.

For loading the workbook data in the process of updating the generated new dynamic workbook, the data processing subsystem 216 is further configured to populate the additional sheets by loading the formatted workbook data into the corresponding additional sheets within the generated new dynamic workbook, maintaining data integrity during the loading process to prevent data corruption, and establishing data relationships between the additional sheets and existing workbook content. Populating the additional sheets means filling the previously created worksheet tabs with actual financial data that has been processed and formatted. Loading the formatted workbook data involves transferring the standardized and cleaned financial information into the appropriate cells within each worksheet. The formatted workbook data refers to the financial information that has already been standardized for consistency in terms of dates, currency, and other data formats. The corresponding additional sheets are the specific worksheet tabs that match the data source from which the data originated. The generated new dynamic workbook is the comprehensive spreadsheet structure that contains both calculation frameworks and data storage areas. Maintaining the data integrity during the loading process means ensuring that data remains accurate, complete, and uncorrupted as it is transferred into the worksheets. The data integrity refers to the accuracy, consistency, and reliability of data throughout the transfer process. Preventing data corruption means avoiding any alteration, loss, or damage to the data during the loading operation. The data corruption occurs when information becomes altered, damaged, or lost during transfer or storage operations. Establishing the data relationships between the additional sheets and existing workbook content involves creating logical connections and references that link data in the new sheets to calculations and formulas in the main workbook. The data relationships are the logical connections and dependencies between different data elements across multiple worksheets. Existing the workbook content refers to the calculation frameworks, formulas, and proof sheet structures that were previously created in the dynamic workbook.

The data processing subsystem 216 systematically transfers formatted financial data into the appropriate worksheet tabs by matching each dataset to its corresponding sheet based on data source origin (bank data goes to “BankDB\_Loans” sheet, partner data to “PartnerAPI\_Fees” sheet), then carefully loading each formatted record into the proper rows and columns while implementing data integrity safeguards such as validation checks that verify data types match column specifications, range checks that ensure numerical values fall within expected parameters, and completeness verification that confirms all required fields are populated, followed by establishing logical data relationships through cell references and named ranges that connect the additional sheets to existing workbook formulas, enabling main calculation sheets to reference specific data elements from the additional sheets (such as loan amounts from the bank sheet feeding into fee calculation formulas, or partner rates from the API sheet being used in commission computations), with all loading operations monitored for errors and validated to ensure no data corruption occurs during the transfer process. For example, when populating additional sheets for a mortgage reconciliation workbook, the data processing subsystem 216 loads formatted bank data including 150 loan records with standardized amounts like “$250,000.00,” dates like “01/15/2025,” and borrower names like “John Smith” into the “MortgageBank\_DB” sheet by placing each loan record in sequential rows with loan amounts in column B, funding dates in column C, and borrower names in column D, simultaneously loads formatted partner data including fee rates like “2.50%” and commission amounts like “$5,000.00” into the “PartnerAPI\_Fees” sheet, maintains data integrity by running validation checks that confirm all loan amounts are positive numbers, all dates fall within the expected range of January 2025, and all required fields contain valid data, prevents data corruption by implementing error handling that stops the loading process if any data validation fails and logs detailed error messages, and establishes data relationships by creating named ranges like “LoanAmounts” that reference column B in the bank sheet and “PartnerRates” that reference column C in the partner sheet, then linking these ranges to formulas in the main calculation sheet where “=LoanAmountsPartnerRates” automatically calculates partner fees using the actual loan amounts from the bank data and fee rates from the partner data, ensuring that the 150 mortgage loans totalling $37.5 million are properly loaded with complete data integrity while maintaining active relationships that enable real-time calculations when any source data changes, creating a fully integrated dynamic workbook where additional sheets serve as both data repositories and active calculation inputs for comprehensive mortgage reconciliation processing.

For loading the workbook data in the process of updating the generated new dynamic workbook, the data processing subsystem 216 is further configured to update the generated new dynamic workbook by integrating the additional sheets comprising the workbook data with existing dynamic workbook structure, refreshing formula computations that depend on newly loaded workbook data, and updating cross-sheet references to incorporate data from the additional sheets. Updating the generated new dynamic workbook means modifying and enhancing the existing spreadsheet structure to incorporate newly added data and maintain all computational relationships. Integrating the additional sheets comprising the workbook data with existing dynamic workbook structure involves merging the newly created data-containing worksheets with the original calculation framework and proof sheet templates. The additional sheets comprising the workbook data are the worksheet tabs that contain the actual financial data loaded from external sources. The existing dynamic workbook structure refers to the original framework including calculation sheets, proof sheet templates, formulas, and organizational layout. Refreshing the formula computations that depend on newly loaded workbook data means recalculating all mathematical expressions and business rules that use data from the newly populated worksheets. The formula computations are the mathematical calculations, business logic expressions, and automated processes within the workbook. The newly loaded workbook data refers to the financial information that was just imported and formatted from external data sources. Updating the cross-sheet references to incorporate data from the additional sheets involves modifying cell references, named ranges, and formula links to connect calculation sheets with the new data sheets. The cross-sheet references are the connections and links between different worksheets that allow formulas in one sheet to use data from another sheet. The data incorporation from the additional sheets means establishing active connections so that calculations can access and use the imported financial data.

The data processing subsystem 216 performs comprehensive workbook integration by systematically merging the newly populated data sheets with the existing calculation framework, where integration involves updating the workbook's internal structure to recognize and incorporate the additional sheets as active data sources, then triggering a complete refresh of all formula computations throughout the workbook so that calculations in the main proof sheets automatically recalculate using the newly loaded financial data (such as loan amounts, partner fees, and settlement dates), and finally updating all cross-sheet references by modifying cell formulas, named ranges, and lookup functions to establish active connections between calculation sheets and data sheets, enabling real-time computational relationships where changes to source data automatically propagate through all dependent calculations, ensuring the entire dynamic workbook operates as a unified, integrated system where proof sheet calculations seamlessly access and process data from all additional sheets. For example, when updating a mortgage reconciliation dynamic workbook after loading data from four sources, the data processing subsystem 216 integrates the additional sheets by incorporating “MortgageBank\_DB” (containing 200 loan records), “PartnerAPI\_Fees” (containing fee schedules), “Settlement\_SFTP” (containing 180 settlement records), and “RiskData\_S3” (containing credit assessments) into the existing workbook structure that includes “Main\_Calculations” and “Proof\_Sheet\_Summary” worksheets, then refreshes formula computations by recalculating the origination fee formula “=SUM(MortgageBank\_DB.LoanAmount)0.015” which now processes $45 million in actual loan data to generate $675,000 in fees, the partner commission calculation “=VLOOKUP(PartnerName,PartnerAPI\_Fees.FeeSchedule,3,FALSE)LoanAmount” which accesses real partner rates to calculate $890,000 in commissions, and the net settlement formula “=SUM(LoanAmount)-SUM(OriginationFees)-SUM(PartnerCommissions)” which computes the final $43.435 million settlement amount, and updates cross-sheet references by modifying the proof sheet formula from “=SUM(A1:A100)” to “=SUM(MortgageBank\_DB.C:C)” to directly reference loan amounts from the bank data sheet, updating partner fee lookups from static values to “=INDEX(PartnerAPI\_Fees.B:B,MATCH(PartnerName,PartnerAPI\_Fees.A:A,0))” for dynamic fee retrieval, and establishing settlement validation references “=COUNTIF(Settlement\_SFTP.Status,‘Completed’)” to verify transaction completion, resulting in a fully integrated dynamic workbook where the main calculation sheets automatically access real financial data from all four additional sheets, formulas recalculate instantly when source data changes, and the proof sheet summary displays accurate reconciliation results based on live data connections rather than static values, creating a unified system where 200 mortgage loans totalling $45 million are processed through integrated calculations that seamlessly combine loan data, partner fees, settlement records, and risk assessments into comprehensive reconciliation analysis.

For loading the workbook data in the process of updating the generated new dynamic workbook, the data processing subsystem 216 is further configured to validate the updated dynamic workbook by verifying successful integration of the additional sheets from the one or more data sources, confirming data consistency and format compliance across the additional sheets within the updated dynamic workbook, and determining whether the updated dynamic workbook maintains structural integrity for subsequent reconciliation processing. Validating the updated dynamic workbook means performing systematic checks to ensure the integrated workbook functions correctly and meets all quality standards. Verifying the successful integration of the additional sheets from the one or more data sources involves confirming that all newly added worksheet tabs are properly connected, accessible, and functioning within the workbook structure. The successful integration means that all additional sheets are properly incorporated into the workbook without errors, broken links, or accessibility issues. The additional sheets from the one or more data sources are the worksheet tabs containing financial data that were imported from external systems like databases, APIs, and file servers. Confirming the data consistency and format compliance across the additional sheets involves checking that all data follows the same formatting standards and maintains logical consistency throughout all worksheets. The data consistency refers to uniformity in data presentation, accuracy of relationships between related data elements, and absence of contradictory information. The format compliance means adherence to established formatting standards for dates, currency, text, and numerical data across all sheets. Determining whether the updated dynamic workbook maintains structural integrity involves verifying that the workbook's organizational structure, formula relationships, and computational framework remain intact and functional. The structural integrity refers to the preservation of the workbook's organizational framework, formula dependencies, cross-sheet references, and overall computational architecture. The subsequent reconciliation processing refers to the loan reconciliation calculations and analysis that will be performed using the integrated workbook.

The data processing subsystem 216 performs comprehensive workbook validation through a multi-layered verification process that begins by systematically checking each additional sheet to confirm successful integration by verifying that all sheets are accessible, properly named, contain expected data volumes, and maintain active connections to the main workbook structure, then conducting thorough data consistency and format compliance checks by comparing data formats across all sheets to ensure uniform date formatting (all dates appear as “01/15/2025”), consistent currency presentation (all amounts display as “$250,000.00”), matching data types in corresponding columns, and logical consistency where related data elements align correctly (loan IDs match between bank and settlement sheets), and concluding with structural integrity assessment that verifies all cross-sheet formulas function correctly, named ranges reference appropriate data, calculation dependencies work properly, and the overall workbook architecture supports reliable reconciliation processing without computational errors or broken relationships. For example, when validating an updated mortgage reconciliation workbook containing data from four sources, the data processing subsystem 216 verifies successful integration by confirming that all additional sheets including “MortgageBank\_DB” (200 loan records), “PartnerAPI\_Fees” (25 partner fee schedules), “Settlement\_SFTP” (180 settlement transactions), and “RiskData\_S3” (200 credit assessments) are properly accessible with correct tab names, expected record counts, and functional data connections, then confirms data consistency and format compliance by checking that loan amounts appear uniformly as “$250,000.00” across all sheets, dates consistently display as “01/15/2025 14:30:00” format, borrower names follow proper case formatting like “John Smith,” and logical consistency exists where Loan ID “LN-2025-001234” appears identically in bank, settlement, and risk assessment sheets with matching loan amounts and borrower information, and determines structural integrity by testing that cross-sheet formulas like “=SUM(MortgageBank\_DB.LoanAmount)” correctly calculate $45 million total from bank data, partner fee lookups “=VLOOKUP(LoanID,PartnerAPI\_Fees.Schedule,3,FALSE)” successfully retrieve appropriate commission rates, settlement validation formulas “=COUNTIF(Settlement\_SFTP.Status,‘Completed’)” accurately count 175 completed transactions, and the main proof sheet calculations produce mathematically correct results including $675,000 in origination fees (1.5% of $45M), $890,000 in partner commissions, and $43.435 million net settlement amount, ensuring the updated dynamic workbook maintains complete structural integrity with all 200 mortgage loans properly integrated, consistently formatted, and ready for reliable subsequent reconciliation processing that will accurately track funding flows, validate partner payments, and generate compliant reconciliation reports.

Furthermore, the data processing subsystem 216 generates the interim fee for one or more partners based on the one or more fee parameters upon loading the workbook data. In an exemplary embodiment of the present disclosure, the one or more fee parameters include federal holidays, weekends, and the like. For example, Federal holidays and weekends are handled to calculate the interim fees for the partners.

For generating the interim fee for the one or more partners, the data processing subsystem 216 is configured to identify the one or more partners who are active and eligible for interim fee computations from the loaded workbook data, based on partner-specific fee agreements. Identifying the one or more partners who are active and eligible for interim fee computations means systematically locating and cataloguing all partner organizations that meet the criteria for fee calculation processing; one or more partners are the individual financial institutions, capital providers, brokers, investment groups, or service organizations involved in loan transactions. The active partners who currently have valid business relationships, operational agreements, and ongoing transaction activity with the loan reconciliation system. The eligible partners for interim fee computations means who meet all necessary criteria and requirements to receive calculated fees based on their transaction activity. The interim fee computations are temporary or periodic fee calculations performed between final settlement periods to determine partner compensation. The loaded workbook data refers to the financial information that has been imported, formatted, and integrated into the dynamic workbook from various data sources. The partner-specific fee agreements are individual contractual arrangements that define the terms, rates, conditions, and calculation methods for each partner's compensation. The fee agreements are formal contracts or arrangements that specify how partners will be compensated, including fee rates, calculation methods, minimum thresholds, and payment terms.

The data processing subsystem 216 performs systematic partner identification by scanning through all loaded workbook data to locate partner records and cross-referencing them against a database of current fee agreements to determine which partners have active status (meaning they have current contracts, recent transaction activity, and valid business relationships), then evaluating each active partner's eligibility for interim fee computations by checking that they meet specific criteria defined in their individual fee agreements such as minimum transaction volumes, required transaction types, geographic restrictions, or time-based requirements, while also verifying that their fee agreement terms are current and not expired, suspended, or under dispute, resulting in a filtered list of partners who are both operationally active and contractually eligible to receive interim fee calculations based on their specific agreement parameters. For example, when identifying eligible partners for interim fee computations from a mortgage reconciliation workbook containing transaction data for 15 different partners, the data processing subsystem 216 scans the loaded workbook data and finds partners including “Capital Finance Group,” “ABC Investment Partners,” “Regional Mortgage Corp,” “Premier Lending Solutions,” and “Metro Capital Advisors,” then cross-references these partners against the fee agreement database to determine that “Capital Finance Group” is active with a current agreement effective through December 2025 requiring minimum $1 million monthly volume (met with $2.3 million in January transactions), “ABC Investment Partners” is active with valid agreement but currently suspended due to compliance review (ineligible), “Regional Mortgage Corp” is active with current agreement and $850,000 in transactions but fails to meet their $1 million minimum threshold (ineligible), “Premier Lending Solutions” is active with valid agreement effective through March 2025 and $1.8 million in qualifying transactions (eligible), and “Metro Capital Advisors” has expired agreement as of December 2024 despite $1.2 million in transactions (ineligible), resulting in identification of two partners who are active and eligible for interim fee computations: “Capital Finance Group” with fee agreement terms of 2.25% on loans above $200,000 and 1.75% on smaller loans, and “Premier Lending Solutions” with agreement terms of 2.0% flat rate on all mortgage transactions plus $500 per loan processing fee, enabling the data processing subsystem 216 to proceed with interim fee calculations for these two eligible partners based on their specific fee agreement parameters while excluding the three ineligible partners due to suspension, insufficient volume, or expired agreements.

For generating the interim fee for the one or more partners, the data processing subsystem 216 is further configured to extract transaction data associated with each of the one or more partners from the dynamic workbook. The transaction data comprises at least one of: loan amounts, processing dates, and settlement timing information. Extracting the transaction data associated with each of the one or more partners means systematically retrieving and isolating financial transaction records that are specifically linked to individual partner organizations from the comprehensive dataset within the dynamic workbook. The transaction data refers to the detailed financial records and information related to loan processing activities. The one or more partners are the individual financial institutions, capital providers, brokers, or service organizations involved in the loan settlement process. The dynamic workbook is the comprehensive spreadsheet-like document containing all integrated financial data from multiple sources. The loan amounts are the principal monetary values of loans being processed, including original loan values, disbursed amounts, and outstanding balances. The processing dates are the timestamps indicating when various loan-related activities occurred, such as application dates, approval dates, funding dates, and settlement dates. The settlement timing information refers to data about when financial transactions were completed, cleared, or settled between parties.

The data processing subsystem 216 performs targeted data extraction by systematically scanning through the dynamic workbook's integrated datasets to locate and retrieve transaction records that are specifically associated with each partner organization, using partner identification fields (such as partner names, IDs, or codes) as filtering criteria to isolate relevant transactions, then extracting the specified data elements including loan amounts (retrieving principal values, disbursement amounts, and current balances), processing dates (capturing timestamps for loan origination, approval, funding, and other key milestones), and settlement timing information (documenting when payments were processed, cleared, or settled), with the extraction process organizing this data by partner to enable partner-specific fee calculations and reconciliation analysis. For example, when extracting the transaction data for interim fee generation, the data processing subsystem 216 scans the dynamic workbook containing 500 loan transactions and identifies 75 transactions associated with “Capital Partner ABC” by filtering on the partner\_name field, then extracts loan amounts showing $8.5 million in total loan principal ($50,000 to $250,000 per loan), processing dates revealing that 45 loans were processed on weekdays (Monday-Friday) and 30 loans were processed on weekends (Saturday-Sunday), and settlement timing information indicating that 60 transactions settled within standard 2-business-day timeframes while 15 transactions experienced delayed settlement due to federal holidays (Presidents Day and Martin Luther King Day), simultaneously extracting data for “Investment Group XYZ” showing 120 transactions totalling $15.2 million with processing dates spanning both business days and weekends, and settlement timing data revealing that 95 transactions settled normally while 25 experienced holiday-related delays, with all extracted transaction data organized by partner to enable accurate interim fee calculations that account for different fee rates applied to weekend processing ($100 premium per weekend transaction) and holiday delays ($50 adjustment per delayed settlement), ensuring that each partner's fee calculation is based on their specific transaction volumes, timing patterns, and settlement characteristics.

For generating the interim fee for the one or more partners, the data processing subsystem 216 is further configured to determine applicable fee computation periods by analyzing transaction processing dates against a federal holiday calendar to identify one or more transactions processed on the federal holidays, identifying the one or more transactions processed on the weekends by comparing the transaction processing dates against one or more weekend date patterns, and categorizing the one or more transactions into business day transactions, weekend transactions, and federal holiday transactions. Determining the applicable fee computation periods means establishing the specific time categories that will affect how fees are calculated based on when transactions were processed. Analyzing the transaction processing dates against a federal holiday calendar involves comparing each transaction's processing date with an official list of federal holidays to determine if the transaction occurred on a non-business day. The federal holiday calendar is an official reference list containing dates of government-recognized holidays such as New Year's Day, Independence Day, Thanksgiving, and Christmas. Identifying the one or more transactions processed on the federal holidays means locating and flagging specific transactions that occurred on official federal holiday dates. Identifying the one or more transactions processed on the weekends involves detecting transactions that occurred on Saturdays and Sundays. Comparing the transaction processing dates against one or more weekend date patterns means checking each transaction date to determine if it falls on a Saturday (day 7) or Sunday (day 1) using calendar day-of-week calculations. The weekend date patterns are the recurring Saturday-Sunday cycles that represent non-business days. Categorizing the one or more transactions means organizing and grouping transactions based on their processing timing characteristics. The business day transactions are transactions processed on Monday through Friday excluding federal holidays. The weekend transactions are transactions processed on Saturdays and Sundays. The federal holiday transactions are transactions processed on official government holidays regardless of the day of the week.

The data processing subsystem 216 performs systematic temporal analysis by first consulting an official federal holiday calendar (containing dates like January 1, July 4, November 11, December 25) and comparing each transaction's processing date against this reference to identify any transactions that occurred on federal holidays, simultaneously analyzing each processing date using day-of-week calculations to determine if the date falls on Saturday (day 7) or Sunday (day 1) according to standard calendar patterns, then organizing all transactions into three distinct categories where business day transactions include those processed Monday through Friday excluding federal holidays (eligible for standard fee rates), weekend transactions include those processed on Saturdays and Sundays (subject to premium weekend rates), and federal holiday transactions include those processed on official government holidays regardless of day of week (subject to special holiday rates), with this categorization enabling differentiated fee calculations based on processing timing. For example, when determining fee computation periods for 200 loan transactions processed during January 2025, the data processing subsystem 216 analyzes processing dates against the federal holiday calendar identifying that 15 transactions were processed on January 1 (New Year's Day-federal holiday) and 8 transactions on January 20 (Martin Luther King Day federal holiday), compares all processing dates against weekend patterns discovering that 35 transactions occurred on Saturdays (January 4, 11, 18, 25) and 28 transactions on Sundays (January 5, 12, 19, 26), then categorizes the 200 transactions into three groups: 114 business day transactions processed Monday-Friday excluding holidays (eligible for standard 1.5% fee rate), 63 weekend transactions processed on Saturdays and Sundays (subject to premium 2.0% weekend rate), and 23 federal holiday transactions processed on New Year's Day and MLK Day (subject to special 2.5% holiday rate), enabling the data processing subsystem 216 to apply appropriate fee calculations where business day transactions generate standard fees, weekend transactions incur premium charges for non-standard processing timing, and federal holiday transactions receive the highest fee rates due to special processing requirements during government holidays.

For generating the interim fee for the one or more partners, the data processing subsystem 216 is further configured to apply partner-specific fee rate structures based on the categorized one or more transactions. The business day transactions are assessed standard fee rates, the weekend transactions are assessed premium fee rates higher than the assessed standard fee rates, the federal holiday transactions are assessed holiday premium rates. Applying the partner-specific fee rate structures means implementing individualized fee calculation systems that are customized for each partner organization based on their unique contractual agreements. The partner-specific fee rate structures are the customized fee calculation frameworks that vary between different partners according to their individual contracts and business arrangements, using the previously established transaction groupings (business day, weekend, federal holiday) as the foundation for applying appropriate fee rates. The categorized one or more transactions refers to the transactions that have been organized into distinct groups based on their processing timing characteristics. The business day transactions are loan transactions processed Monday through Friday excluding federal holidays. The assessed standard fee rates means applying the normal, baseline fee percentages or amounts specified in partner agreements for regular business operations. The standard fee rates are the regular, baseline fee percentages or fixed amounts that partners receive for transactions processed during normal business hours and days. The weekend transactions are loan transactions processed on Saturdays and Sundays. The assessed premium fee rates higher than the assessed standard fee rates means applying elevated fee percentages or amounts that exceed the normal rates due to weekend processing requirements. The premium fee rates are enhanced fee percentages or amounts that are greater than standard rates, typically applied for non-standard processing conditions; federal holiday transactions are loan transactions processed on official government holidays regardless of the day of the week. The assessed holiday premium rates means applying the highest tier of fee percentages or amounts due to the special processing requirements during federal holidays.

The data processing subsystem 216 implements differentiated fee calculation by systematically applying each partner's unique fee rate structure to their categorized transactions, where each partner has individualized rate schedules defined in their agreements that specify different compensation levels based on transaction timing, with business day transactions receiving the baseline rates established in standard fee agreements (such as 1.5% origination fees or $500 processing fees), weekend transactions receiving enhanced premium rates that compensate partners for non-standard processing requirements (such as 2.0% origination fees or $750 processing fees), and federal holiday transactions receiving the highest premium rates that reflect the additional complexity and cost of holiday processing (such as 2.5% origination fees or $1,000 processing fees), with each partner's specific rate structure being applied independently so that different partners may have varying standard rates, premium multipliers, and holiday adjustments based on their individual contractual negotiations and business relationships. For example, when applying partner-specific fee rate structures to categorized transactions for three different partners, the data processing subsystem 216 processes “Capital Finance Group” transactions by applying their standard rates of 1.75% origination fee and $400 processing fee to 45 business day transactions totalling $8.5 million (generating $148,750 in origination fees and $18,000 in processing fees), their premium rates of 2.25% origination fee and $600 processing fee to 12 weekend transactions totalling $2.1 million (generating $47,250 in origination fees and $7,200 in processing fees), and their holiday premium rates of 2.75% origination fee and $800 processing fee to 5 federal holiday transactions totalling $950,000 (generating $26,125 in origination fees and $4,000 in processing fees), simultaneously processes “Premier Lending Solutions” with their different rate structure applying 2.0% standard rate and $500 processing fee to 38 business day transactions totalling $7.2 million, 2.5% premium rate and $750 processing fee to 8 weekend transactions totalling $1.6 million, and 3.0% holiday premium rate and $1,000 processing fee to 3 federal holiday transactions totalling $600,000, and processes “ABC Investment Partners” with their unique rates of 1.5% standard, 2.0% premium, and 2.5% holiday rates applied to their respective transaction categories, resulting in differentiated fee calculations where each partner receives compensation based on their specific contractual rate structures and the timing characteristics of their transactions, ensuring that weekend and holiday processing receives appropriate premium compensation while maintaining each partner's individualized fee agreement terms.

For generating the interim fee for the one or more partners, the data processing subsystem 216 is further configured to determine the interim fee for each partner by multiplying one or more transaction amounts by applicable fee rates for each transaction category, aggregating fee amounts across the categorized one or more transaction for each partner, and applying at least one of: partner-specific fee caps, minimums, and adjustment factors, to determine the interim fee for each partner. Determining the interim fee for each partner means computing/calculating the temporary compensation amount that each partner organization will receive based on their transaction activity. Multiplying the one or more transaction amounts by applicable fee rates involves performing mathematical calculations where each transaction's monetary value is multiplied by the corresponding fee percentage or rate for that transaction type. The one or more transaction amounts are the monetary values of individual loan transactions processed by each partner. The applicable fee rates are the specific percentage rates or fixed amounts that apply to each transaction based on its category and the partner's fee agreement. Each transaction category refers to the previously established groupings of business day, weekend, and federal holiday transactions. Aggregating the fee amounts across the categorized one or more transaction for each partner means adding together all calculated fees from all transaction categories to create a total fee amount for each partner. Aggregating fee amounts involves summing or combining multiple individual fee calculations into a single total. The categorized one or more transaction refers to the transactions that have been organized by processing timing (business day, weekend, holiday). Applying at least one of: partner-specific fee caps, minimums, and adjustment factors means implementing contractual limitations and modifications that may alter the calculated fee amount. The partner-specific fee caps are maximum fee limits specified in agreements that prevent fees from exceeding certain amounts. The minimums are guaranteed minimum fee amounts that partners receive regardless of calculated fees. The adjustment factors are contractual modifications such as volume discounts, performance bonuses, or penalty reductions that modify the final fee calculation. The interim fee for each partner is the final calculated compensation amount for each partner after all calculations, aggregations, and adjustments have been applied.

The data processing subsystem 216 calculates final partner compensation through a systematic multi-step process that begins by performing individual transaction fee calculations where each transaction amount is multiplied by its applicable rate based on category (business day transactions×standard rate, weekend transactions×premium rate, holiday transactions×holiday rate), then aggregates all calculated fees within each category and across all categories for each partner to create subtotals and grand totals, and finally applies contractual modifications including fee caps that limit maximum compensation (such as monthly caps of $50,000), minimum guarantees that ensure baseline compensation regardless of transaction volume (such as $5,000 monthly minimums), and adjustment factors like volume discounts for high-volume partners (such as 5% discount for partners exceeding $10 million monthly volume) or performance bonuses for exceptional service metrics, resulting in the final interim fee amount for each partner that reflects their transaction activity while adhering to all contractual terms and limitations. For example, when determining interim fees for “Capital Finance Group” with 62 total transactions, the data processing subsystem 216 multiplies transaction amounts by applicable rates calculating $148,750 from 45 business day transactions ($8.5M×1.75%), $47,250 from 12 weekend transactions ($2.1M×2.25%), and $26,125 from 5 holiday transactions ($950K×2.75%), then aggregates these fee amounts across all categories to reach a subtotal of $222,125 in origination fees plus $29,200 in processing fees ($400×45+$600×12+$800×5) for a total calculated fee of $251,325, and applies contractual adjustments including their monthly fee cap of $300,000 (not exceeded), minimum guarantee of $15,000 (exceeded), and 3% volume discount for exceeding $10 million monthly volume (reducing fees by $7,540), resulting in a final interim fee of $243,785 for Capital Finance Group, while simultaneously calculating “Premier Lending Solutions” fees by multiplying their 49 transactions ($9.4M total) by their rates (2.0% standard, 2.5% premium, 3.0% holiday) generating $201,500 in calculated fees, then applying their $250,000 monthly cap (not exceeded), $10,000 minimum (exceeded), and no volume discount, resulting in their final interim fee of $201,500, ensuring each partner receives accurate compensation that reflects their specific transaction activity, rate structures, and contractual terms including caps, minimums, and adjustment factors.

For generating the interim fee for the one or more partners, the data processing subsystem 216 is further configured to validate the determined interim fee against one or more predefined rules and one or more partner agreement parameters to determine fee accuracy. Validating the determined interim fee means performing systematic checks to verify that the calculated compensation amount is correct and complies with all applicable standards. The interim fee refers to the final calculated compensation amount for each partner after all multiplications, aggregations, and adjustments have been applied. The one or more predefined rules are pre-established validation criteria such as maximum fee thresholds, minimum fee requirements, calculation logic verification, and data consistency checks. The one or more partner agreement parameters are contractual specifications including fee rate ranges, calculation methods, payment terms, volume requirements, and special conditions unique to each partner. Determining the fee accuracy means confirming that the calculated fee amount is mathematically correct and contractually compliant. The fee accuracy refers to the correctness of the calculated amount in terms of mathematical precision, adherence to business rules, and compliance with contractual terms.

The data processing subsystem 216 performs comprehensive fee validation by systematically checking each calculated interim fee against multiple validation layers, starting with predefined rules that verify mathematical accuracy (ensuring calculations are correct), range validation (confirming fees fall within expected parameters), consistency checks (verifying fees align with transaction volumes and rates), and business logic validation (ensuring calculations follow established formulas), then cross-referencing each fee against specific partner agreement parameters including contractual fee rate ranges (verifying applied rates match agreement terms), volume-based requirements (confirming minimum transaction thresholds are met), special conditions (checking for unique contractual provisions), and payment terms (ensuring fee timing and calculation methods comply with agreements), with any discrepancies or failures triggering error flags that require resolution before fee approval, ensuring complete accuracy and compliance before final fee determination. For example, when validating the determined interim fee of $243,785 for “Capital Finance Group,” the data processing subsystem 216 checks predefined rules by verifying mathematical accuracy (confirming $8.5M×1.75%=$148,750 for business day transactions), range validation (checking that the total fee falls within the expected range of $200,000-$350,000 for their typical monthly volume), consistency checks (verifying the fee aligns with their 62 processed transactions totaling $11.55 million), and business logic validation (ensuring the 3% volume discount was correctly applied to reduce fees by $7,540), then validates against partner agreement parameters by confirming their applied rates (1.75% standard, 2.25% premium, 2.75% holiday) match their contract terms effective through December 2025, verifying their $300,000 monthly fee cap was properly applied (fee of $243,785 is below cap), checking that their minimum transaction volume of $1 million monthly was exceeded ($11.55 million processed), and confirming their volume discount eligibility (3% discount applies to partners exceeding $10 million monthly volume), with all validation checks passing successfully to confirm fee accuracy, while simultaneously validating “Premier Lending Solutions” fee of $201,500 by checking their different rate structure (2.0% standard, 2.5% premium, 3.0% holiday), verifying their $250,000 monthly cap compliance, and confirming their $10,000 minimum guarantee was exceeded, ensuring both partners'interim fees are mathematically accurate, comply with all predefined business rules, and adhere to their specific contractual agreement parameters before final approval and processing.

For generating the interim fee for the one or more partners, the data processing subsystem 216 is further configured to generate one or more interim fee records comprising partner identification, fee amount, calculation basis, and applicable time period. Generating the one or more interim fee records means creating structured documentation that formally records the calculated compensation information for each partner. The interim fee records are formal data structures or documents that contain comprehensive information about partner fee calculations. The partner identification refers to the unique identifiers and descriptive information that clearly specify which partner organization the fee record belongs to. The fee amount is the final calculated monetary compensation that the partner will receive. The calculation basis refers to the detailed methodology, data sources, and computational steps used to determine the fee amount. The applicable time period is the specific date range or timeframe during which the transactions occurred and for which the fees are being calculated.

The data processing subsystem 216 creates comprehensive documentation by systematically generating structured interim fee records for each eligible partner, where each record serves as a complete audit trail and payment authorization document containing partner identification information (including partner name, unique ID, contact details, and account information), the precise fee amount calculated through the multi-step process (reflecting all transaction categories, rate applications, and contractual adjustments), detailed calculation basis documentation (specifying the transaction volumes, applied rates, categorization logic, aggregation methods, and any caps or adjustments used), and the applicable time period (defining the exact date range of transactions included in the calculation), with each record formatted as a structured data entry that can be used for payment processing, audit verification, regulatory reporting, and historical tracking purposes. For example, when generating interim fee records for the January 2025 reconciliation period, the data processing subsystem 216 creates a record for “Capital Finance Group” comprising partner identification “Partner ID: CFG-2025-001, Name: Capital Finance Group LLC, Account: CFG-Banking-4789, Contact: Sarah Johnson, Phone: (555) 123-4567,” fee amount “$243,785.00,” calculation basis “62 transactions totaling $11,550,000: Business Day (45 trans, $8.5M×1.75%=$148,750), Weekend (12 trans, $2.1M×2.25%=$47,250), Holiday (5 trans, $950K×2.75%=$26,125), Processing Fees ($29,200), Volume Discount (−$7,540), Net Fee: $243,785,” and applicable time period “January 1, 2025 through January 31, 2025 (Transaction Processing Period),” simultaneously generating a separate record for “Premier Lending Solutions” with partner identification “Partner ID: PLS-2025-002, Name: Premier Lending Solutions Inc, Account: PLS-Corporate-9876,” fee amount “$201,500.00,” calculation basis “49 transactions totalling $9,400,000: Business Day (38 trans, $7.2M×2.0%=$144,000), Weekend (8 trans, $1.6M×2.5%=$40,000), Holiday (3 trans, $600K×3.0%=$18,000), Processing Fees ($24,500), No Adjustments Applied, Total Fee: $201,500,” and applicable time period “January 1-31, 2025,” with each generated record providing complete documentation that enables payment processing teams to issue accurate compensation, auditors to verify calculation accuracy, and compliance teams to maintain regulatory records showing exactly how each partner's interim fee was determined based on their specific transaction activity and contractual terms during the specified time period.

For generating the interim fee for the one or more partners, the data processing subsystem 216 is further configured to store the generated interim fee records in the cloud storage buckets for subsequent reconciliation and partner settlement processes. Storing the generated interim fee records means saving and preserving the structured fee documentation in a secure, accessible digital repository. The interim fee records are the comprehensive fee calculation documents that were previously created containing partner identification, fee amounts, calculation basis, and time periods. The cloud storage buckets are secure, scalable digital storage containers hosted on cloud computing platforms that provide reliable data storage, backup, and access capabilities. The cloud storage refers to remote data storage services provided by cloud computing platforms such as Amazon S3, Google Cloud Storage, or Microsoft Azure. The subsequent reconciliation refers to future financial verification and validation processes that will use the stored fee records to ensure accuracy and completeness. The reconciliation processes are systematic procedures for verifying that financial records are accurate, complete, and consistent across different systems and time periods. The partner settlement processes are the operational procedures for processing actual payments and finalizing financial transactions with partner organizations.

The data processing subsystem 216 ensures long-term data preservation and accessibility by systematically uploading each generated interim fee record to designated cloud storage buckets using secure transfer protocols, where the storage system organizes records using structured naming conventions and folder hierarchies (such as organizing by year, month, and partner), implements robust security measures including encryption at rest and in transit, access controls that limit who can view or modify records, and backup redundancy to prevent data loss, while maintaining detailed metadata that enables efficient retrieval and searching, with the stored records serving as the authoritative source for subsequent reconciliation processes that will verify fee accuracy against actual transaction data and partner settlement processes that will use the records to generate payment instructions, process actual compensation transfers, and maintain audit trails for regulatory compliance and financial reporting. For example, when storing generated interim fee records for January 2025, the data processing subsystem 216 uploads the “Capital Finance Group” record containing “$243,785.00 fee calculation based on 62 transactions” to cloud storage bucket “s3://loan-reconciliation/interim-fees/2025/01/” with filename “CFG-2025-001_InterimFee_Jan2025.json” including metadata tags “Partner: Capital Finance Group, Period: Jan2025, Amount: 243785.00, Status: Generated,” simultaneously stores the “Premier Lending Solutions” record with “$201,500.00 fee calculation” as “PLS-2025-002_InterimFee_Jan2025.json” in the same bucket structure, implements security measures including AES-256 encryption, access controls limiting retrieval to authorized reconciliation staff and payment processors, and automatic backup replication across multiple geographic regions, enabling subsequent reconciliation processes in February 2025 to retrieve and compare these stored records against actual payment confirmations to verify that Capital Finance Group received exactly $243,785.00 and Premier Lending Solutions received $201,500.00, while partner settlement processes access the stored calculation basis details to generate payment instructions showing “Wire $243,785.00 to CFG-Banking-4789 for 62 January transactions per stored fee record CFG-2025-001,” ensuring complete audit trails where the cloud-stored interim fee records serve as the definitive source for payment verification, dispute resolution, regulatory reporting, and historical analysis of partner compensation patterns across multiple reconciliation and settlement cycles.

In an embodiment of the present disclosure, each rule for the one or more proof sheet rulebooks are loaded, parsed and executed. Further, if the one or more rules corresponds to the semantic rules, the one or more rules are parsed and converted to Python formulas and applied to a dataset and the output is applied to a target cell. The loading of each rule for the one or more proof sheet rulebooks means systematically retrieving and importing individual business logic statements from the rulebook documents into the processing system. The parsing of each rule for the one or more proof sheet rulebooks means analyzing and interpreting the rule syntax to understand its structure, components, and intended logic. The execution of each rule for the one or more proof sheet rulebooks involves running or applying the rule to perform its intended calculation or operation. The one or more rules correspond to semantic rules means the business logic is written in natural language or business terminology rather than programming code. The semantic rules are business logic expressions written using domain-specific terminology and natural language constructs that describe financial operations. The parse and conversion of the rules into the machine-readable formulas involves translating the semantic business language into executable mathematical expressions or programming code. The machine-readable formulas are computational expressions that can be processed by computer systems, such as mathematical equations or programming functions. Applying the rules to the dataset means executing the converted formulas against specific financial data to perform calculations. The dataset refers to the collection of financial information such as loan amounts, partner fees, transaction dates, and settlement data. Applying of the output to the target cell means the calculated result is placed into a specific location within the proof sheet or workbook. The target cell is the designated location where the calculation result will be displayed or stored.

The data processing subsystem 216 performs systematic rule processing by first loading individual business rules from proof sheet rulebooks into active memory (retrieving rules like “calculate origination fee as 1.5% of loan amount for loans above $100,000”), then parsing each rule to understand its semantic structure and identify components such as conditions, calculations, and data references, followed by converting the parsed semantic rules into executable machine-readable formulas (transforming “calculate origination fee as 1.5% of loan amount” into “=IF(LoanAmount>100000, LoanAmount0.015, 0)”), executing these converted formulas against the relevant dataset containing actual financial data (applying the formula to loan amounts like $250,000, $150,000, $75,000), and finally placing the calculated outputs into designated target cells within the proof sheet (storing results like $3,750, $2,250, $0 in specific cells), with this process enabling business users to author rules in familiar terminology while ensuring accurate automated execution. For example, when processing a semantic rule “If loan amount exceeds $200,000 and partner is Capital Finance Group, then calculate broker fee as 2.25% of loan amount plus $500 processing fee,” the data processing subsystem 216 loads this rule from the “Commercial Loan Rulebook” into memory, parses the semantic structure to identify the conditions (loan amount>$200,000 AND partner=Capital Finance Group), calculation logic (loan amount×2.25%+$500), and data references (loan amount field, partner name field), converts the parsed rule into the machine-readable formula “=IF(AND(LoanAmount>200000, PartnerName=‘Capital Finance Group’), (LoanAmount0.0225)+500, 0),” applies this formula to the dataset containing loan records where one loan shows $350,000 amount with “Capital Finance Group” as partner (calculating $350,000×2.25%+$500=$8,375), another shows $150,000 with “ABC Partners” (calculating $0 due to failed conditions), and a third shows $275,000 with “Capital Finance Group” (calculating $275,000×2.25%+$500=$6,687.50), then applies these outputs to target cells in the proof sheet where Cell B15 displays “$8,375.00” for the first loan, Cell B16 shows “$0.00” for the second loan, and Cell B17 contains “$6,687.50” for the third loan, enabling the data processing subsystem 216 to automatically execute complex business logic written in natural language while producing accurate financial calculations that populate the appropriate locations within the reconciliation proof sheet.

In an embodiment of the present disclosure, the data processing subsystem 216 evaluates the machine-readable (e.g., Python) formulas and apply the evaluated Python formulas on the data dynamically to detect one or more data issues. In an embodiment of the present disclosure, the output workbook is stored in the s3 bucket. Evaluating the machine-readable formulas means systematically processing and executing the computational expressions that were previously converted from semantic rules. The machine-readable formulas are executable mathematical expressions, logical statements, or programming functions that can be processed by computer systems. The interpretation of machine-readable formulas in a machine-readable language refers to the process of parsing and executing formulas using computational languages such as Python, SQL, Excel functions, or other programming syntax. the machine-readable language is a computational syntax that computers can directly process and execute, such as programming languages, mathematical notation, or structured query languages. Applying the evaluated machine-readable formulas on the data dynamically means executing the processed formulas against live financial datasets in real-time as data changes or updates occur. Detecting the one or more data issues means identifying problems, inconsistencies, errors, or anomalies within the financial data through formula-based analysis. The data issues are problems within the financial dataset such as missing values, inconsistent amounts, duplicate entries, calculation errors, or values that fall outside expected ranges.

The data processing subsystem 216 performs comprehensive data validation by systematically evaluating machine-readable formulas that have been converted from business rules, where the evaluation process involves interpreting formulas using computational engines (such as Python pandas for data analysis, Excel calculation engine for spreadsheet formulas, or SQL processors for database queries) that can parse mathematical expressions, logical conditions, and data manipulation commands, then applying these evaluated formulas dynamically against live financial datasets so that whenever data changes or updates occur, the formulas automatically re-execute to perform validation checks, with the system designed to detect various data issues including range validation (identifying loan amounts outside acceptable limits), consistency checks (finding mismatched data between related fields), completeness verification (detecting missing required information), duplicate detection (identifying repeated transactions), mathematical accuracy (verifying calculation correctness), and business rule compliance (ensuring data meets established criteria), with all detected issues flagged for operator review and resolution. For example, when evaluating machine-readable formulas for loan reconciliation data validation, the data processing subsystem 216 processes the formula “=IF(LoanAmount<50000 OR LoanAmount>5000000, ‘RANGE_ERROR’, ‘VALID’)” using Excel's calculation engine to check loan amounts against acceptable limits, simultaneously executes the Python formula “df[df[‘LoanAmount’]!=df[‘SettlementAmount’]+df[‘Fees’]].index.tolist( )” to detect mathematical inconsistencies where loan amounts don't equal settlement plus fees, and runs the SQL query “SELECT loan_id, COUNT( ) FROM transactions GROUP BY loan_id HAVING COUNT( )>1” to identify duplicate loan entries, applying these evaluated formulas dynamically to a dataset containing 500 loan records where the range validation formula detects 3 data issues (two loans with amounts of $25,000 and $6,500,000 that fall outside the $50,000-$5,000,000 acceptable range, and one loan with a negative amount of −$150,000), the mathematical consistency formula identifies 8 data issues where loans like “LN-2025-001234” show $250,000 loan amount but settlement of $245,000 plus fees of $3,500 totalling $248,500 (creating a $1,500 discrepancy), and the duplicate detection query finds 2 data issues where loan “LN-2025-005678” appears twice with different settlement amounts, with all detected issues automatically flagged in the data processing subsystem 216 as “RANGE_ERROR: Loan LN-2025-001111 amount $25,000 below minimum,” “MATH_ERROR: Loan LN-2025-001234 settlement mismatch $1,500,” and “DUPLICATE_ERROR: Loan LN-2025-005678 appears 2 times,” enabling operators to immediately identify and resolve data quality problems before proceeding with reconciliation processing.

Further, the data processing subsystem 216 includes or excludes transactions based on when the transactions are handled by each of the one or more partners or where the transactions are in the process of money movement. In an embodiment of the present disclosure, the data processing subsystem 216 process data, rules, operators and formulas. Including the transactions refers to incorporating specific financial transactions into the active reconciliation dataset for processing and calculation. Excluding the transactions means removing specific financial transactions from the reconciliation dataset so they are not processed or calculated. When the transactions are handled by each of the one or more partners refers to the timing and processing status of transactions as managed by individual partner organizations. Where the transactions are in process of money movement refers to the current status or stage of financial transfers and fund movements associated with the transactions. In process of money movement describes transactions that are currently undergoing financial transfer activities such as pending settlements, funds in transit, clearing processes, or awaiting final payment confirmation. The money movement refers to the actual transfer of funds between accounts, institutions, or parties involved in the loan transaction.

The data processing subsystem 216 makes selective transaction processing decisions by evaluating each transaction against two key operational criteria, where the first criterion examines the timing and handling status of transactions by individual partners to determine if they should be included (such as including transactions that have been fully processed and confirmed by partners) or excluded (such as excluding transactions still pending partner approval or processing), while the second criterion assesses the current stage of money movement to decide inclusion based on fund transfer status, where transactions may be included if funds have been successfully transferred and settled, or excluded if money is still in transit, pending clearance, or awaiting final settlement confirmation, with these inclusion/exclusion decisions ensuring that only appropriate transactions are processed in the reconciliation based on their operational readiness and financial completion status. For example, when processing 200 loan transactions for reconciliation, the data processing subsystem 216 evaluates each transaction using the partner handling criterion and excludes 25 transactions where “Capital Finance Group” has not yet completed their internal approval process (transactions still marked as “Partner Processing” status), includes 150 transactions where “Premier Lending Solutions” has fully processed and confirmed their handling (marked as “Partner Confirmed”), and excludes 15 transactions where “ABC Investment Partners” is experiencing system delays (marked as “Partner Pending”), simultaneously applying the money movement criterion to exclude 30 transactions where funds are still in transit between banks (showing status “ACH Pending” or “Wire In Progress”), include 140 transactions where money movement has been completed with funds successfully settled (showing “Settlement Complete” status), and exclude 20 transactions where settlement is awaiting final clearance (showing “Clearing Hold” status), resulting in the data processing subsystem 216 including 110 transactions that meet both criteria (partner has completed handling AND money movement is finalized) for active reconciliation processing while excluding 90 transactions that fail one or both criteria, ensuring that only transactions with confirmed partner processing and completed fund transfers are included in fee calculations and reconciliation analysis, while excluded transactions remain in a pending status until their partner handling is completed or money movement reaches final settlement, at which point they may be re-evaluated for inclusion in subsequent reconciliation cycles.

Further, the data processing subsystem 216 stores the proof sheet templates, proof sheet rulebooks, proof sheet configurations, financial data defined in the rulebook, the dynamic workbook, the interim fee, and the one or more exceptions in cloud storage buckets. Storing means saving and preserving digital information in a secure, persistent storage system for long-term retention and future access. The proof sheet templates are standardized spreadsheet frameworks that define the structure, layout, and formatting for loan reconciliation documents. The proof sheet rulebooks are structured documents containing business rules, calculation logic, and processing instructions that govern how reconciliation calculations are performed. The proof sheet configurations are settings files that specify data source connections, processing parameters, and operational instructions for each type of proof sheet. The financial data defined in the rulebook refers to the actual monetary information, transaction records, and financial datasets that are processed according to the rules specified in the rulebooks. The dynamic workbook is the comprehensive spreadsheet document that contains integrated data, calculations, formulas, and results from the reconciliation process. The interim fee refers to the calculated compensation amounts determined for partner organizations based on their transaction activity. The one or more exceptions are identified discrepancies, errors, or anomalies discovered during the reconciliation process that require attention or resolution. The cloud storage buckets are secure, scalable digital storage containers hosted on cloud computing platforms that provide organized data storage with access controls and backup capabilities. The cloud storage refers to remote data storage services that offer reliability, scalability, and accessibility through internet-based platforms.

The data processing subsystem 216 performs comprehensive data preservation by systematically uploading all critical reconciliation components to designated cloud storage buckets using secure transfer protocols, where each component type is organized using structured naming conventions and folder hierarchies (such as templates stored in “/templates/2025/”, rulebooks in “/rulebooks/commercial/”, configurations in “/configs/daily/”), with the storage system implementing robust security measures including encryption at rest and in transit, role-based access controls that restrict viewing and modification permissions, automated backup replication across multiple geographic regions, and detailed metadata tagging that enables efficient searching and retrieval, while maintaining version control to track changes over time and ensuring all stored components serve as authoritative sources for audit trails, regulatory compliance, disaster recovery, and future reconciliation processes. For example, when storing reconciliation components for January 2025 commercial loan processing, the data processing subsystem 216 uploads proof sheet templates including “Commercial_Loan_Template_v2.3.xlsx” and “Daily_Settlement_Template_v1.8.xlsx” to cloud bucket “s3: //loan-reconciliation/templates/2025/01/” with metadata tags indicating template version and effective dates, stores proof sheet rulebooks including “Commercial_Loan_Rules_2025.json” containing 47 business rules and “Partner_Fee_Rules_v3.1.json” with partner-specific calculation logic to bucket “s3://loan-reconciliation/rulebooks/commercial/” with access restricted to senior analysts, uploads proof sheet configurations including “daily_recon_config.json” specifying database connections and “partner_api_config.json” containing API endpoints to “s3://loan-reconciliation/configs/daily/” with encryption enabled, stores financial data including loan transaction files totalling $45 million, partner fee schedules, and settlement records to “s3://loan-reconciliation/financial-data/2025/01/” with strict access controls limiting viewing to authorized personnel, saves the dynamic workbook “Commercial_Reconciliation_Jan2025.xlsx” containing 200 loan records, integrated calculations, and proof sheet results to “s3://loan-reconciliation/workbooks/2025/01/” with automatic versioning, uploads interim fee records showing $243,785 for Capital Finance Group and $201,500 for Premier Lending Solutions to “s3://loan-reconciliation/interim-fees/2025/01/” with payment processing metadata, and stores 15 identified exceptions including 3 duplicate transactions, 8 settlement mismatches, and 4 missing partner confirmations to “s3://loan-reconciliation/exceptions/2025/01/” with priority flags and resolution tracking, ensuring all components are securely preserved with appropriate access controls, backup redundancy, and organizational structure that enables efficient retrieval for audit purposes, regulatory reporting, dispute resolution, and future reconciliation cycles while maintaining complete data integrity and compliance with financial industry security standards.

In an embodiment, the data loader subsystem 214 and the data processing subsystem 216 are configured to be controlled through the no-code configuration interface for defining source criteria and dynamically generating the one or more rules associated with financial operations, without programming input. The data loader subsystem 214 and the data processing subsystem 216 are the specialized software components responsible for retrieving financial data from external sources and processing that data for reconciliation calculations, respectively. The no-code configuration interface is a graphical user interface that allows users to set up and manage system operations without writing programming code, typically using visual tools, dropdown menus, forms, and point-and-click selections. The source criteria are the specific parameters such as database connection strings, file locations, date ranges, data filters, and selection conditions that define how and what data should be obtained. Dynamically generating the one or more rules means automatically creating business logic and calculation instructions based on user inputs and configurations rather than requiring manual programming. The one or more rules associated with financial operations are the business logic statements that govern how financial calculations, validations, and processing should be performed. The financial operations refer to loan processing activities such as fee calculations, settlement processing, partner compensation, and reconciliation procedures. Without programming input means users can configure and control the system without writing code, scripts, or programming languages.

The data processing subsystem 216 operates through an intuitive no-code configuration interface that enables business users to control both data loading and processing operations using visual configuration tools, where users can define source criteria by selecting from dropdown menus of available databases, APIs, and file servers, specifying connection parameters through form fields rather than connection strings, setting data filters using calendar widgets and numeric range selectors, and establishing processing rules through drag-and-drop rule builders that convert business terminology into executable logic, with the interface dynamically generating the underlying technical configurations, database queries, API calls, and calculation formulas based on user selections, eliminating the need for programming knowledge while ensuring that complex financial operations such as multi-source data integration, partner fee calculations, and exception detection can be configured and modified by operations staff through point-and-click interactions rather than requiring developer intervention. For example, when configuring a new commercial loan reconciliation process, a business analyst uses the no-code interface to define source criteria by selecting “Commercial Bank Database” from a dropdown menu of available sources, specifying date range “January 1-31, 2025” using calendar widgets, setting loan amount filter “≥$100,000” through numeric input fields, and choosing data fields like “loan_id, principal_amount, funding_date” through checkbox selections, then dynamically generates financial operation rules using a visual rule builder to create “IF loan amount>$200,000 THEN apply 2.25% partner fee ELSE apply 1.75% partner fee” through dropdown selections for conditions (“loan amount”), operators (“>”), values (“$200,000”), and actions (“apply fee rate”), with the interface automatically converting these visual configurations into technical specifications including database connection string “jdbc:postgresql://commercial.bank.com:5432/loans”, SQL query “SELECT loan_id, principal_amount, funding_date FROM loans WHERE funding_date BETWEEN ‘2025-01-01’ AND ‘2025-01-31’ AND principal_amount>=100000”, and executable formula “=IF(LoanAmount>200000, LoanAmount0.0225, LoanAmount0.0175)” without requiring the analyst to write any programming code, enabling the system to automatically connect to the commercial bank database, retrieve 150 qualifying loan records totaling $28 million, and apply the appropriate fee calculations based on the visually configured rules, demonstrating how complex financial data integration and processing operations can be configured and controlled entirely through intuitive graphical interfaces without programming input while maintaining full technical functionality and accuracy.

The controlling of the data loader subsystem 214 and the data processing subsystem 216 through the no-code configuration interface, comprises providing a graphical user interface comprising visual selection tools for specifying connections of the one or more data sources from the one or more adapters without requiring code syntax. Providing the graphical user interface means creating and displaying a visual software interface that users can interact with through mouse clicks, keyboard input, and visual elements. The graphical user interface is a visual software interface that allows users to interact with computer systems through graphical elements like windows, buttons, menus, and forms rather than text-based commands. The visual selection tools are interactive graphical elements such as dropdown menus, checkboxes, radio buttons, drag-and-drop areas, point-and-click selectors, and form fields that allow users to make selections visually. Specifying the connections involves defining and establishing the technical parameters needed to link the reconciliation system with external data sources. The connections are the technical links and communication channels between the loan reconciliation system and external data repositories. Without requiring code syntax means that the users can configure connections without writing programming code, scripts, database queries, or technical commands. The code syntax refers to the specific programming language rules, commands, and technical formatting required to write functional computer code.

The data processing subsystem 216 presents users with an intuitive graphical interface that eliminates technical complexity by offering visual selection tools such as dropdown menus populated with available data sources (databases, APIs, FTP servers), point-and-click adapter selection where users choose from icons representing different connection types (database adapter, API adapter, file adapter), drag-and-drop configuration areas where users can visually map data fields, form-based parameter entry where connection details are entered through labelled text fields and selection boxes, and interactive wizards that guide users through connection setup steps, with all visual interactions automatically generating the underlying technical configurations, connection strings, authentication parameters, and adapter specifications without exposing users to programming syntax, enabling business users to establish complex data source connections through intuitive visual interactions while the system handles all technical implementation details behind the scenes. For example, when configuring data source connections for mortgage reconciliation, a business analyst uses the graphical interface to specify connections by selecting “Mortgage Bank Database” from a dropdown menu of available data sources, clicking on the “Database Adapter” icon from a visual palette of adapter types, entering connection details through labelled form fields including “Server Name: mortgage.bank.com,” “Database: loan_records,” “Username: recon_user” without writing connection strings, using drag-and-drop tools to map data fields by dragging “loan_amount” from a source field list to a target field labelled “Principal Amount,” selecting authentication method “SQL Server Authentication” from radio button options, and clicking “Test Connection” button to verify connectivity, with the interface automatically generating the technical connection string “jdbc:sqlserver://mortgage.bank.com:1433;databaseName=loan_records;user=recon_user;password=encrypted_pwd” and adapter configuration parameters behind the scenes, simultaneously configuring a “Partner Fee API” connection by selecting it from the data source dropdown, choosing “API Adapter” from visual icons, entering “Base URL: https://api.partner.com/fees” in a form field, selecting “Bearer Token” authentication from a dropdown, and using a visual query builder to specify “GET /ees? date={current_date}&type=mortgage” without writing HTTP request syntax, enabling the analyst to establish connections to multiple data sources including the mortgage database (retrieving 200 loan records), partner API (accessing fee schedules for 15 partners), and settlement FTP server (downloading daily settlement files) entirely through visual selection tools and form-based inputs without requiring knowledge of SQL syntax, HTTP protocols, or FTP commands, while the system automatically handles all technical implementation details to create functional data source connections ready for reconciliation processing.

The controlling of the data loader subsystem 214 and the data processing subsystem 216 through the no-code configuration interface, further comprises generating one or more configuration files in one or more financial formats based on user selections made through dropdown menus, forms, and point-and-click selections, for each of the one or more data sources. Generating the one or more configuration files means automatically creating structured digital documents that contain technical specifications and parameters needed to operate the loan reconciliation system. The configuration files are structured data files (such as JSON, XML, YAML, or INI files) that store system settings, connection parameters, processing instructions, and operational specifications. The one or more financial formats refers to industry-standard data structures and file layouts specifically designed for financial industry services such as NACHA (ACH transactions), SWIFT (international transfers), FIX (trading), CSV (comma-separated values), XML (structured data), and JSON (JavaScript Object Notation), based on the choices and inputs provided by users through the graphical interface. The user selections are the specific choices, inputs, and preferences that users make when configuring the system. The dropdown menus are graphical interface elements that display a list of options when clicked, allowing users to select one choice from multiple available options. The forms are structured input interfaces containing labelled fields, checkboxes, radio buttons, and text boxes where users can enter information and make selections. The point-and-click selections are user interactions where clicking on graphical elements (buttons, icons, checkboxes) makes choices or triggers actions.

The data processing subsystem 216 automatically creates technical configuration files by translating user interface interactions into structured digital documents that contain all necessary parameters for system operation, where the generation process captures user selections from dropdown menus (such as choosing “PostgreSQL Database” or “REST API”), form inputs (such as entering server addresses, usernames, and port numbers), and point-and-click selections (such as clicking checkboxes for data fields or selecting authentication methods), then converts these visual choices into appropriate financial format specifications that match industry standards for the selected data source types, with each data source receiving its own dedicated configuration file containing connection parameters, data format specifications, processing rules, and operational settings formatted according to the requirements of that specific source type, ensuring that complex technical configurations are generated automatically without requiring users to understand file formats, syntax rules, or technical specifications. For example, when a business analyst configures connections to three data sources for commercial loan reconciliation, the data processing subsystem 216 generates configuration files by capturing user selections where the analyst chooses “Commercial Bank Database” from a dropdown menu, enters “server: commercial.bank.com, port: 5432, database: loans” in form fields, and clicks checkboxes for data fields “loan_id, principal_amount, funding_date,” resulting in the automatic generation of “commercial_bank_config.json” file containing ‘{“source_type”: “postgresql”, “connection”: {“host”: “commercial.bank.com”, “port”: 5432, “database”: “loans”, “username”: “recon_user”}, “data_format”: “SQL”, “fields”: [“loan_id”, “principal_amount”, “funding_date”], “query_template”: “SELECT {fields} FROM loans WHERE {criteria}”}’, simultaneously generates “partner_api_config.json” when the analyst selects “Partner Fee API” from dropdown, enters “https://api.partner.com/fees” in the base URL form field, and clicks “JSON Response Format” radio button, creating ‘{“source_type”: “rest_api”, “endpoint”: “https://api.partner.com/fees”, “method”: “GET”, “data_format”: “JSON”, “authentication”: {“type”: “bearer_token”}, “response_mapping”: {“partner_name”: “name”, “fee_rate”: “rate”, “effective_date”: “date”}}’, and produces “settlement_ftp_config.xml” when the analyst chooses “Settlement FTP Server” from dropdown, enters FTP credentials through form fields, and selects “NACHA Format” for file processing, generating ‘ftp.settlement.com21/daily_files/NACHAYYYYMMDDcents’, with each generated configuration file formatted in the appropriate financial industry standard (JSON for API connections, XML for FTP configurations, SQL parameters for database connections) and containing all technical specifications needed for the system to automatically connect to and process data from each source without requiring the analyst to understand file syntax, database connection strings, or API protocols.

The controlling of the data loader subsystem 214 and the data processing subsystem 216 through the no-code configuration interface, further comprises adapting semantic rule authoring through a visual rule builder that accepts business terminology input and converts one or more semantic expressions into machine-readable rule definitions. Adapting the semantic rule authoring means implementing and configuring a system that enables business users to create rules using natural language and domain-specific terminology rather than programming code. The semantic rule authoring is the process of creating business logic and calculation rules using meaningful business terms and natural language expressions that describe financial operations. The visual rule builder is a graphical interface tool that provides interactive elements for constructing business rules through drag-and-drop, form-based inputs, and visual selection rather than text-based coding. Accepting the business terminology input means that the data processing subsystem 216 can understand and process financial industry terms, loan processing vocabulary, and business concepts entered by users. The business terminology input refers to domain-specific language used in financial services such as “origination fee,” “settlement amount,” “partner commission,” “funding date,” and “loan principal”. Converting the one or more semantic expressions involves translating natural language business statements into structured, processable formats. The semantic expressions are business logic statements written in natural language that describe conditions, calculations, and operations using familiar business terms. The machine-readable rule definitions are structured, formatted rule specifications that computer systems can interpret and execute. The rule definitions are formal specifications that define the logic, conditions, calculations, and actions that should be performed by the data processing subsystem 216.

The data processing subsystem 216 provides an intuitive visual rule builder interface that enables business users to create complex financial rules by entering familiar business terminology and concepts through interactive forms, dropdown menus populated with financial terms, and drag-and-drop logic builders, where users can construct semantic expressions such as “If loan amount exceeds $200,000 and partner is Capital Finance Group, then calculate broker fee as 2.25% of loan amount plus $500 processing fee” using natural business language, with the data processing subsystem 216 automatically parsing these semantic expressions to identify business concepts (loan amount, partner names, fee calculations), logical operators (if-then conditions, comparisons), and mathematical operations (percentages, additions), then converting the parsed semantic expressions into structured machine-readable rule definitions using formats such as JSON rule objects, SQL conditional statements, or programming language functions that can be executed by the reconciliation engine, enabling business users to author sophisticated financial logic without programming knowledge while ensuring accurate automated execution. For example, when a business analyst uses the visual rule builder to create a partner fee calculation rule, they adapt semantic rule authoring by entering the business terminology “Calculate partner commission for Premium Lending Solutions as 2.5% of loan principal when loan amount is greater than $150,000 and funding occurs on weekdays” through a form-based interface where they select “Premium Lending Solutions” from a partner dropdown menu, enter “2.5%” in a commission rate field, choose “loan principal” from a calculation basis dropdown, set “greater than $150,000” using comparison operators and amount fields, and select “weekdays” from a timing conditions menu, with the visual rule builder accepting this business terminology input and automatically converting the semantic expression into the machine-readable rule definition ‘{“rule_id”: “partner_commission_001”, “conditions”: [{“field”: “loan_amount”, “operator”: “greater_than”, “value”: 150000}, {“field”: “partner_name”, “operator”: “equals”, “value”: “Premium Lending Solutions”}, {“field”: “funding_day”, “operator”: “in”, “value”: [“Monday”, “Tuesday”, “Wednesday”, “Thursday”, “Friday”]}], “actions”: [{“type”: “calculate”, “formula”: “loan_principal 0.025”, “target”: “partner_commission”}]}’ that the reconciliation engine can interpret and execute, enabling the system to automatically apply this rule to process 45 qualifying loans totalling $8.2 million for Premium Lending Solutions, calculating $205,000 in partner commissions for weekday-funded loans above $150,000 while excluding weekend transactions and smaller loans, demonstrating how business users can create sophisticated financial logic using familiar terminology through visual interfaces while the data processing subsystem 216 handles the technical conversion into executable rule definitions.

The controlling of the data loader subsystem 214 and the data processing subsystem 216 through the no-code configuration interface, further comprises automatically translating the semantic rules into executable formulas using the rule parser and compiler without manual code generation. Automatically translating means the system performs conversion processes without requiring human intervention or manual input. The semantic rules are business logic statements written in natural language or domain-specific terminology that describe financial operations and calculations. The executable formulas are computational expressions that can be processed and run by computer systems to perform calculations and operations. The rule parser is a software component that analyzes and interprets the structure, syntax, and meaning of semantic rules to extract their logical components. The compiler is a software component that converts parsed rule components into executable code, formulas, or computational instructions. Without manual code generation means the translation process occurs automatically without requiring users or developers to write programming code, scripts, or technical instructions. The manual code generation refers to the traditional process where programmers manually write code to implement business logic. The rule parser and compiler are two software components work together to perform the automatic translation process.

The data processing subsystem 216 performs seamless rule conversion through an automated two-stage process where the rule parser first analyzes semantic rules written in business terminology to identify and extract logical components such as conditions (loan amount thresholds), operators (greater than, equals), data references (partner names, loan fields), and actions (fee calculations, percentage applications), breaking down complex business statements into structured elements that can be processed computationally, then the compiler takes these parsed components and automatically generates executable formulas using appropriate computational syntax such as Excel functions, SQL expressions, Python code, or mathematical equations, with the entire translation process occurring transparently in the background without requiring users to understand programming languages, write code, or manually convert business logic into technical implementations, ensuring that business rules authored in familiar terminology are automatically transformed into functional computational expressions ready for execution. For example, when processing the semantic rule “Calculate origination fee as 1.75% of loan amount for Capital Finance Group when loan exceeds $100,000 and funding occurs on business days,” the data processing subsystem 216 automatically translates this by having the rule parser analyze and extract components including conditions (“loan exceeds $100,000” and “funding occurs on business days”), data references (“loan amount” and “Capital Finance Group”), mathematical operations (“1.75% of loan amount”), and logical structure (if-then relationship), then the compiler automatically generates the executable formula “=IF(AND(LoanAmount>100000, PartnerName=‘Capital Finance Group’, WEEKDAY(FundingDate,2)<=5), LoanAmount0.0175, 0)” without manual code generation, simultaneously processing another semantic rule “Apply weekend premium of 25% additional fee for all weekend transactions” where the parser extracts the weekend condition and premium calculation while the compiler generates “=IF(OR(WEEKDAY(FundingDate)=1, WEEKDAY(FundingDate)=7), StandardFee1.25, StandardFee)” automatically, enabling the system to translate 15 different semantic rules including complex multi-condition statements like “For Premier Lending Solutions, calculate broker commission as 2.25% of principal plus $500 processing fee when loan amount is between $200,000 and $500,000 and settlement occurs within 3 business days” into executable formulas such as “=IF(AND(PartnerName=‘Premier Lending Solutions’, LoanAmount>=200000, LoanAmount<=500000, NETWORKDAYS(FundingDate, SettlementDate)<=3), (LoanAmount0.0225)+500, 0)” without requiring any manual programming, demonstrating how business users can author rules in natural language while the automated rule parser and compiler system seamlessly converts them into functional computational expressions ready for immediate execution against loan datasets containing hundreds of transactions.

The controlling of the data loader subsystem 214 and the data processing subsystem 216 through the no-code configuration interface, further comprises providing real-time rule validation and syntax checking to determine whether the semantic rules conform to supported logic patterns. Providing the real-time rule validation means continuously monitoring and checking business rules as they are being created or modified by users, with immediate feedback and verification. The real-time refers to instantaneous or immediate processing that occurs as users interact with the system without delays or batch processing. The rule validation is the process of verifying that created rules are correct, complete, and will function properly when executed. The syntax checking involves analyzing the structure, format, and composition of rules to ensure they follow proper formatting and logical construction. The syntax refers to the correct arrangement and structure of rule components including conditions, operators, data references, and actions. The Semantic rules are business logic statements written in natural language or domain-specific terminology that describe financial operations and calculations. The supported logic patterns are the predefined, acceptable structures and formats that the system can recognize, process, and execute; and logic patterns are standardized templates or frameworks that define how business rules should be structured, including condition-action relationships, data flow patterns, and computational sequences.

The data processing subsystem 216 continuously monitors rule creation and modification activities by implementing real-time validation engines that instantly analyze each semantic rule as users type, select options, or modify conditions, performing comprehensive syntax checking that verifies proper rule structure (ensuring conditions are properly formed, operators are correctly used, data references are valid), logical consistency (confirming that rule logic makes business sense and mathematical operations are appropriate), and pattern compliance (checking that the rule structure matches one of the system's supported logic patterns such as simple if-then statements, complex multi-condition rules, mathematical calculations, or data lookup operations), with the validation system immediately providing visual feedback through color coding, error messages, warning indicators, or suggestion prompts that guide users to correct issues before rules are saved or executed, ensuring that only properly formatted, logically sound rules that conform to supported patterns are accepted into the data processing subsystem 216. For example, when a business analyst creates the semantic rule “Calculate partner fee as 2.5% of loan amount for Capital Finance Group when loan exceeds $150,000,” the data processing subsystem 216 provides real-time rule validation by immediately checking syntax as the user types, highlighting “loan amount” in green to indicate a valid data reference, showing “2.5%” with a checkmark to confirm proper percentage format, and displaying “Capital Finance Group” with validation that this partner exists in the system database, while simultaneously performing syntax checking that verifies the rule follows the supported logic pattern of “IF [condition] THEN [action]” structure, confirming that mathematical operations are properly formatted (percentage calculation), and validating that all referenced data fields are available, but when the user attempts to create an invalid rule like “Calculate fee as 2.5% of invalid_field when partner equals 999,” the real-time validation immediately displays error indicators including a red underline under “invalid_field” with tooltip “Field not found in data schema,” a warning icon next to “999” stating “Partner ID format invalid-use partner name,” and an overall rule status showing “Rule does not conform to supported logic patterns-missing proper condition structure,” enabling the analyst to immediately correct the rule to “Calculate partner fee as 2.5% of loan_amount for ABC Partners when loan_amount exceeds $150,000” which then shows all green validation indicators confirming the rule conforms to supported logic patterns and is ready for execution, demonstrating how real-time validation and syntax checking ensure that users create only properly structured, executable rules while providing immediate guidance to correct any formatting or logical issues before rules are saved to the data processing subsystem 216.

The controlling of the data loader subsystem 214 and the data processing subsystem 216 through the no-code configuration interface, further comprises adapting dynamic modification of the source criteria and rules through the graphical user interface without requiring at least one of: system restart and developer intervention. Adapting the dynamic modification means implementing and enabling the capability for users to make changes and updates to system configurations in real-time while the system continues to operate. The dynamic modification refers to the ability to alter, update, or change system settings, configurations, and rules while the system is actively running without interrupting operations. The source criteria are the parameters, conditions, and specifications that define which data sources to access, what data to retrieve, and how to filter or select information from external systems. The rules are the business logic statements, calculation instructions, and processing guidelines that govern how financial operations and reconciliation processes are performed through the graphical user interface that means the users can make modifications using visual interface elements such as forms, menus, buttons, and interactive controls rather than editing configuration files or writing code, without requiring at least one of system restart and developer intervention. The system restart refers to the process of shutting down and restarting the entire software application or system to apply configuration changes. The developer intervention means the involvement of programmers, software developers, or technical specialists to implement changes, write code, or modify system configurations.

The data processing subsystem 216 enables seamless operational flexibility by implementing hot-swappable configuration capabilities that allow business users to modify data source connections, update business rules, change processing parameters, and adjust operational settings through intuitive graphical interfaces while the system continues running and processing transactions, with changes taking effect immediately or during the next processing cycle without disrupting ongoing operations, eliminating the traditional requirements for system downtime (no restart needed) and technical expertise (no developer intervention required), achieved through modular architecture that supports real-time configuration reloading, rule engine hot-swapping, and dynamic data source connection management, ensuring that business users can respond quickly to changing requirements, correct operational issues, or implement new business logic without waiting for technical support or scheduled maintenance windows. For example, when a business analyst discovers that the partner fee rate for “Capital Finance Group” needs to change from 2.25% to 2.5% effective immediately due to a contract amendment, they adapt dynamic modification by logging into the graphical interface, navigating to the “Partner Rules” section, locating the existing rule “Calculate partner fee as 2.25% of loan amount for Capital Finance Group,” clicking the “Edit” button to open the rule modification form, changing the fee rate from “2.25%” to “2.5%” using a simple text field, and clicking “Apply Changes” which immediately updates the rule in the active system without requiring system restart (the reconciliation engine continues processing other transactions while the rule change takes effect) and without requiring developer intervention (no programmer needs to modify code, update configuration files, or deploy new software), with the system automatically validating the change, updating the rule engine, and applying the new 2.5% rate to subsequent Capital Finance Group transactions within minutes, simultaneously enabling the analyst to add a new data source by clicking “Add Data Source,” selecting “Partner Settlement API” from a dropdown, entering the API endpoint “https://api.newsettlement.com/data” in a form field, configuring authentication parameters through visual selections, and activating the connection with a single click, with the new data source becoming immediately available for reconciliation processing without system downtime or technical support, demonstrating how dynamic modification capabilities enable business users to make critical operational changes including rule updates affecting millions of dollars in transactions and new data source integrations through simple graphical interactions while maintaining continuous system operation and eliminating dependencies on technical resources or scheduled maintenance windows.

The controlling of the data loader subsystem 214 and the data processing subsystem 216 through the no-code configuration interface, further comprises storing one or more configuration parameters and the machine-readable rule definitions in the cloud storage buckets for persistent access across reconciliation sessions. Storing means saving and preserving digital information in a secure, persistent storage system for long-term retention and future retrieval. The one or more configuration parameters are the specific settings, values, and operational specifications that control how the loan reconciliation system functions, including data source connections, processing rules, user preferences, and system behaviors. The configuration parameters are individual settings such as database connection strings, API endpoints, file paths, processing schedules, validation thresholds, and operational flags that define system behavior. The machine-readable rule definitions are structured, formatted business logic specifications that have been converted from semantic rules into computational formats that computer systems can interpret and execute. The cloud storage buckets are secure, scalable digital storage containers hosted on cloud computing platforms that provide organized, accessible data storage with backup and recovery capabilities. The persistent access means the stored information remains available and accessible over extended periods of time, surviving system shutdowns, restarts, and maintenance cycles. The reconciliation sessions are individual processing cycles or operational periods during which loan reconciliation activities are performed.

The data processing subsystem 216 ensures operational continuity and consistency by systematically uploading all critical configuration parameters (such as data source connection details, processing schedules, validation rules, user preferences, and system settings) and machine-readable rule definitions (including converted business logic, calculation formulas, conditional statements, and processing instructions) to designated cloud storage buckets using secure transfer protocols and organized folder structures, where the storage system implements persistent access capabilities through redundant storage across multiple geographic locations, automated backup procedures, version control tracking, and high-availability architecture that ensures stored information remains accessible and retrievable across multiple reconciliation sessions, system restarts, user logins, and operational cycles, enabling seamless continuity where configuration settings and business rules established in one session are automatically available and consistent in all subsequent sessions without requiring reconfiguration or rule recreation. For example, when storing configuration parameters and rule definitions for a commercial loan reconciliation system, the data processing subsystem 216 uploads configuration parameters including database connection “postgresql://commercial.bank.com:5432/loans” with username “recon_user,” API endpoint “https://api.partner.com/fees” with bearer token authentication, processing schedule “daily at 6:00 AM EST,” validation threshold “loan amounts between $50,000-$5,000,000,” and user preference “email notifications enabled” to cloud storage bucket “s3://loan-reconciliation/config/2025/” with folder structure “/database-connections/”, “/api-settings/”, “/schedules/”, and “/user-preferences/”, simultaneously storing machine-readable rule definitions including converted business logic ‘{“rule_id”: “partner_fee_001”, “conditions”: [{“field”: “loan_amount”, “operator”: “greater_than”, “value”: 150000}], “actions”: [{“formula”: “loan_amount0.025”}]}’ for partner fee calculations, ‘{“rule_id”: “weekend_premium”, “conditions”: [{“field”: “funding_day”, “operator”: “in”, “value”: [“Saturday”, “Sunday”]}], “actions”: [{“formula”: “standard_fee1.25”}]}’ for weekend processing premiums, and 25 other rule definitions to “/rules/commercial/” and “/rules/partner-specific/” folders, with persistent access ensured through automated replication across three geographic regions (US-East, US-West, Europe), daily backup snapshots, and 99.99% availability guarantees, enabling seamless operation where a business analyst who configures partner fee rules on Monday can log out and return on Wednesday to find all configuration parameters and rule definitions exactly as configured, while a different analyst working the night shift can access the same stored configurations to process weekend transactions, and system administrators can restart the reconciliation engine for maintenance knowing that all 47 stored configuration parameters and 38 machine-readable rule definitions will be automatically reloaded from cloud storage, ensuring consistent system behavior and eliminating the need to reconfigure data sources, recreate business rules, or re-enter operational settings across the hundreds of reconciliation sessions that occur throughout the year.

The controlling of the data loader subsystem 214 and the data processing subsystem 216 through the no-code configuration interface, further comprises automatically applying updated configurations and rules to subsequent proof sheet generation processes without manual code deployment. Automatically applying means the system performs implementation and activation of changes without requiring human intervention or manual triggering. The updated configurations are modified system settings, data source parameters, processing instructions, and operational specifications that have been changed from their previous versions. The configurations refer to system settings such as data source connections, processing schedules, validation parameters, output formats, and operational preferences. The rules are business logic statements, calculation instructions, and processing guidelines that govern how financial operations and reconciliation processes are performed. The subsequent proof sheet generation processes refer to future reconciliation operations and document creation activities that occur after the configurations and rules have been updated. The proof sheet generation processes are the systematic procedures for creating reconciliation documents that verify loan transactions, partner fees, settlements, and financial accuracy, without manual code deployment that means changes are implemented and activated without requiring developers to manually install software updates, modify program files, restart services, or execute technical deployment procedures. The manual code deployment refers to traditional software update processes where technical personnel must manually install code changes, restart systems, or execute deployment scripts. The code deployment is the process of installing, activating, and implementing software changes in a production environment.

The data processing subsystem 216 implements seamless change propagation through automated deployment mechanisms that continuously monitor stored configurations and rule definitions for updates, then automatically detect when changes have been made (such as modified data source connections, updated business rules, or altered processing parameters), and immediately apply these changes to all active proof sheet generation processes without requiring technical intervention, achieved through hot-reloading capabilities that refresh system components in real-time, dynamic rule engine updates that incorporate new business logic without service interruption, and configuration management systems that propagate changes across all processing modules, ensuring that any modifications made through the no-code interface are instantly available to subsequent reconciliation operations without waiting for scheduled deployments, system restarts, or developer involvement, maintaining continuous operational capability while ensuring all future proof sheet generation uses the most current configurations and rules. For example, when a business analyst updates the partner fee rule for “Capital Finance Group” from 2.25% to 2.5% through the no-code interface at 10:30 AM, the data processing subsystem 216 automatically applies this updated rule configuration by detecting the change in cloud storage, refreshing the active rule engine within 30 seconds, and ensuring that all subsequent proof sheet generation processes use the new 2.5% rate without manual code deployment, demonstrated when the next scheduled reconciliation runs at 11:00 AM and automatically processes 45 new Capital Finance Group transactions using the updated 2.5% fee rate (calculating $281,250 in fees instead of the previous 2.25% rate that would have generated $253,125), simultaneously applying an updated data source configuration where the analyst added a new “Settlement API” connection at 2:15 PM, with the system automatically incorporating this new data source into the 3:00 PM proof sheet generation process that retrieves settlement data from both the existing FTP server and the newly configured API endpoint, processing 150 settlement records from the FTP source and 75 additional records from the new API source to create comprehensive proof sheets totalling $12.8 million in reconciled transactions, while a third example shows an updated validation rule requiring loan amounts between $75,000-$3,000,000 (changed from the previous $50,000-$5,000,000 range) being automatically applied to the 4:30 PM reconciliation cycle that immediately flags 12 transactions outside the new range without requiring any developer to manually deploy code changes, restart services, or execute deployment scripts, ensuring that all configuration updates, rule modifications, and system changes made through the graphical interface are seamlessly and automatically incorporated into ongoing proof sheet generation processes while maintaining continuous system operation and eliminating traditional deployment delays and technical dependencies.

The plurality of subsystems 110 further includes the data aggregator subsystem 218 that is communicatively connected to the one or more hardware processors 202. The data aggregator subsystems 218 is configured to detect one or more exceptions in the loan reconciliation by aggregating the one or more proof sheets based on the obtained financial data and the updated dynamic workbook. In another embodiment of the present disclosure, the data aggregator is the module/subsystem loading the proof sheet configuration to bring in the data set and, in each configuration, there are rules for each source defined using JSON. For example, load window: N . . . N−5 instruction loads data of 5 days, select: A, B, C instruction will only select specific columns, the instruction exclude, excludes specific columns, the instruction-sum, adds specific columns, the instruction—skip, skips certain transactions, the instruction—codes, includes specific transaction codes and the like. In an exemplary embodiment of the present disclosure, the one or more exceptions include duplicate transactions, missing transactions, transactions posted to a wrong account, accounting errors, timing differences, lender errors, and the like. In an embodiment of the present disclosure, the data aggregator subsystem 218 runs the one or more proof sheet configurations based on one or more configuration parameters. For example, the one or more configuration parameters include time, holiday rules, weekend rules, transaction timing of the one or more partners, and the like.

The data aggregator subsystem 218 operates as an intelligent orchestration engine that systematically evaluates and processes multiple configuration parameters to determine optimal timing and conditions for executing proof sheet generation, where the subsystem continuously monitors time parameters by tracking system clocks, business hours, and scheduled processing windows to trigger reconciliation activities at predetermined intervals, applies holiday rules by consulting federal and banking holiday calendars to automatically adjust processing schedules and accommodate non-business days, implements weekend rules by detecting Saturday and Sunday dates and modifying operational behaviors such as limiting processing scope or applying premium calculations, and coordinates transaction timing of the one or more partners by tracking individual partner submission schedules and data availability to ensure all required information is present before initiating proof sheet creation For example, the data aggregator subsystem 218 (a) running daily commercial loan reconciliation configurations every weekday at 6:00 PM EST when the time parameter indicates end-of-business processing should commence, (b) automatically applying holiday rules by detecting that Independence Day falls on a Thursday and postponing that day's reconciliation until Friday while extending all partner deadlines by 24 hours and sending automated notifications to stakeholders, (c) implementing weekend rules by recognizing Saturday operations and activating limited processing modes that handle only urgent transactions exceeding $1 million while applying 25% weekend premium fees and suspending routine partner fee calculations, (d) managing transaction timing of the one or more partners by monitoring that “Capital Finance Group” consistently submits transaction files by 4:00 PM, “Premier Lending Solutions” uploads settlement data by 5:30 PM, and “Regional Bank” delivers comprehensive summaries by 7:00 PM, then (e) automatically triggering proof sheet configuration execution at 7:30 PM once all three partners confirm data submission, while dynamically adjusting to 8:30 PM on Fridays when Regional Bank requests extended processing time for weekly reconciliation activities, and (f) ensuring the data aggregator subsystem 218 maintains autonomous, parameter-driven proof sheet generation that seamlessly adapts to business schedules, regulatory requirements, partner operational constraints, and temporal variations without requiring manual oversight or intervention.

In an embodiment of the present disclosure, the data aggregator subsystem 218 extracts values from the one or more proof sheets and integrate output values to final accounting statements and portfolio activity. Furthermore, the data aggregator subsystem 218 monitors transactions, files from the one or more partners and banks to orchestrate the timing of creating the one or more proof sheets. In an embodiment of the present disclosure, the data aggregator subsystem 218 allows configuration driven output and scheduling. For example, the data aggregator subsystem 218 combines multiple proof sheets to pull all the exceptions and persist it separately.

In detail, the data aggregator subsystem 218 is a specialized software component responsible for collecting, combining, and analyzing financial information from multiple sources to identify discrepancies and issues. The one or more exceptions are discrepancies, errors, inconsistencies, or anomalies discovered during the reconciliation process that require attention or resolution. In another embodiment, the one or more exceptions include issues such as duplicate transactions, missing records, mathematical discrepancies, timing differences, data mismatches, or values that fall outside expected parameters. The loan reconciliation is the systematic process of verifying and validating that loan-related financial records are accurate, complete, and consistent across different systems and data sources. The one or more proof sheets are standardized reports that demonstrate the accuracy and completeness of loan reconciliation by showing transaction flows, calculations, and verification results. The obtained financial data refers to the raw financial information that was retrieved from external data sources such as databases, APIs, and file systems. The updated dynamic workbook is the comprehensive spreadsheet document that contains integrated data, calculations, formulas, and results after all processing and updates have been completed. The dynamic workbook serves as the central repository containing all reconciliation calculations, data relationships, and computational results.

The data aggregator subsystem 218 performs comprehensive exception detection by systematically collecting and analyzing information from multiple proof sheets (such as funding statements, settlement reports, partner fee calculations, and transaction summaries) along with the underlying financial data and integrated dynamic workbook calculations, using sophisticated comparison algorithms and validation logic to identify discrepancies such as mathematical inconsistencies where calculated totals don't match expected values, data mismatches where the same transaction appears differently across multiple sources, missing records where expected transactions are absent from reconciliation results, duplicate entries where identical transactions appear multiple times, timing discrepancies where transaction dates don't align with processing schedules, and threshold violations where amounts fall outside acceptable ranges, with the aggregation process cross-referencing data across all proof sheets and workbook calculations to ensure comprehensive coverage and accurate exception identification that enables operators to address issues before final reconciliation approval. For example, when the data aggregator subsystem 218 processes loan reconciliation for January 2025 containing 500 transactions across 15 partners, the data aggregator subsystem 218 detects exceptions by aggregating proof sheets including the “Funding Statement” showing $45 million in total loans, “Partner Fee Summary” displaying $1.2 million in calculated commissions, and “Settlement Report” indicating $43.8 million in net settlements, then cross-references this information with obtained financial data from bank databases, partner APIs, and settlement files along with the updated dynamic workbook containing integrated calculations, identifying 8 exceptions including 2 duplicate transactions where loan “LN-2025-001234” appears in both the morning and afternoon processing batches with identical $250,000 amounts, 3 mathematical discrepancies where partner “Capital Finance Group” shows calculated fees of $125,000 in the proof sheet but the dynamic workbook formula produces $127,500 due to a weekend premium that wasn't applied in the proof sheet, 1 missing record where settlement file contains transaction “ST-2025-005678” for $180,000 but no corresponding loan record exists in the funding proof sheet, and 2 timing exceptions where loans funded on January 15th appear in settlement records dated January 12th (impossible backward dating), with each detected exception automatically flagged with detailed descriptions such as “DUPLICATE: Loan LN-2025-001234 appears 2 times with identical amounts,” “MATH_ERROR: CFG partner fees mismatch $2,500 between proof sheet ($125,000) and workbook calculation ($127,500),” and “MISSING: Settlement ST-2025-005678 ($180,000) has no corresponding loan record,” enabling reconciliation operators to immediately identify and resolve these 8 exceptions from the 500 total transactions before approving the final reconciliation results and ensuring complete accuracy across all $45 million in processed loans.

For detecting the one or more exceptions in the loan reconciliation, the data aggregator subsystem 218 is configured to extract output values from the one or more proof sheets and integrate the extracted output values into final accounting statements and portfolio activity. Extracting output values means systematically retrieving specific calculated results, totals, and computed figures from completed reconciliation documents. The output values are the final calculated results, totals, summaries, and key figures produced by the reconciliation process, such as total loan amounts, partner fees, settlement figures, and exception counts. The one or more proof sheets are structured reconciliation documents that contain calculated results, transaction summaries, fee computations, and validation outcomes from the loan reconciliation process. The proof sheets are standardized reports that demonstrate reconciliation accuracy by showing transaction flows, calculations, and verification results. The extracted output values refers to the specific numerical results and calculated figures that have been retrieved from the proof sheets. The final accounting statements are comprehensive financial reports that summarize an organization's financial position, performance, and cash flows, including balance sheets, income statements, and cash flow statements. The portfolio activity refers to the comprehensive record of all loan-related transactions, performance metrics, risk assessments, and financial movements within an organization's loan portfolio. The portfolio encompasses the entire collection of loans, investments, and related financial instruments managed by the organization.

The data aggregator subsystem 218 performs systematic value extraction by scanning through completed proof sheets to identify and retrieve key calculated results such as total funded amounts, aggregate partner fees, net settlement figures, exception counts, and performance metrics, then systematically integrates these extracted values into the organization's broader financial reporting framework by updating general ledger accounts, populating regulatory reports, feeding management dashboards, and contributing to portfolio performance analysis, where integration involves mapping proof sheet results to appropriate accounting categories (such as recording loan origination fees as revenue, partner commissions as expenses, and settlement amounts as asset transfers), updating portfolio activity records with transaction volumes, risk metrics, and performance indicators, and ensuring that reconciliation results flow seamlessly into monthly financial statements, quarterly regulatory filings, and ongoing portfolio management systems, providing complete financial transparency and enabling accurate organizational reporting that reflects the verified and reconciled loan activity. For example, when extracting output values from January 2025 loan reconciliation proof sheets, the data aggregator subsystem 218 retrieves key figures including $45 million total loan originations from the “Funding Statement,” $1.2 million in partner commissions from the “Partner Fee Summary,” $43.8 million net settlement amount from the “Settlement Report,” 8 identified exceptions from the “Exception Summary,” and 95% reconciliation accuracy rate from the “Performance Metrics” sheet, then integrates these extracted output values into final accounting statements by posting $45 million as “Loans Originated” in the balance sheet assets section, recording $1.2 million as “Partner Commission Expense” in the income statement, updating cash flow statements with $43.8 million in “Settlement Cash Outflows,” and integrating into portfolio activity by updating the loan portfolio dashboard showing January volume of $45 million (bringing year-to-date total to $45 million), adding 500 new loan records to the portfolio management system with individual loan details, risk ratings, and partner associations, updating portfolio performance metrics including 2.67% average partner fee rate (calculated from $1.2M fees on $45M volume), 99.98% settlement accuracy (with only $100,000 in exceptions from $45M total), and geographic distribution showing 60% commercial loans, 40% residential mortgages across 12 states, enabling the organization's CFO to report accurate January financial results showing $45 million in new loan assets, $1.2 million in commission expenses, and maintaining a high-quality loan portfolio with minimal exceptions, while portfolio managers can track performance metrics, risk concentrations, and partner relationships using the integrated proof sheet output values that provide complete transparency into loan reconciliation results and their impact on overall organizational financial position and portfolio composition.

For detecting the one or more exceptions in the loan reconciliation, the data aggregator subsystem 218 is further configured to monitor transactions and files received from the one or more partners and the bank to orchestrate timing of creation of the one or more proof sheets. Monitoring the transactions and files means continuously observing, tracking, and analyzing the status and flow of financial data and documents in real-time. The transactions are individual financial operations such as loan fundings, fee payments, settlements, transfers, and other monetary exchanges between parties. The files are digital documents containing financial data such as transaction records, settlement reports, fee schedules, loan details, and reconciliation information, received from the one or more partners. The one or more partners are the various financial institutions, capital providers, brokers, investment groups, or service organizations involved in loan transactions; bank refers to the primary lending institution or financial entity that originates, funds, or services the loans being reconciled. The orchestration of timing means coordinating, managing, and controlling the sequence and timing of multiple related activities. The timing refers to the specific scheduling, sequencing, and temporal coordination of when activities should occur; creation involves the generation, production, and assembly of reconciliation documents. The one or more proof sheets are structured reconciliation documents that contain calculated results, transaction summaries, fee computations, and validation outcomes. The proof sheets are standardized reports that demonstrate reconciliation accuracy by showing transaction flows, calculations, and verification results.

The data aggregator subsystem 218 implements sophisticated monitoring capabilities that continuously track the arrival and processing status of financial transactions and data files from multiple sources including various partner organizations and banking institutions, using real-time data feeds, file system watchers, API polling mechanisms, and automated notification systems to detect when new transaction data becomes available, when settlement files are uploaded, when partner fee schedules are updated, or when banking records are transmitted, then uses this monitoring information to orchestrate the optimal timing for proof sheet creation by ensuring all necessary data components are available before initiating reconciliation processes, coordinating the sequence of proof sheet generation to align with data availability and business requirements, and managing dependencies between different proof sheets that may require data from multiple sources, ensuring that reconciliation documents are created only when complete and accurate data sets are available from all required partners and banking sources. For example, when monitoring transactions and files for commercial loan reconciliation, the data aggregator subsystem 218 tracks incoming data streams including real-time transaction feeds from “Commercial Bank” showing 45 new loan fundings totalling $8.5 million received at 9:15 AM, settlement files from “Capital Finance Group” uploaded via SFTP at 10:30 AM containing fee calculations for 25 transactions, API updates from “Premier Lending Solutions” received at 11:45 AM with commission data for 18 loans, and end-of-day summary files from “Regional Settlement Bank” delivered at 6:00 PM with final settlement confirmations, using this monitoring information to orchestrate timing of proof sheet creation by waiting until all required data sources have provided their daily submissions before initiating the “Daily Funding Statement” generation at 6:30 PM (ensuring all partner and bank data is available), scheduling the “Partner Fee Reconciliation” proof sheet creation for 7:00 PM after verifying that fee calculations from all 15 partners have been received, and coordinating the “Master Settlement Report” generation for 8:00 PM once banking settlement confirmations are processed, with the monitoring system automatically detecting when “ABC Investment Partners” fails to submit their daily fee file by the 5:00 PM deadline and sending alerts to operations staff while holding the related proof sheet creation until the missing data arrives at 5:45 PM, ensuring that all proof sheets are created with complete, accurate data from all required sources and preventing incomplete reconciliation documents that could result from missing partner transactions or delayed banking files, ultimately producing comprehensive proof sheets that accurately reflect the day's $8.5 million in loan activity across all monitored partners and banking relationships.

For detecting the one or more exceptions in the loan reconciliation, the data aggregator subsystem 218 is further configured to identify the one or more exceptions based on the extracted output values, and the monitored transactions and files, by combining the one or more proof sheets. Identifying the one or more exceptions means systematically locating, recognizing, and cataloguing specific discrepancies, errors, or anomalies within the reconciliation data. The one or more exceptions are discrepancies, inconsistencies, errors, or anomalies discovered during reconciliation analysis that deviate from expected patterns or violate business rules. The exceptions include issues such as duplicate transactions, missing records, mathematical discrepancies, timing differences, settlement mismatches, or values outside acceptable parameters. The extracted output values are the specific calculated results, totals, and key figures that were previously retrieved from completed proof sheets, such as loan amounts, partner fees, and settlement figures. The monitored transactions and files are individual financial operations being observed in real-time, while monitored files are digital documents containing financial data being tracked for arrival and processing. The proof sheets serve as standardized reports that demonstrate reconciliation accuracy through organized presentation of financial data and calculations.

The data aggregator subsystem 218 performs comprehensive exception identification by systematically cross-referencing extracted output values from completed proof sheets (such as total loan amounts, calculated partner fees, and settlement figures) against monitored real-time transaction data and incoming files from partners and banks, using sophisticated comparison algorithms that combine information across multiple proof sheets to detect inconsistencies such as when a funding statement shows $2.5 million in loans but partner fee calculations indicate fees based on $2.3 million (suggesting missing transactions), when settlement files from banks show different amounts than calculated settlement totals in proof sheets, when transaction timing in monitored files doesn't align with processing dates in proof sheet calculations, or when partner-reported transaction volumes don't match the aggregated totals across multiple proof sheets, with the combination process enabling comprehensive exception detection that wouldn't be possible by analyzing individual proof sheets in isolation, ensuring that discrepancies between real-time data streams and reconciliation calculations are systematically identified and flagged for resolution. For example, when identifying exceptions for January 2025 commercial loan reconciliation, the data aggregator subsystem 218 combines extracted output values including $8.5 million total loans from the “Daily Funding Statement,” $191,250 in partner fees from the “Partner Commission Report,” and $8.308 million net settlement from the “Settlement Summary” with monitored transactions showing real-time feeds of 45 individual loan records totalling $8.3 million from Commercial Bank and monitored files including partner fee schedules from 5 different partners, identifying exceptions by detecting that the extracted funding statement total of $8.5 million doesn't match the monitored transaction total of $8.3 million (indicating a $200,000 discrepancy), finding that “Capital Finance Group” reported fees of $45,000 in their monitored file but the extracted partner commission report shows $47,500 for their transactions (suggesting a calculation error or missing transactions), discovering that monitored settlement files from Regional Bank show $8.295 million while the extracted settlement summary indicates $8.308 million (creating a $13,000 mismatch), and identifying timing exceptions where monitored transaction file shows loan “LN-2025-001234” funded on January 15th but the combined proof sheet analysis reveals this same loan appearing in settlement calculations dated January 12th, with the systematic combination of extracted proof sheet values and monitored real-time data enabling identification of 6 specific exceptions including “AMOUNT\_MISMATCH: Funding total $8.5M vs monitored transactions $8.3M=$200K difference,” “PARTNER\_FEE\_ERROR: CFG reported $45K vs calculated $47.5K=$2.5K discrepancy,” and “SETTLEMENT\_VARIANCE: Bank file $8.295M vs proof sheet $8.308M=$13K difference,” ensuring comprehensive exception detection that combines static proof sheet calculations with dynamic transaction monitoring to identify discrepancies that require investigation and resolution before final reconciliation approval.

For detecting the one or more exceptions in the loan reconciliation, the data aggregator subsystem 218 is further configured to persist the identified one or more exceptions separately based on configuration-driven output and scheduling, by combining the one or more proof sheets. Persisting identified one or more exceptions means permanently saving and storing information in a durable storage system that maintains data integrity over time. The identified one or more exceptions are the specific discrepancies, errors, inconsistencies, or anomalies that have been discovered and catalogued during the reconciliation analysis process. The identified one or more exceptions include issues such as duplicate transactions, missing records, mathematical discrepancies, timing differences, settlement mismatches, or values outside acceptable parameters. The configuration-driven output refers to storage formats, file types, destinations, and organizational structures that are determined by user-configurable settings rather than fixed system defaults. The configuration-driven means the output characteristics are controlled by adjustable parameters and settings that users can modify. The output encompasses the various formats, destinations, and structures used for storing the exception data. The scheduling refers to the timing, frequency, and automated triggers that determine when exception persistence occurs. The proof sheets serve as the source documents from which exception information is extracted and consolidated.

The data aggregator subsystem 218 implements sophisticated exception persistence by systematically storing identified discrepancies and anomalies in dedicated storage locations using configurable output formats and automated scheduling mechanisms, where the persistence process combines exception information discovered across multiple proof sheets (such as funding statements, partner fee reports, settlement summaries, and transaction analyses) into consolidated exception records that maintain complete audit trails and detailed descriptions of each identified issue, with configuration-driven output enabling users to specify storage formats (such as JSON files for system integration, Excel spreadsheets for manual review, PDF reports for management distribution, or database records for automated processing), destination locations (such as specific cloud storage buckets, network folders, or database tables), and organizational structures (such as grouping by exception type, partner, date, or severity level), while scheduling capabilities automatically trigger exception persistence at predetermined intervals (such as immediately upon detection, hourly batches, end-of-day summaries, or weekly compilations) or based on specific events (such as completion of reconciliation cycles, detection of critical exceptions, or manual operator requests), ensuring that all identified exceptions are systematically preserved with appropriate formatting, timing, and accessibility for subsequent analysis, resolution tracking, and audit purposes. For example, when persisting identified exceptions from January 2025 commercial loan reconciliation, the data aggregator subsystem 218 stores 8 identified exceptions by combining information from multiple proof sheets including 2 duplicate transaction exceptions from the “Daily Funding Statement,” 3 mathematical discrepancy exceptions from the “Partner Fee Report,” 1 missing record exception from the “Settlement Summary,” and 2 timing inconsistency exceptions from the “Transaction Analysis Report,” using configuration-driven output settings that specify storage in three formats: JSON files for automated processing saved to “s3://loan-reconciliation/exceptions/2025/01/daily\_exceptions\_20250131.json” containing structured data like ‘{“exception\_id”: “EX-2025-001”, “type”: “DUPLICATE”, “description”: “Loan LN-2025-001234 appears twice with identical $250,000 amounts”, “source\_sheets”: [“Daily Funding Statement”, “Settlement Summary”], “severity”: “HIGH”, “detected\_date”: “2025-01-31T14:30:00Z”}’, Excel spreadsheets for manual review saved to network folder “\\\\finance\\reconciliation\\exceptions\\” with filename “January\_2025\_Exceptions\_Summary.xlsx” containing human-readable tables showing exception details, affected amounts, and resolution status, and PDF reports for management distribution automatically emailed to senior staff with executive summary format showing “8 exceptions identified totalling $425,000 in affected transactions requiring immediate attention,” while scheduling automatically triggers exception persistence immediately upon detection for critical exceptions (such as the $200,000 funding discrepancy that generates instant alerts), hourly batch processing for standard exceptions (consolidating routine duplicate detection and minor calculation differences), and end-of-day comprehensive reports (combining all daily exceptions into summary documents), ensuring that each of the 8 identified exceptions is systematically preserved with complete audit trails including source proof sheet references, detailed descriptions, affected transaction amounts, detection timestamps, and resolution tracking capabilities that enable operations staff to efficiently manage exception resolution while maintaining regulatory compliance and audit readiness through comprehensive exception documentation and storage.

The reconciliation engine includes a dynamic script executor configured to inject runtime code for handling the one or more exceptions and computing one or more complex formulas associated with the one or more exceptions. The reconciliation engine is the core processing component of the loan reconciliation system that manages data integration, rule execution, and calculation processing. The dynamic script executor is a specialized software component that can generate, modify, and execute programming code in real-time during system operation. The script executor is a software component that can interpret and run programming scripts or code segments. Injecting the runtime code means inserting, adding, or introducing new code into the running system without stopping or restarting operations. The runtime code refers to programming instructions that are created and executed while the system is actively running and processing data. The one or more exceptions are discrepancies, errors, inconsistencies, or anomalies discovered during reconciliation that require special processing or resolution. Computing the one or more complex formulas involves performing calculations, mathematical operations, or logical processing of the one or more complex formulas that are sophisticated mathematical expressions, multi-step calculations, or intricate business logic that cannot be handled by standard reconciliation rules. The complex formulas are advanced computational expressions that may involve multiple variables, conditional logic, iterative calculations, or specialized financial algorithms.

The reconciliation engine incorporates an advanced dynamic script executor that provides real-time code generation and execution capabilities specifically designed to handle exceptional situations and complex calculations that cannot be addressed by standard reconciliation rules, where the dynamic script executor monitors the reconciliation process for exceptions such as unusual transaction patterns, data inconsistencies, or calculation errors, then automatically generates and injects custom programming code tailored to resolve each specific exception, such as creating specialized formulas for handling multi-currency conversions when foreign transactions are detected, generating iterative calculation loops for complex fee structures that vary based on multiple conditions, or developing custom validation algorithms for unusual transaction types that don't fit standard processing patterns, with the runtime code injection capability enabling the system to adapt and respond to unexpected situations without requiring system shutdown, manual programming, or pre-configured exception handling rules, ensuring that even the most complex and unusual reconciliation scenarios can be processed accurately through dynamically generated computational solutions. For example, when the reconciliation engine encounters an exception involving “Capital Finance Group” transactions where their standard 2.25% fee structure doesn't apply to a complex loan package containing $2.5 million in commercial mortgages with varying risk ratings, geographic locations, and settlement timing requirements, the dynamic script executor automatically injects runtime code that computes complex formulas by generating a Python script ‘risk_adjusted_fee=base_amount (base_rate+(risk_multiplier geographic_factor timing_premium))’ where the script dynamically calculates individual risk multipliers (1.15 for high-risk properties, 1.05 for medium-risk, 1.0 for low-risk), geographic factors (1.08 for urban markets, 1.03 for suburban, 0.98 for rural), and timing premiums (1.12 for weekend settlements, 1.05 for holiday processing, 1.0 for business days), executing this injected runtime code to process the complex loan package by calculating fees of $63,250 for the $2.5M high-risk urban property with weekend settlement ($2.5M×2.25%×1.15×1.08×1.12), $58,875 for the $2.3M medium-risk suburban property with business day settlement ($2.3M×2.25%×1.05×1.03×1.0), and $54,145 for the $2.4M low-risk rural property with standard processing ($2.4M×2.25%×1.0×0.98×1.0), while simultaneously handling another exception where duplicate loan entries require complex deduplication logic by injecting runtime code that creates a sophisticated matching algorithm ‘if (loan_id_match AND amount_match AND date_within_24 hrs): mark_duplicate_and_consolidate( )’ that identifies and resolves 3 duplicate transactions totaling $750,000, demonstrating how the dynamic script executor enables the reconciliation engine to automatically generate and execute specialized code solutions for handling complex exceptions and computing intricate formulas that would be impossible to address through standard reconciliation rules, ensuring accurate processing of even the most unusual and complicated financial scenarios without requiring manual intervention or system modifications.

The plurality of subsystems 110 further includes the data output subsystem 220 that is communicatively connected to the one or more hardware processors 202. The data output subsystem 220 is configured to provide the generated interim fee, the created one or more proof sheets and the detected one or more exceptions, as an output, on graphical user interface screen of the one or more electronic devices 102. In an embodiment of the present disclosure, the detected one or more exceptions are outputted in one or more output formats for allowing the one or more operators to handle exceptions and one or more aged reconciliation issues. For example, the one or more output formats include native excel sheets with transaction data, accounting statements, web views, Portable Document Formats (PDFs), dashboards, reports, and the like. For example, the data output subsystem 220 offers the one or more output formats for the operations team to handle exceptions and also aged reconciliation issues. The data output subsystem 220 is a specialized software component responsible for presenting, displaying, and delivering processed reconciliation results to users through various interfaces and formats. The graphical user interface screen is the visual display interface that users interact with through monitors, tablets, or other electronic displays. The one or more electronic devices 102 are the computing hardware such as desktop computers, laptops, tablets, smartphones, or workstations used by operators. The one or more output formats are the various presentation styles, file types, and display methods used to present exception information. The output formats include visual presentations such as spreadsheets, reports, dashboards, charts, PDFs, or interactive displays. The one or more operators are the human users responsible for managing, reviewing, and resolving reconciliation issues. Handling the exceptions refers to the process of reviewing, investigating, and resolving identified discrepancies or errors. The one or more aged reconciliation issues are long-standing, unresolved discrepancies or problems that have persisted across multiple reconciliation cycles.

The data output subsystem 220 serves as the primary interface between the reconciliation system and human operators by systematically presenting all processed results including calculated interim fees, completed proof sheets, and identified exceptions through intuitive graphical displays on various electronic devices, where the subsystem formats and organizes information using multiple output formats such as interactive dashboards showing real-time exception counts and resolution status, detailed Excel spreadsheets containing transaction-level exception data for manual analysis, PDF reports providing executive summaries for management review, and specialized exception management interfaces that prioritize issues by severity and age, with particular emphasis on presenting aged reconciliation issues (such as exceptions that have remained unresolved for multiple processing cycles) in prominent, easily accessible formats that enable operators to efficiently identify, investigate, and resolve both current exceptions and historical discrepancies, ensuring that all reconciliation results are presented in user-friendly formats that facilitate effective exception management and resolution tracking. For example, when the data output subsystem 220 provides reconciliation results for January 2025 commercial loan processing, the data output subsystem 220 displays the generated interim fee totaling $1.2 million across 15 partners on the main dashboard screen of operators' desktop computers, presents created proof sheets including the “Daily Funding Statement” showing $8.5 million in processed loans and “Partner Commission Report” detailing individual partner calculations through interactive web-based interfaces accessible on tablets and laptops, and outputs detected exceptions including 8 current issues (2 duplicate transactions, 3 mathematical discrepancies, 1 missing record, 2 timing inconsistencies) in multiple output formats such as an Excel spreadsheet “January\_2025\_Exceptions. xlsx” containing detailed transaction data for manual investigation, a PDF executive summary “Monthly\_Exception\_Report.pdf” showing exception trends and resolution metrics for management review, an interactive dashboard displaying real-time exception status with color-coded priority levels (red for critical $200,000+ discrepancies, yellow for moderate issues, green for resolved items), and a specialized aged reconciliation interface highlighting 3 aged reconciliation issues including a $75,000 settlement discrepancy from November 2024 that remains unresolved, a recurring duplicate transaction pattern affecting “ABC Investment Partners” that has appeared in 4 consecutive months, and a systematic timing issue with “Regional Bank” settlement files that has persisted for 6 weeks, with each output format designed to enable operators to handle exceptions efficiently by providing drill-down capabilities for detailed investigation, bulk resolution tools for similar issues, automated escalation for aged items exceeding 30 days, and comprehensive audit trails showing resolution history, ensuring that operators can effectively manage both immediate exceptions requiring urgent attention and aged reconciliation issues that need systematic resolution to prevent recurring problems in future reconciliation cycles.

The plurality of subsystems 110 further includes the loan reconciliation management subsystem 222 that is communicatively connected to the one or more hardware processors 202. The loan reconciliation management subsystem 222 determines successful completion of the loan reconciliation process using the created one or more proof sheets, the obtained financial data and the updated dynamic workbook. Determining the completion of the loan reconciliation process means systematically evaluating, assessing, and making a conclusive decision about the status or outcome of a process. The loan reconciliation management subsystem 222 performs comprehensive completion assessment by systematically analyzing the consistency, accuracy, and completeness of information across three critical data sources, where the evaluation process examines created proof sheets to verify that all required reconciliation documents have been generated with complete calculations and no missing sections, reviews obtained financial data to confirm that all necessary source information was successfully retrieved and processed without data quality issues, and validates the updated dynamic workbook to ensure that all formulas have executed correctly, cross-references are consistent, and integrated calculations align with proof sheet results, with successful completion determined when all proof sheets show balanced totals, no critical exceptions remain unresolved, financial data integrity checks pass validation, dynamic workbook calculations are mathematically consistent across all sheets, and predetermined quality thresholds are met for accuracy, completeness, and data consistency, while unsuccessful completion is indicated by unresolved critical exceptions, mathematical discrepancies between data sources, missing required proof sheets, or failed validation checks that require additional processing or manual intervention.

For example, when determining successful completion of January 2025 commercial loan reconciliation processing $8.5 million across 500 transactions, the loan reconciliation management subsystem 222 analyzes created proof sheets including “Daily Funding Statement” showing balanced totals of $8.5 million in loans matching $8.5 million in funding sources, “Partner Commission Report” displaying $191,250 in calculated fees with all 15 partners having complete calculations, and “Settlement Summary” indicating $8.308 million in net settlements with no missing settlement records, examines obtained financial data confirming successful retrieval of 500 loan records from Commercial Bank database, complete partner fee schedules from all 15 partners via API connections, and settlement files from 3 banking institutions with 100% data completeness and no corrupted records, and validates the updated dynamic workbook showing consistent cross-sheet calculations where funding totals ($8.5M) minus partner fees ($191.25K) equals net settlement amounts ($8.308M) with all formulas executing without errors, cross-references between sheets matching perfectly, and validation rules confirming all transactions fall within acceptable parameters, resulting in successful completion determination when all proof sheets are complete and balanced, financial data shows 100% retrieval success with no quality issues, dynamic workbook calculations are mathematically consistent with zero formula errors, only 2 minor exceptions remain (both classified as informational rather than critical), and overall reconciliation accuracy measures 99.97% which exceeds the required 99.5% threshold, enabling the system to generate completion notification “January 2025 Commercial Loan Reconciliation COMPLETED SUCCESSFULLY: 500 transactions totalling $8.5M processed with 99.97% accuracy, all critical validations passed, 2 minor informational exceptions documented,” while a contrasting example shows unsuccessful completion when proof sheets contain $50,000 in unbalanced totals, financial data retrieval failed for 3 partner sources, dynamic workbook shows 15 formula errors, and 8 critical exceptions remain unresolved, requiring additional processing cycles before successful completion can be achieved.

Further, the loan reconciliation management subsystem 222 outputs a notification corresponding to the successful completion of the loan reconciliation process on graphical user interface screen of the one or more electronic devices 102. The notification is an alert, message, or announcement that informs users about a specific event, status change, or system condition. The loan reconciliation process is the comprehensive systematic procedure for verifying, validating, and confirming that loan-related financial records are accurate, complete, and consistent across different systems and data sources. The loan reconciliation management subsystem 222 generates and displays completion notifications by creating visual alerts and messages that appear on users' electronic device screens to inform operators, managers, and stakeholders that the reconciliation process has been successfully completed, where the notification system formats completion messages with key summary information such as total transaction volumes, processing accuracy percentages, completion timestamps, and any relevant metrics, then delivers these notifications through various graphical interface elements including pop-up windows that appear prominently on users' screens, dashboard status indicators that change color or display completion badges, email notifications with embedded summary reports, mobile app push notifications for remote users, and system status displays that update in real-time, with the notification delivery system targeting appropriate user groups based on their roles and responsibilities, ensuring that operations staff receive detailed technical completion information, management receives executive summaries, and stakeholders get relevant status updates through their preferred electronic devices and interface channels.

For example, when outputting notification for successful completion of January 2025 commercial loan reconciliation processing $8.5 million across 500 transactions, the loan reconciliation management subsystem 222 displays notifications on graphical user interface screens by showing a prominent green pop-up window on operations staff desktop computers stating “RECONCILIATION COMPLETED SUCCESSFULLY: January 2025 Commercial Loans—500 transactions totaling $8,500,000 processed with 99.97% accuracy at 11:45 PM EST on January 31, 2025,” simultaneously sending mobile push notifications to managers' smartphones displaying “Jan 2025 Loan Reconciliation Complete: $8.5M processed, 99.97% accuracy, 2 minor exceptions documented,” updating the main dashboard interface on tablets used by senior analysts to show a completion status badge changing from yellow “Processing” to green “Complete” with summary metrics “500 loans|$8.5M volume|15 partners|99.97% accuracy|2 exceptions,” generating email notifications delivered to stakeholders' laptops and desktop computers containing executive summary reports with completion confirmation and key performance indicators, and displaying system-wide status notifications on wall-mounted monitoring screens in the operations center showing “DAILY RECONCILIATION STATUS: COMPLETE” with timestamp and volume information, ensuring that all relevant personnel across different electronic devices and interface platforms receive appropriate completion notifications tailored to their roles, with operations staff getting detailed technical information for final review and sign-off, management receiving executive summaries for reporting and decision-making, and monitoring systems displaying real-time status updates that confirm successful completion of the critical daily reconciliation process affecting millions of dollars in loan transactions.

In operation, the data processing subsystem 216 runs continuously, and the data aggregator subsystem 218 decides based on the one or more proof sheet configurations and the transaction monitoring outputs to trigger the proof sheet creation. Further, the data loader subsystem 214 gets triggered to load all the data using various adapters, such as FTP adapter, SFTP, the API adapter, the S3 adapter, the RDBMS, the script adapter, and the like for each proof sheet and initiates the data processing subsystem 216. Furthermore, the data processing subsystem 216 runs through all the rules in the proof sheets and writes the output values to the proof sheet. The data processing subsystem 216 also runs data validator before using the aggregator to write the final output in excel and other file formats.

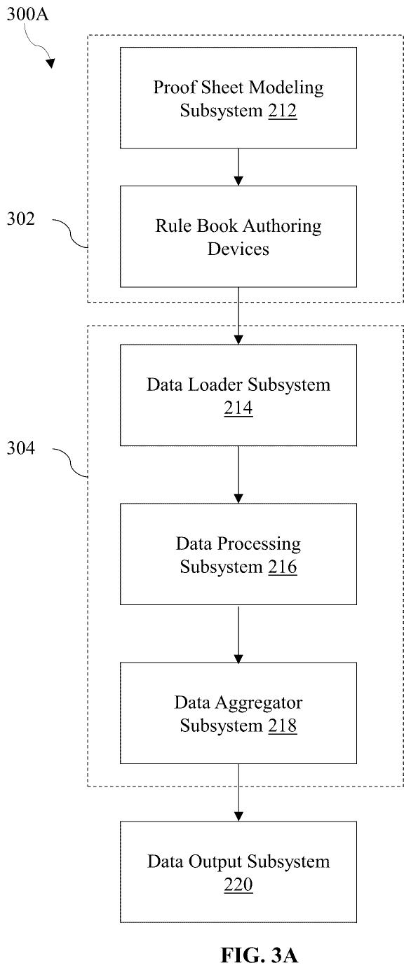

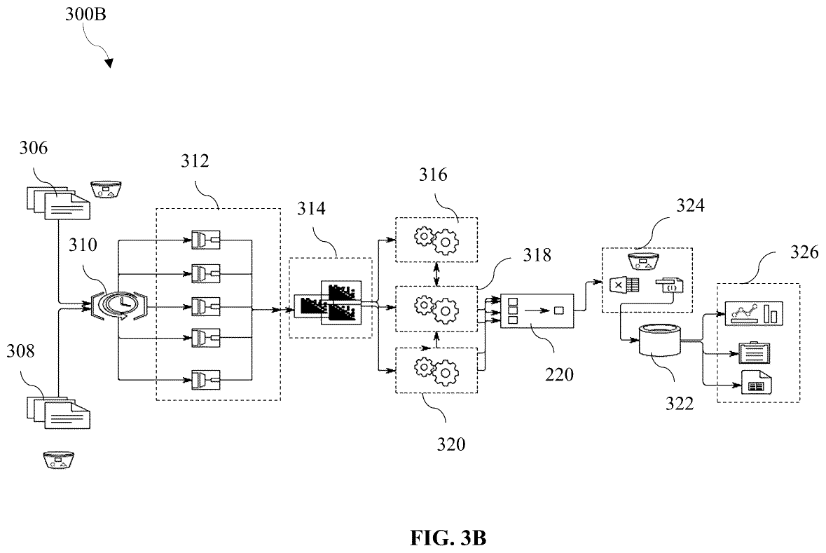

FIG. 3A is a block diagram 300A illustrating an exemplary operation of the computer-implemented system 104 for facilitating loan reconciliation of organizations, in accordance with an embodiment of the present disclosure. FIG. 3B is a pictorial depiction 300B illustrating an exemplary operation of the computer-implemented system 104 for facilitating loan reconciliation of organizations, in accordance with an embodiment of the present disclosure. For the sake of brevity, FIGS. 3A-B have been explained together.

The proof sheet modelling subsystem 212 defines the output template of how reconciliation may look like. Further, the rulebook authoring subsystem 218 defines the source data and writes semantic rules to process the data. In an embodiment of the present disclosure, the proof sheet modelling subsystem 212 and the rulebook authoring subsystem 218 corresponds to authoring 302, as shown in FIG. 3A. Furthermore, the data loader subsystem 214 allows configuration driven data load. In an embodiment of the present disclosure, the data processing subsystem 216 processes data, rules, operators and formulas. Further, the data aggregator subsystem 218 facilitates configuration driven output and scheduling. In an embodiment of the present disclosure, the data loader subsystem 214, the data processing subsystem 216 and the data aggregator subsystem 218 corresponds to an execution engine 304, as shown in FIG. 3A. Further, the data output subsystem 220 outputs the generated interim fee, the created one or more proof sheets and the detected one or more exceptions on graphical user interface screen of the one or more electronic devices 102 in one or more output formats, such as native excel sheets with transaction data, Portable Document Formats (PDFs), dashboards, reports, and the like.

In an embodiment of the present disclosure, proof sheet templates and proof sheet rulebooks 306 are received by scheduler job collections 310. In an exemplary embodiment of the present disclosure, the proof sheet templates, and the proof sheet rulebooks 306 are excel files. Further, the proof sheet configurations 308 are also received by the scheduler job collections 310. In an exemplary embodiment of the present disclosure, the proof sheet configurations 308 are. JSON files. In an embodiment of the present disclosure, the proof sheet templates, the proof sheet rulebooks 306, and the proof sheet configurations 308 are stored in S3 buckets. Further, all configurations required for the data loader subsystem 214 and the data processing subsystem 216 are stored in the proof sheet configurations 308. In an embodiment of the present disclosure, the scheduler job collections 310 run 37 proof sheet configurations 308 based on the time, holiday rules, weekend rules and transaction timing of our partners. In an embodiment of the present disclosure, a set of adapters 312 are part of the data loader subsystem 214 to handle various source systems and formats that need to be loaded into the data processing subsystem 216. In an exemplary embodiment of the present disclosure, the set of adapters 312 includes FTP adapter, SFTP, API adapter, S3 adapter, RDBMS adapter, a script adapter, and the like. Further, encoders 314 include National Automated Clearing House Association (NACHA), VISA, Bank Administration Institute (BAI), JavaScript Object Notation (JSON), Comma-Separated Values (CSV), excel files, Hypertext Markup Language (HTML) tables, and the like. In an embodiment of the present disclosure, the data processing subsystem 216 includes one or more components, such as data processing 316, a rule parser and formula parser 318 and a dynamic script executor 320, as shown in FIG. 3B. In an exemplary embodiment of the present disclosure, the data processing subsystem 216 performs data filtering, transaction grouping and matching, calculating credits and debits, and proof sheet rule processing. The rule parser 318 converts semantic rules to python formulas. Further, the dynamic script executor 320 handles exception scenarios to inject dynamic code for the engine to handle complex formulas. In an embodiment of the present disclosure, the data aggregator subsystem 218 aggregate transactions, proof sheets and capturing exception items. The data aggregator subsystem 218 also performs data aggregation and proof sheet generation, formula parsing, worksheet formatting and workbook consolidation. Further, in data lake 322, all the outputs are persisted for validation, historical tracking, auditing and governance 324. Furthermore, a dashboard 326 is used to view all proof sheet outputs, reconciliation views, reconciliation reports, aging exceptions, accounting statement generation, dashboards, portfolio view and tracking aged reconciliation items and also exception tracking of transaction. In an embodiment of the present disclosure, the computer-implemented system 104 corresponds to reconciliation engine running on Elastic Container Service (ECS) cluster.

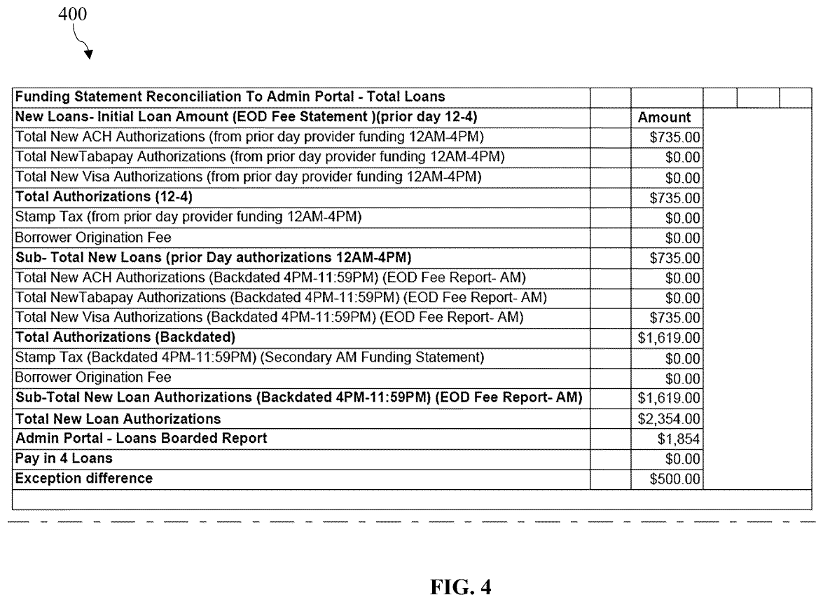

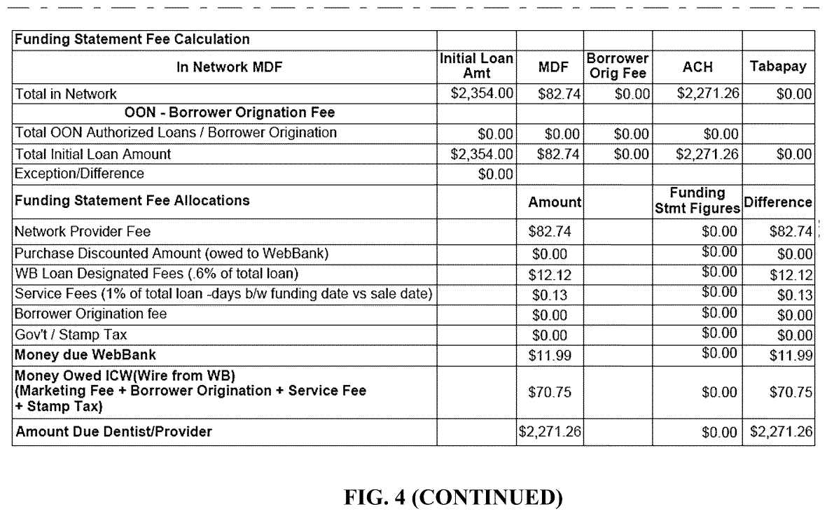

FIG. 4 is a pictorial depiction illustrating an exemplary proof sheet 400, in accordance with an embodiment of the present disclosure. In an embodiment of the present disclosure, the proof sheet 400 includes the funding statement. The funding statement reconciles by verifying every loan funded is issued by the bank, involves tracing money transfers through one or more channels. Verifying every loan funded means systematically confirming and validating that each individual loan transaction has received complete financial disbursement where money has been successfully transferred from the lending institution to the borrower, ensuring that all approved loans have progressed from authorization status to actual monetary delivery. Tracing the money transfers through one or more channels means systematically following, tracking, and documenting the complete path and movement of funds as they flow from the originating bank account to the borrower's designated account using various financial networks, systems, and transaction processing methods such as wire transfer networks, ACH systems, electronic payment platforms, check processing systems, or other monetary transmission mechanisms.

The verification process involves comprehensive examination of loan disbursement records to confirm that every approved loan has received actual funding, combined with detailed tracing of money transfers that follows the complete financial trail through multiple channels to establish definitive proof that funds originated from the legitimate banking institution and reached the intended borrower, where the tracing process utilizes various financial channels including wire transfer networks for immediate high-value transactions, ACH systems for standard electronic transfers, check processing networks for traditional paper-based payments, electronic payment platforms for digital transactions, and specialized lending channels for specific loan types, ensuring that each money transfer can be documented with complete audit trails showing origination accounts, destination accounts, transfer amounts, processing dates, transaction reference numbers, and channel-specific identifiers that provide irrefutable evidence of proper loan funding and legitimate financial flow. For example, when verifying every loan funded for January 2025 commercial lending totaling $3.2 million across 20 transactions, the system confirms each loan received actual disbursement by tracing money transfers through one or more channels such as loan “CL-2025-001234” for $500,000 where tracing reveals a wire transfer from Commercial Bank's lending account (12345-6789) through the Federal Reserve wire network (Reference: FED20250115-7891) to borrower's account at Regional Credit Union on January 15, 2025 at 2:30 PM EST, loan “CL-2025-001235” for $750,000 where tracing shows an ACH transfer from the bank's ACH origination account through the Automated Clearing House network (Trace Number: ACH20250116-4567) with settlement to the borrower's business account at First National Bank on January 16, 2025, and loan “CL-2025-001236” for $300,000 where tracing involves multiple channels including a $200,000 wire transfer (Reference: FED20250117-2345) for immediate construction funding and a $100,000 ACH transfer (Trace: ACH20250118-8901) for equipment purchase, ensuring that every loan funded totalling $1.55 million across these three examples can be verified through documented money transfer records across wire networks, ACH systems, and electronic payment channels, providing complete confirmation that all funded loans received actual disbursement from Commercial Bank through traceable financial pathways with specific transaction identifiers, processing timestamps, and channel documentation that establishes legitimate loan funding and proper money movement from lender to borrower.

Further, the funding statement reconciles by validating loans purchased from the bank by capital partners of a firm, in compliance with one or more underwriting rules. Validating the loans purchased from the bank means systematically confirming and verifying that loan acquisition transactions between the originating banking institution and secondary market investors or capital providers have been properly executed, documented, and transferred according to established procedures and contractual agreements. The underwriting rules are the specific criteria, standards, guidelines, and requirements used to evaluate loan quality, borrower creditworthiness, risk assessment parameters, and eligibility conditions that determine whether loans meet acceptable investment standards for purchase by capital partners.

The validation process involves comprehensive examination of loan purchase transactions to confirm that capital partners (such as investment firms, pension funds, or secondary market investors) have legitimately acquired loans from the originating bank in accordance with predetermined underwriting rules that specify acceptable loan characteristics including minimum credit scores, debt-to-income ratios, loan-to-value ratios, property types, geographic restrictions, and other risk assessment criteria, where the validation process verifies that purchased loans meet all specified underwriting standards, purchase agreements have been properly executed with appropriate documentation, loan transfers have been completed with proper legal assignments, and all regulatory compliance requirements have been satisfied, ensuring that capital partners receive loans that conform to their investment criteria and risk tolerance parameters while maintaining proper documentation and regulatory compliance throughout the purchase process. For example, when validating loans purchased from Commercial Bank by capital partners during January 2025, the system confirms that “Capital Investment Partners” purchased a $5 million loan portfolio consisting of 25 commercial mortgages in compliance with underwriting rules requiring minimum 720 credit scores (verified through credit reports showing all borrowers meet this threshold), maximum 75% loan-to-value ratios (confirmed through property appraisals showing LTV ratios ranging from 65% to 74%), debt-service coverage ratios above 1.25× (validated through borrower financial statements demonstrating ratios between 1.28× and 1.67×), properties located only in metropolitan areas within specified states (verified through property addresses confirming locations in Atlanta, Charlotte, and Nashville), and loan amounts between $150,000 and $500,000 (confirmed through loan documentation showing individual loans ranging from $175,000 to $485,000), while simultaneously validating that “Regional Pension Fund” purchased a $3.2 million residential mortgage portfolio of 40 loans in compliance with different underwriting rules requiring minimum 680 credit scores, maximum 80% LTV ratios, primary residence occupancy, and geographic concentration in suburban markets, ensuring that both capital partners received loan portfolios totaling $8.2 million that fully comply with their respective underwriting rules through documented verification of credit scores, property valuations, borrower qualifications, geographic distributions, and loan characteristics that meet all specified investment criteria and risk parameters established in their purchase agreements with Commercial Bank.

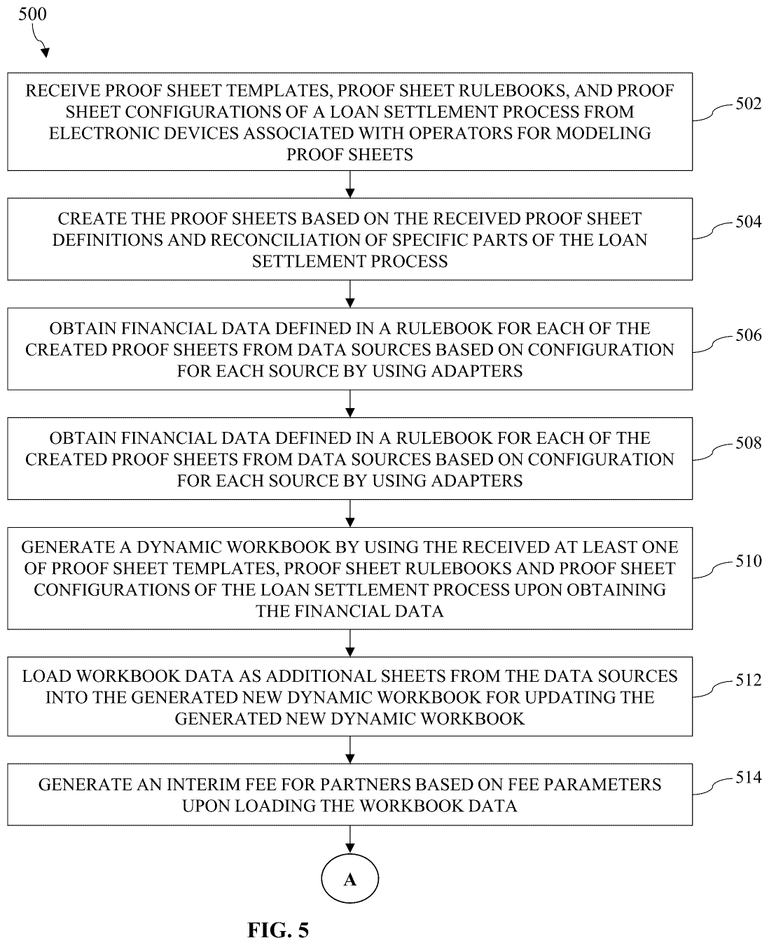

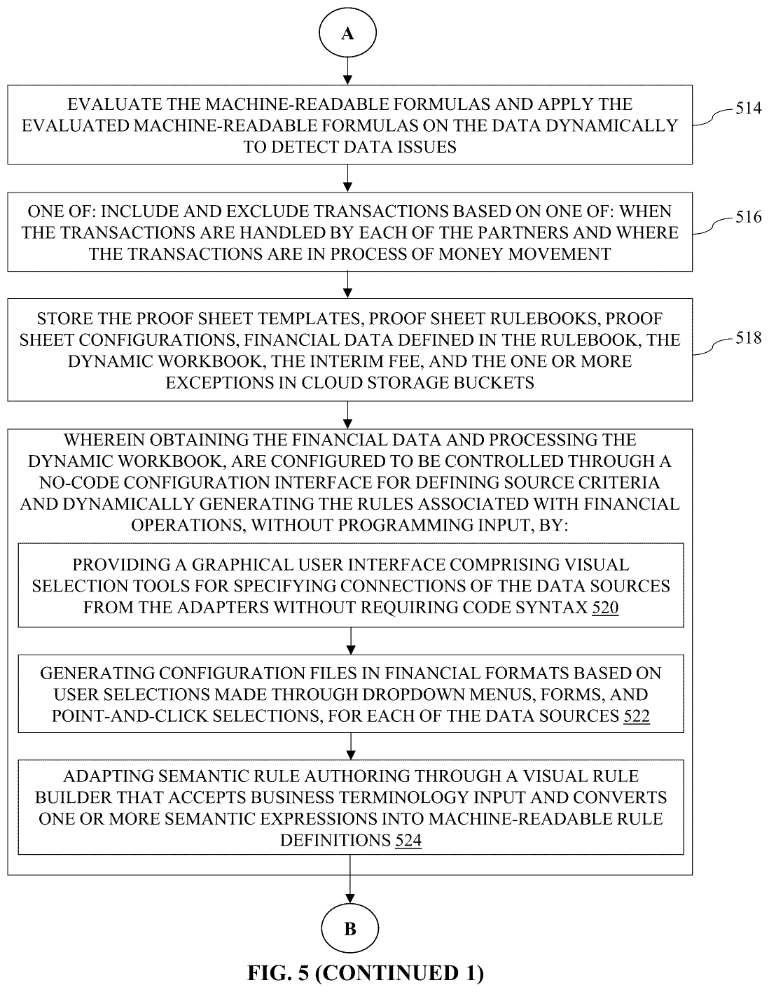

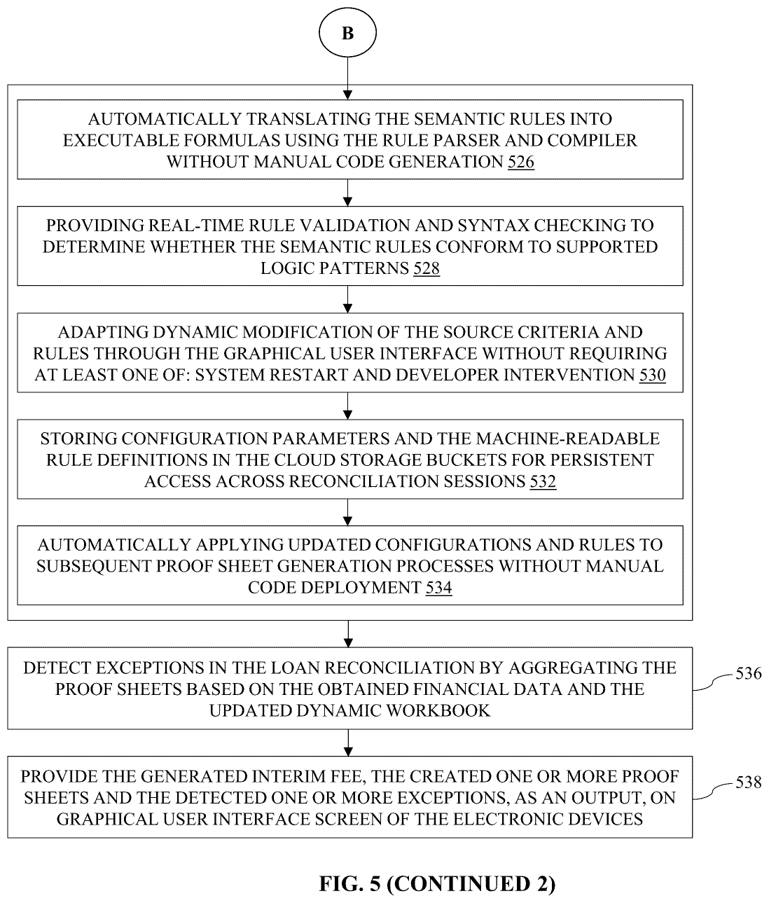

FIG. 5 is a process flow diagram illustrating an exemplary computer-implemented method for facilitating the loan reconciliation of organizations, in accordance with an embodiment of the present disclosure. At step 502, one or more proof sheet templates, one or more proof sheet rulebooks, one or more proof sheet configurations of the loan settlement process, or any combination thereof are received from one or more electronic devices 102 associated with one or more operators for modeling one or more proof sheets. In an exemplary embodiment of the present disclosure, the one or more proof sheet rulebooks include one or more rules to handle one or more products differently, breakdown of fees, final settlement amount to a bank and a provider, or any combination thereof. In an exemplary embodiment of the present disclosure, the one or more electronic devices 102 may include a laptop computer, desktop computer, tablet computer, smartphone, wearable device, a digital camera and the like.

At step 504, the one or more proof sheets are created based on the received at least one of: one or more proof sheet definitions, reconciliation of one or more specific parts of the loan settlement process, or a combination thereof. In an embodiment of the present disclosure, the one or more rules for each line item in the one or more proof sheets are authored by the one or more operators semantically or using one or more formulas. For example, the one or more proof sheets include a funding statement. In an embodiment of the present disclosure, the funding statement reconciles by: verifying every loan funded is issued by the bank, involves tracing money transfers through one or more channels; and validating loans purchased from the bank by capital partners of a firm, in compliance with one or more underwriting rules. In an exemplary embodiment of the present disclosure, the one or more channels include Automated Clearing House (ACH), Visa International Service Association (VISA), and the like. In an embodiment of the present disclosure, the computer-implemented method 500 includes defining output template of how reconciliation should look like. For example, the funding statement reconciles if every loan funded is issued by WebBank by tracing the money transfers via different channels, such as ACH, VISA, and the like and if capital partners purchased the loans from the WebBank based on the underwriting rules.

In an embodiment of the present disclosure, the computer-implemented method 500 includes defining source data and write semantic rules to process the data.

At step 506, financial data defined in the rulebook is obtained for each of the created one or more proof sheets from one or more data sources 108 based on configuration for each source using the one or more adapters. In an embodiment of the present disclosure, the one or more data sources 108 include an Application Programming Interface (API), one or more ingest outbound files, one or more inbound files, and the like. Further, the one or more data sources 108 are easily configured to simply pull all required transactions and settlement files from the one or more data sources 108 using a simple Graphical User Interface (GUI) file or a configuration file. For example, the rules for each line item in the proof sheet can be authored by the operations team semantically or using formulas. The data source required can be easily configured to simply pull all required transactions and settlement files from various sources using a simple GUI/Config file. In an embodiment of the present disclosure, rules for each cell are also stored in a rule store and converted to formulas dynamically. All the rules for a proof sheet are embedded into the templates, versioned and persisted in s3 storage for on-demand retrieval. In an embodiment of the present disclosure, the financial data includes a set of financial files of one or more financial formats. For example, the one or more financial formats include National Automated Clearing House Association (NACHA), VISA, Bank Administration Institute (BAI), JavaScript Object Notation (JSON), Comma-Separated Values (CSV), excel files, Hypertext Markup Language (HTML) tables, and the like. In an exemplary embodiment of the present disclosure, the one or more adapters include a File Transfer Protocol (FTP) adapter, a Secure File Transfer Protocol (SFTP), an API adapter, a Simple Storage Service (S3) adapter, a Relational Database Management System (RDBMS), a script adapter, or a combination thereof. For example, the configuration for each source dictates if the data needs to be pulled from an API using specific criteria, or ingest outbound files sent from our systems to servicing partners/banks and inbound files from servicing partner, banks and VISA.

At step 508, a dynamic workbook is generated using the received at least one of: the one or more proof sheet templates, the received one or more proof sheet rulebooks, and the received one or more proof sheet configurations of the loan settlement process, or any combination thereof upon obtaining the financial data.

At step 510, workbook data is loaded as additional sheets from the one or more data sources 108 into the generated new dynamic workbook for updating the generated new dynamic workbook. In an embodiment of the present disclosure, each of the one or more data sources 108 is queried and filtered as per the one or more proof sheet configurations and formatted for consistencies based on or more formats to be added as sheets to the created dynamic workbook. In an exemplary embodiment of the present disclosure, the one or more formats include datetime formats, currency formats, and the like.

At step 512, an interim fee for one or more partners is generated based on the one or more fee parameters upon loading the workbook data. In an exemplary embodiment of the present disclosure, the one or more fee parameters include federal holidays, weekends, and the like. For example, Federal holidays and weekends are handled to calculate the interim fees for the partners. In an embodiment of the present disclosure, each rule for the one or more proof sheet rulebooks are loaded, parsed and executed. Further, if the one or more rules corresponds to the semantic rules, the one or more rules are parsed and converted to Python formulas and applied to a dataset and the output is applied to a target cell. At step 514, the Python formulas are evaluated and the evaluated Python formulas are applied on the data dynamically to detect one or more data issues. In an embodiment of the present disclosure, the output workbook is stored in the s3 bucket. At step 516, the transactions are included or excluded based on when the transactions are handled by each of the one or more partners or where the transactions are in the process of money movement. In an embodiment of the present disclosure, the method 500 includes processing data, rules, operators and formulas. At step 518, the proof sheet templates, proof sheet rulebooks, proof sheet configurations, financial data defined in the rulebook, the dynamic workbook, the interim fee, and the one or more exceptions, are stored in the cloud storage buckets.

In an embodiment, the data loader subsystem 214 and the data processing subsystem 216 are configured to be controlled through a no-code configuration interface for defining source criteria and dynamically generating the one or more rules associated with financial operations, without programming input, by: (a) providing a graphical user interface comprising visual selection tools for specifying connections of the one or more data sources from the one or more adapters without requiring code syntax, as shown in 520; (b) generating one or more configuration files in one or more financial formats based on user selections made through dropdown menus, forms, and point-and-click selections, for each of the one or more data sources, as shown in 522; (c) adapting semantic rule authoring through a visual rule builder that accepts business terminology input and converts one or more semantic expressions into machine-readable rule definitions, as shown in 524; (d) automatically translating the semantic rules into executable formulas using the rule parser and compiler without manual code generation, as shown in 526; (e) providing real-time rule validation and syntax checking to determine whether the semantic rules conform to supported logic patterns, as shown in 528; (f) adapting dynamic modification of the source criteria and rules through the graphical user interface without requiring at least one of: system restart and developer intervention, as shown in 530; (g) storing one or more configuration parameters and the machine-readable rule definitions in the cloud storage buckets for persistent access across reconciliation sessions, as shown in 532; and (h) automatically applying updated configurations and rules to subsequent proof sheet generation processes without manual code deployment, as shown in 534.

At step 536, one or more exceptions in the loan reconciliation are detected by aggregating the one or more proof sheets based on the obtained financial data and the updated dynamic workbook. In an exemplary embodiment of the present disclosure, the one or more exceptions include duplicate transactions, missing transactions, transactions posted to a wrong account, accounting errors, timing differences, lender errors, and the like. In an embodiment of the present disclosure, the computer-implemented method 500 includes running the one or more proof sheet configurations based on one or more configuration parameters. For example, the one or more configuration parameters include time, holiday rules, weekend rules, transaction timing of the one or more partners, and the like. In an embodiment of the present disclosure, the computer-implemented method 500 includes extracting values from the one or more proof sheets and integrate output values to final accounting statements and portfolio activity. Furthermore, the computer-implemented method 500 includes monitoring transactions, files from the one or more partners and banks to orchestrate the timing of creating the one or more proof sheets. In an embodiment of the present disclosure, the computer-implemented method 500 includes allowing configuration driven output and scheduling. For example, the computer-implemented method 500 includes combining multiple proof sheets to pull all the exceptions and persist it separately.

At step 516, the generated interim fee, the created one or more proof sheets and the detected one or more exceptions are provided as the output on the graphical user interface screen of the one or more electronic devices 102. In an embodiment of the present disclosure, the detected one or more exceptions are outputted in one or more output formats for allowing the one or more operators to handle exceptions and one or more aged reconciliation issues. For example, the one or more output formats include native excel sheets with transaction data, accounting statements, web views, Portable Document Formats (PDFs), dashboards, reports, and the like.

In an embodiment of the present disclosure, the computer-implemented method 500 includes determining successful completion of the loan reconciliation process using the created one or more proof sheets, the obtained financial data and the updated dynamic workbook. Further, the computer-implemented method 500 includes outputting a notification corresponding to the successful completion of the loan reconciliation process on graphical user interface screen of the one or more electronic devices 102.

The computer-implemented method 500 may be implemented in any suitable hardware, software, firmware, or combination thereof.

Thus, various embodiments of the present system provide a solution to facilitate loan reconciliation of organizations. The computer-implemented system 104 provides a set of adapters 312 for all possible integrations including HTTP, FTP, STFP, s3, DB and even dynamic scripts. In an embodiment of the present disclosure, adding source is only a configuration and no code is required. Further, all SQL and mathematical operations can be configured with no code. In an embodiment of the present disclosure, all industry standard financial files can be processed dynamically. The computer-implemented system 104 converts financial taxonomy into semantic rules for end user authoring and auto-generate code using rules. For example, funding, purchases, transactions, payments, cancels, and other terms are interpreted dynamically. In an embodiment of the present disclosure, the computer-implemented system 104 has the ability to convert semantic rules to excel formulas. Further, transactions are traced dynamically over time. The computer-implemented system 104 allows configurable output file formats and auto-generation of accounting statements. In an embodiment of the present disclosure, the computer-implemented system 104 has the ability to convert this engine as a service and handle financial reconciliation for any firm. The computer-implemented system 104 provides full services loan application and administration capabilities in the mobile devices natively. In an embodiment of the present disclosure, the computer-implemented system 104 corresponds to Platform as a Service (PaaS). Furthermore, the computer-implemented system 104 includes several autonomous modules, such as pre-approval, auto-pay setup, reconciliation, identity validations, and the like that can be offered as individual services in the platform. The computer-implemented system 104 improves and transforms credit lending and make it easier for the one or more partners to integrate. Furthermore, the computer-implemented system 104 makes end borrowers' life easier to get point of sale financing or point of care financing with decision and full application process in minutes.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the computer-implemented system 104 either directly or through intervening I/O. Network adapters may also be coupled to the computer-implemented system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer-implemented system 104 in accordance with the embodiments herein. The computer-implemented system 104 herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The computer-implemented system 104 can read the inventive instructions on the program storage devices and follow these instructions to execute the methodology of the embodiments herein.

The computer-implemented system 104 further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A computer-implemented system for facilitating loan reconciliation of organizations, the computer-implemented system comprising:
one or more hardware processors; and
a memory coupled to the one or more hardware processors, wherein the memory comprises a plurality of subsystems in the form of programmable instructions executable by the one or more hardware processors, and wherein the plurality of subsystems comprises:
an input receiver subsystem configured to receive at least one of: one or more proof sheet templates, one or more proof sheet rulebooks, and one or more proof sheet configurations of a loan settlement process from one or more electronic devices associated with one or more operators for modeling one or more proof sheets, wherein the one or more proof sheet rulebooks comprise one or more rules to handle at least one of: one or more products differently, breakdown of fees, and final settlement amount to a bank and a provider;
a proof sheet modeling subsystem configured to create the one or more proof sheets based on the received at least one of: one or more proof sheet definitions and reconciliation of one or more specific parts of the loan settlement process, wherein the one or more rules for each line item in the one or more proof sheets are authored by the one or more operators one of: semantically and using one or more formulas;
a data loader subsystem configured to obtain financial data defined in a rulebook for each of the created one or more proof sheets from one or more data sources based on configuration for each source using one or more adapters, wherein the one or more adapters comprise: a File Transfer Protocol (FTP) adapter, a Secure File Transfer Protocol (SFTP), an Application Program Interface (API) adapter, a Simple Storage Service (S3) adapter, a Relational Database Management System (RDBMS), and a script adapter,
wherein the one or more data sources comprise an Application Programming Interface (API), one or more ingest outbound files, and one or more inbound files, and wherein the one or more data sources are easily configured to obtain transactions and settlement files from the one or more data sources using one of a Graphical User Interface (GUI) file and a configuration file;
a data processing subsystem comprises a reconciliation engine running on a container orchestration cluster, configured to:
generate a dynamic workbook using the received at least one of: the one or more proof sheet templates, the one or more proof sheet rulebooks and the one or more proof sheet configurations of the loan settlement process upon obtaining the financial data, wherein to generate the dynamic workbook, the data processing subsystem is configured to:
load a copy of a template into the reconciliation engine;
generate a new dynamic workbook using a compiler and a parser;
parse each cell in the template to copy customized formats and formulas into the new dynamic workbook using the parser;
load data as reference sheets based on the one or more proof sheet configurations using the parser;
compile default formulas and convert each of the one or more rules to formulas using the compiler;
apply the one or more rules and the formulas to the reference data;
execute the formulas and copy the resulting data into the new dynamic workbook in the memory; and
generate the data for the new dynamic workbook in the memory;
load workbook data as additional sheets from the one or more data sources into the generated new dynamic workbook for updating the generated new dynamic workbook, wherein each of the one or more data sources is queried and filtered as per the one or more proof sheet configurations and formatted for consistencies based on one or more formats to be added as sheets to the generated new dynamic workbook, and wherein the one or more formats comprise: datetime formats, and currency formats;
generate an interim fee for one or more partners based on one or more fee parameters upon loading the workbook data, wherein the one or more fee parameters comprise federal holidays and weekends,
wherein each rule for the one or more proof sheet rulebooks are loaded, parsed, and executed, wherein the one or more rules correspond to semantic rules, the one or more rules are parsed and converted to machine-readable formulas and applied to a dataset and the output is applied to a target cell;
evaluate the machine-readable formulas, wherein the machine-readable formulas are interpreted in a machine-readable language and apply the evaluated machine-readable formulas on the data dynamically to detect one or more data issues;
one of: include and exclude transactions based on one of: when the transactions are handled by each of the one or more partners and where the transactions are in process of money movement; and
store the proof sheet templates, proof sheet rulebooks, proof sheet configurations, financial data defined in the rulebook, the dynamic workbook, the interim fee, and the one or more exceptions in cloud storage buckets,
wherein the data loader subsystem and the data processing subsystem are configured to be controlled through a no-code configuration interface for defining source criteria and dynamically generating the one or more rules associated with financial operations, without programming input, by:
providing a graphical user interface comprising visual selection tools for specifying connections of the one or more data sources from the one or more adapters without requiring code syntax;
generating one or more configuration files in one or more financial formats based on user selections made through dropdown menus, forms, and point-and-click selections, for each of the one or more data sources;
adapting semantic rule authoring through a visual rule builder that accepts business terminology input and converts one or more semantic expressions into machine-readable rule definitions;
automatically translating the semantic rules into executable formulas using the rule parser and compiler without manual code generation;
providing real-time rule validation and syntax checking to determine whether the semantic rules conform to supported logic patterns;
adapting dynamic modification of the source criteria and rules through the graphical user interface without requiring at least one of: system restart and developer intervention;
storing one or more configuration parameters and the machine-readable rule definitions in the cloud storage buckets for persistent access across reconciliation sessions; and
automatically applying updated configurations and rules to subsequent proof sheet generation processes without manual code deployment;
a data aggregator subsystem configured to detect one or more exceptions in the loan reconciliation by aggregating the one or more proof sheets based on the obtained financial data and the updated dynamic workbook, wherein the data aggregator subsystem is further configured to:
extract output values from the one or more proof sheets and integrate the extracted output values into final accounting statements and portfolio activity;
monitor transactions and files received from the one or more partners and the bank to orchestrate timing of creation of the one or more proof sheets;
identify the one or more exceptions based on the extracted output values, and the monitored transactions and files, by combining the one or more proof sheets; and
persist the identified one or more exceptions separately based on configuration-driven output and scheduling, by combining the one or more proof sheets;
wherein the reconciliation engine further comprises a dynamic script executor configured to inject runtime code for handling the one or more exceptions and computing one or more complex formulas associated with the one or more exceptions; and
a data output subsystem configured to provide the generated interim fee, the created one or more proof sheets and the detected one or more exceptions, as an output, on graphical user interface screen of the one or more electronic devices, wherein the detected one or more exceptions are outputted in one or more output formats for allowing the one or more operators to handle exceptions and one or more aged reconciliation issues.

2. The computer-implemented system of claim 1, wherein the one or more proof sheets comprise a funding statement, and wherein the funding statement is configured to reconcile by:
verifying every loan funded is issued by the bank, involves tracing money transfers through one or more channels; and
validating loans purchased from the bank by capital partners of a firm, in compliance with one or more underwriting rules.

3. The computer-implemented system of claim 1, wherein in creating the one or more proof sheets, the proof sheet modeling subsystem is configured to:
receive the one or more proof sheet definitions from the input receiver subsystem, wherein the one or more proof sheet definitions indicate structural templates and formatting requirements for loan settlement reconciliation documents;
identify the one or more specific parts of the loan settlement process requiring the reconciliation, wherein the one or more specific parts comprise at least one of: loan funding flows, partner fee distributions, settlement amount computations, and transaction timing validations;
generate one or more proof sheet structures, by mapping each identified specific part of the loan settlement process to corresponding line items within the proof sheet framework, establishing data field relationships between one or more line items and the one or more available data sources, and generating computation hierarchies for interdependent line item computations;
adapt dual-mode rule authoring for each line item by providing a semantic authoring interface wherein the one or more operators define one or more logics using natural language expressions and financial terminology without programming syntax, and providing a formula-based authoring interface wherein the one or more operators create mathematical expressions and computational formulas using spreadsheet-like syntax;
process the semantically authored rules by parsing one or more semantic expressions to extract one or more logic components, converting the one or more logic components into machine-readable rule definitions indicating semantic rule syntax, and validating the semantic rule syntax against supported logic patterns;
process formula-based authored rules by validating mathematical formula syntax for computational accuracy, verifying one or more data field references within formulas correspond to the one or more available data sources, and checking formula dependencies to prevent circular computation references;
integrate the semantically authored rules and the formula-based authored rules, into the one or more proof sheet structures by associating each authored rule with its corresponding line item within the one or more proof sheets, establishing execution order for interdependent rule computations, and configuring one or more rule parameters based on the one or more specific parts of the loan settlement process being reconciled;
create the one or more proof sheets by applying the semantically authored rules and the formula-based authored rules, to populate the one or more line items with computed values, formatting line item presentations according to proof sheet definition requirements, and generating proof sheet metadata including creation timestamp, operator identification, and rule version information; and
validate the generated one or more proof sheets by verifying the one or more line items comprising at least one of: appropriate computed values and data references, confirming the one or more proof sheet structures match the received proof sheet definitions, and determining whether the generated one or more proof sheets accurately represent the reconciliation of the identified one or more specific parts of the loan settlement process.

4. The computer-implemented system of claim 1, wherein in loading the workbook data as the additional sheets into the generated new dynamic workbook for updating the generated new dynamic workbook, the data processing subsystem is further configured to:
identify the one or more data sources specified in the one or more proof sheet configurations for workbook data integration;
establish the one or more connections to each of the one or more data sources using the corresponding one or more adapters;
query each of the one or more data sources by applying one or more query parameters specified in the one or more proof sheet configurations to retrieve relevant financial data, executing data extraction operations based on the one or more proof sheet configurations for each source, and retrieving raw workbook data from each connected data source;
filter the retrieved workbook data by applying filtering criteria defined in the one or more proof sheet configurations to exclude irrelevant data records, selecting one or more data records that match the reconciliation requirements for the dynamic workbook, and removing duplicate and invalid data entries based on predefined data quality rules;
format the filtered workbook data for consistency by standardizing datetime formats across the one or more data sources to determine uniform temporal representation, normalizing currency formats to maintain consistent monetary value presentation, and applying additional formatting rules specified in the one or more formats to determine data compatibility;
generate the additional sheets within the generated new dynamic workbook by generating separate worksheet tabs for each data source to maintain data source traceability, structuring each additional sheet with appropriate column headers and data organization, and preserving data source metadata within each additional sheet for audit purposes;
populate the additional sheets by loading the formatted workbook data into the corresponding additional sheets within the generated new dynamic workbook, maintaining data integrity during the loading process to prevent data corruption, and establishing data relationships between the additional sheets and existing workbook content;
update the generated new dynamic workbook by integrating the additional sheets comprising the workbook data with existing dynamic workbook structure, refreshing formula computations that depend on newly loaded workbook data, and updating cross-sheet references to incorporate data from the additional sheets; and
validate the updated dynamic workbook by verifying successful integration of the additional sheets from the one or more data sources, confirming data consistency and format compliance across the additional sheets within the updated dynamic workbook, and determining whether the updated dynamic workbook maintains structural integrity for subsequent reconciliation processing.

5. The computer-implemented system of claim 1, wherein in generating the interim fee for the one or more partners based on the one or more fee parameters, the data processing subsystem is configured to:
identify the one or more partners who are active and eligible for interim fee computations from the loaded workbook data, based on partner-specific fee agreements;
extract transaction data associated with each of the one or more partners from the dynamic workbook, wherein the transaction data comprises at least one of: loan amounts, processing dates, and settlement timing information;
determine applicable fee computation periods by analyzing transaction processing dates against a federal holiday calendar to identify one or more transactions processed on the federal holidays, identifying the one or more transactions processed on the weekends by comparing the transaction processing dates against one or more weekend date patterns, and categorizing the one or more transactions into business day transactions, weekend transactions, and federal holiday transactions;
apply partner-specific fee rate structures based on the categorized one or more transactions, wherein the business day transactions are assessed standard fee rates, the weekend transactions are assessed premium fee rates higher than the assessed standard fee rates, the federal holiday transactions are assessed holiday premium rates;
determine the interim fee for each partner by multiplying one or more transaction amounts by applicable fee rates for each transaction category, aggregating fee amounts across the categorized one or more transaction for each partner, and applying at least one of: partner-specific fee caps, minimums, and adjustment factors, to determine the interim fee for each partner;
validate the determined interim fee against one or more predefined rules and one or more partner agreement parameters to determine fee accuracy;
generate one or more interim fee records comprising partner identification, fee amount, calculation basis, and applicable time period; and
store the generated interim fee records in the cloud storage buckets for subsequent reconciliation and partner settlement processes.

6. The computer-implemented system of claim 1, wherein the financial data comprises a set of financial files of the one or more financial formats.

7. The computer-implemented system of claim 1, wherein the one or more exceptions comprise duplicate transactions, missing transactions, transactions posted to a wrong account, accounting errors, timing differences, and lender errors.

8. The computer-implemented system of claim 1, wherein the data aggregator subsystem is configured to run the one or more proof sheet configurations based on one or more configuration parameters, and wherein the one or more configuration parameters comprise time, holiday rules, weekend rules and transaction timing of the one or more partners.

9. The computer-implemented system of claim 1, further comprising a loan reconciliation management subsystem configured to:
determine successful completion of the loan reconciliation process using the created one or more proof sheets, the obtained financial data and the updated dynamic workbook; and
output a notification corresponding to the successful completion of the loan reconciliation process on graphical user interface screen of the one or more electronic devices.

10. A computer-implemented method for facilitating loan reconciliation of organizations, the computer-implemented method comprising:
receiving, by one or more hardware processors, at least one of: one or more proof sheet templates, one or more proof sheet rulebooks, and one or more proof sheet configurations of a loan settlement process from one or more electronic devices associated with one or more operators for modeling one or more proof sheets, wherein the one or more proof sheet rulebooks comprise one or more rules to handle at least one of: one or more products differently, breakdown of fees, and final settlement amount to a bank and a provider;
creating, by the one or more hardware processors, the one or more proof sheets based on the received at least one of one or more proof sheet definitions and reconciliation of one or more specific parts of the loan settlement process, wherein the one or more rules for each line item in the one or more proof sheets are authored by the one or more operators one of: semantically and using one or more formulas;
obtaining, by the one or more hardware processors, financial data defined in a rulebook for each of the created one or more proof sheets from one or more data sources based on configuration for each source using one or more adapters, wherein the one or more adapters comprise: a File Transfer Protocol (FTP) adapter, a Secure File Transfer Protocol (SFTP), an Application Program Interface (API) adapter, a Simple Storage Service (S3) adapter, a Relational Database Management System (RDBMS), and a script adapter,
wherein the one or more data sources comprise an Application Programming Interface (API), one or more ingest outbound files, and one or more inbound files, and wherein the one or more data sources are easily configured to obtain transactions and settlement files from the one or more data sources using one of a Graphical User Interface (GUI) file and a configuration file;
generating, by the one or more hardware processors, a dynamic workbook using the received at least one of: the one or more proof sheet templates, the one or more proof sheet rulebooks, and the one or more proof sheet configurations of the loan settlement process upon obtaining the financial data, wherein to generate the dynamic workbook, a data processing subsystem, comprises a reconciliation engine running on a container orchestration cluster, configured to execute steps comprising:
loading a copy of a template into the reconciliation engine;
generating a new dynamic workbook using a compiler and a parser;
parsing each cell in the template to copy customized formats and formulas into the new dynamic workbook using the parser;
loading data as reference sheets based on the one or more proof sheet configurations using the parser;
compiling default formulas and convert each of the one or more rules to formulas using the compiler;
applying the one or more rules and the formulas to the reference data;
executing the formulas and copy the resulting data into the new dynamic workbook in the memory; and
generating the data for the new dynamic workbook in the memory;
loading, by the one or more hardware processors, workbook data as additional sheets from the one or more data sources into the generated new dynamic workbook for updating the generated new dynamic workbook, wherein each of the one or more data sources is queried and filtered as per the one or more proof sheet configurations and formatted for consistencies based on or more formats to be added as sheets to the generated dynamic workbook, and wherein the one or more formats comprise: datetime formats, and currency formats;
generating, by the one or more hardware processors, an interim fee for one or more partners based on one or more fee parameters upon loading the workbook data, wherein the one or more fee parameters comprise: federal holidays and weekends;
wherein each rule for the one or more proof sheet rulebooks are loaded, parsed, and executed, wherein the one or more rules correspond to semantic rules, the one or more rules are parsed and converted to machine-readable formulas and applied to a dataset and the output is applied to a target cell;
evaluating, by the one or more hardware processors, the machine-readable formulas, wherein the machine-readable formulas are interpreted in a machine-readable language, and applying, by the one or more hardware processors, the evaluated machine-readable formulas on the data dynamically to detect one or more data issues;
one of: including and excluding, by the one or more hardware processors, transactions based on one of: when the transactions are handled by each of the one or more partners and where the transactions are in process of money movement; and
storing, by the one or more hardware processors, the proof sheet templates, proof sheet rulebooks, proof sheet configurations, financial data defined in the rulebook, the dynamic workbook, the interim fee, and the one or more exceptions in cloud storage buckets,
wherein obtaining the financial data and processing the dynamic workbook, are configured to be controlled through a no-code configuration interface for defining source criteria and dynamically generating the one or more rules associated with financial operations, without programming input, by:
providing, by the one or more hardware processors, a graphical user interface comprising visual selection tools for specifying connections of the one or more data sources from the one or more adapters without requiring code syntax;
generating, by the one or more hardware processors, one or more configuration files in one or more financial formats based on user selections made through dropdown menus, forms, and point-and-click selections, for each of the one or more data sources;
adapting, by the one or more hardware processors, semantic rule authoring through a visual rule builder that accepts business terminology input and converts one or more semantic expressions into machine-readable rule definitions;
automatically translating, by the one or more hardware processors, the semantic rules into executable formulas using the rule parser and compiler without manual code generation;
providing, by the one or more hardware processors, real-time rule validation and syntax checking to determine whether the semantic rules conform to supported logic patterns;
adapting, by the one or more hardware processors, dynamic modification of the source criteria and rules through the graphical user interface without requiring at least one of: system restart and developer intervention;
storing, by the one or more hardware processors, one or more configuration parameters and the machine-readable rule definitions in the cloud storage buckets for persistent access across reconciliation sessions; and
automatically applying, by the one or more hardware processors, updated configurations and rules to subsequent proof sheet generation processes without manual code deployment;
detecting, by the one or more hardware processors, one or more exceptions in the loan reconciliation by aggregating the one or more proof sheets based on the obtained financial data and the updated dynamic workbook, wherein detecting the one or more exceptions comprises:
extracting, by the one or more hardware processors, output values from the one or more proof sheets and integrating the extracted output values into final accounting statements and portfolio activity;
monitoring, by the one or more hardware processors, transactions and files received from the one or more partners and the bank to orchestrate timing of creation of the one or more proof sheets;
identifying, by the one or more hardware processors, the one or more exceptions based on the extracted output values, and the monitored transactions and files, by combining the one or more proof sheets; and
persisting, by the one or more hardware processors, the identified one or more exceptions separately based on configuration-driven output and scheduling, by combining the one or more proof sheets,
wherein the reconciliation engine further comprises a dynamic script executor configured to inject runtime code for handling the one or more exceptions and computing one or more complex formulas associated with the one or more exceptions; and
providing, by the one or more hardware processors, the generated interim fee, the created one or more proof sheets and the detected one or more exceptions, as an output, on graphical user interface screen of the one or more electronic devices, wherein the detected one or more exceptions are outputted in one or more output formats for allowing the one or more operators to handle the one or more exceptions and one or more aged reconciliation issues.

11. The computer-implemented method of claim 10, wherein the one or more proof sheets comprise a funding statement, wherein the funding statement is configured to reconcile by:
verifying, by the one or more hardware processors, every loan funded is issued by the bank, involves tracing money transfers through one or more channels; and
ensuring, by the one or more hardware processors, loans purchased from the bank by capital partners of a firm, in compliance with one or more underwriting rules.

12. The computer-implemented method of claim 10, wherein creating the one or more proof sheets, comprises:
receiving, by the one or more hardware processors, the one or more proof sheet definitions from the input receiver subsystem, wherein the one or more proof sheet definitions indicate structural templates and formatting requirements for loan settlement reconciliation documents;
identifying, by the one or more hardware processors, the one or more specific parts of the loan settlement process requiring the reconciliation, wherein the one or more specific parts comprise at least one of: loan funding flows, partner fee distributions, settlement amount computations, and transaction timing validations;
generating, by the one or more hardware processors, one or more proof sheet structures, by mapping each identified specific part of the loan settlement process to corresponding line items within the proof sheet framework, establishing data field relationships between one or more line items and the one or more available data sources, and generating computation hierarchies for interdependent line item computations;
adapting, by the one or more hardware processors, dual-mode rule authoring for each line item by providing a semantic authoring interface wherein the one or more operators define one or more logics using natural language expressions and financial terminology without programming syntax, and providing a formula-based authoring interface wherein the one or more operators create mathematical expressions and computational formulas using spreadsheet-like syntax;
processing, by the one or more hardware processors, the semantically authored rules by parsing one or more semantic expressions to extract one or more logic components, converting the one or more logic components into machine-readable rule definitions indicating semantic rule syntax, and validating the semantic rule syntax against supported logic patterns;
processing, by the one or more hardware processors, formula-based authored rules by validating mathematical formula syntax for computational accuracy, verifying one or more data field references within formulas correspond to the one or more available data sources, and checking formula dependencies to prevent circular computation references;
integrating, by the one or more hardware processors, the semantically authored rules and the formula-based authored rules, into the one or more proof sheet structures by associating each authored rule with its corresponding line item within the one or more proof sheets, establishing execution order for interdependent rule computations, and configuring one or more rule parameters based on the one or more specific parts of the loan settlement process being reconciled;
creating, by the one or more hardware processors, the one or more proof sheets by applying the semantically authored rules and the formula-based authored rules, to populate the one or more line items with computed values, formatting line item presentations according to proof sheet definition requirements, and generating proof sheet metadata including creation timestamp, operator identification, and rule version information; and
validating, by the one or more hardware processors, the generated one or more proof sheets by verifying the one or more line items comprising at least one of: appropriate computed values and data references, confirming the one or more proof sheet structures match the received proof sheet definitions, and determining whether the generated one or more proof sheets accurately represent the reconciliation of the identified one or more specific parts of the loan settlement process.

13. The computer-implemented method of claim 10, wherein loading the workbook data as the additional sheets into the generated new dynamic workbook for updating the generated new dynamic workbook, comprises:
identifying, by the one or more hardware processors, the one or more data sources specified in the one or more proof sheet configurations for workbook data integration;
establishing, by the one or more hardware processors, the one or more connections to each of the one or more data sources using the corresponding one or more adapters;
querying, by the one or more hardware processors, each of the one or more data sources by applying one or more query parameters specified in the one or more proof sheet configurations to retrieve relevant financial data, executing data extraction operations based on the one or more proof sheet configurations for each source, and retrieving raw workbook data from each connected data source;
filtering, by the one or more hardware processors, the retrieved workbook data by applying filtering criteria defined in the one or more proof sheet configurations to exclude irrelevant data records, selecting one or more data records that match the reconciliation requirements for the dynamic workbook, and removing duplicate and invalid data entries based on predefined data quality rules;
formatting, by the one or more hardware processors, the filtered workbook data for consistency by standardizing datetime formats across the one or more data sources to determine uniform temporal representation, normalizing currency formats to maintain consistent monetary value presentation, and applying additional formatting rules specified in the one or more formats to determine data compatibility;
generating, by the one or more hardware processors, the additional sheets within the generated new dynamic workbook by generating separate worksheet tabs for each data source to maintain data source traceability, structuring each additional sheet with appropriate column headers and data organization, and preserving data source metadata within each additional sheet for audit purposes;
populating, by the one or more hardware processors, the additional sheets by loading the formatted workbook data into the corresponding additional sheets within the generated new dynamic workbook, maintaining data integrity during the loading process to prevent data corruption, and establishing data relationships between the additional sheets and existing workbook content;
updating, by the one or more hardware processors, the generated new dynamic workbook by integrating the additional sheets comprising the workbook data with existing dynamic workbook structure, refreshing formula computations that depend on newly loaded workbook data, and updating cross-sheet references to incorporate data from the additional sheets; and
validating, by the one or more hardware processors, the updated dynamic workbook by verifying successful integration of the additional sheets from the one or more data sources, confirming data consistency and format compliance across the additional sheets within the updated dynamic workbook, and determining whether the updated dynamic workbook maintains structural integrity for subsequent reconciliation processing.

14. The computer-implemented method of claim 10, wherein generating the interim fee for the one or more partners based on the one or more fee parameters, comprises:
identifying, by the one or more hardware processors, the one or more partners who are active and eligible for interim fee computations from the loaded workbook data, based on partner-specific fee agreements;
extracting, by the one or more hardware processors, transaction data associated with each of the one or more partners from the dynamic workbook, wherein the transaction data comprises at least one of: loan amounts, processing dates, and settlement timing information;
determining, by the one or more hardware processors, applicable fee computation periods by analyzing transaction processing dates against a federal holiday calendar to identify one or more transactions processed on the federal holidays, identifying the one or more transactions processed on the weekends by comparing the transaction processing dates against one or more weekend date patterns, and categorizing the one or more transactions into business day transactions, weekend transactions, and federal holiday transactions;
applying, by the one or more hardware processors, partner-specific fee rate structures based on the categorized one or more transactions, wherein the business day transactions are assessed standard fee rates, the weekend transactions are assessed premium fee rates higher than the assessed standard fee rates, the federal holiday transactions are assessed holiday premium rates;
determining, by the one or more hardware processors, the interim fee for each partner by multiplying one or more transaction amounts by applicable fee rates for each transaction category, aggregating fee amounts across the categorized one or more transaction for each partner, and applying at least one of: partner-specific fee caps, minimums, and adjustment factors, to determine the interim fee for each partner;
validating, by the one or more hardware processors, the determined interim fee against one or more predefined rules and one or more partner agreement parameters to determine fee accuracy;
generating, by the one or more hardware processors, one or more interim fee records comprising partner identification, fee amount, calculation basis, and applicable time period; and
storing, by the one or more hardware processors, the generated interim fee records in the cloud storage buckets for subsequent reconciliation and partner settlement processes.

15. The computer-implemented method of claim 10, wherein the financial data comprises a set of financial files of one or more financial formats.

16. The computer-implemented method of claim 10, wherein the one or more exceptions comprise duplicate transactions, missing transactions, transactions posted to a wrong account, accounting errors, timing differences, and lender errors.

17. The computer-implemented method of claim 10, further comprising running, by the one or more hardware processors, the one or more proof sheet configurations based on one or more configuration parameters, and wherein the one or more configuration parameters comprise time, holiday rules, weekend rules and transaction timing of the one or more partners.

18. The computer-implemented method of claim 10, further comprising:
determining, by the one or more hardware processors, successful completion of the loan reconciliation process using the created one or more proof sheets, the obtained financial data, and the updated dynamic workbook; and
outputting, by the one or more hardware processors, a notification corresponding to the successful completion of the loan reconciliation process on graphical user interface screen of the one or more electronic devices.

19. The non-transitory computer-readable storage medium having instructions stored therein that when executed by one or more hardware processors, cause the one or more hardware processors to execute operations of:
receiving at least one of: one or more proof sheet templates, one or more proof sheet rulebooks, and one or more proof sheet configurations of a loan settlement process from one or more electronic devices associated with one or more operators for modeling one or more proof sheets, wherein the one or more proof sheet rulebooks comprise one or more rules to handle at least one of: one or more products differently, breakdown of fees, and final settlement amount to a bank and a provider;
creating the one or more proof sheets based on the received at least one of one or more proof sheet definitions and reconciliation of one or more specific parts of the loan settlement process, wherein the one or more rules for each line item in the one or more proof sheets are authored by the one or more operators one of: semantically and using one or more formulas;
obtaining financial data defined in a rulebook for each of the created one or more proof sheets from one or more data sources based on configuration for each source using one or more adapters, wherein the one or more adapters comprise: a File Transfer Protocol (FTP) adapter, a Secure File Transfer Protocol (SFTP), an Application Program Interface (API) adapter, a Simple Storage Service (S3) adapter, a Relational Database Management System (RDBMS), and a script adapter,
wherein the one or more data sources comprise an Application Programming Interface (API), one or more ingest outbound files, and one or more inbound files, and wherein the one or more data sources are easily configured to obtain transactions and settlement files from the one or more data sources using one of a Graphical User Interface (GUI) file and a configuration file;
generating a dynamic workbook using the received at least one of: the one or more proof sheet templates, the one or more proof sheet rulebooks, and the one or more proof sheet configurations of the loan settlement process upon obtaining the financial data, wherein to generate the dynamic workbook, a data processing subsystem, comprises a reconciliation engine running on a container orchestration cluster, configured to execute steps comprising:
loading a copy of a template into the reconciliation engine;
generating a new dynamic workbook using a compiler and a parser;
parsing each cell in the template to copy customized formats and formulas into the new dynamic workbook using the parser;
loading data as reference sheets based on the one or more proof sheet configurations using the parser;
compiling default formulas and convert each of the one or more rules to formulas using the compiler;
applying the one or more rules and the formulas to the reference data;
executing the formulas and copy the resulting data into the new dynamic workbook in the memory; and
generating the data for the new dynamic workbook in the memory;
loading workbook data as additional sheets from the one or more data sources into the generated new dynamic workbook for updating the generated new dynamic workbook, wherein each of the one or more data sources is queried and filtered as per the one or more proof sheet configurations and formatted for consistencies based on or more formats to be added as sheets to the generated dynamic workbook, and wherein the one or more formats comprise: datetime formats, and currency formats;
generating an interim fee for one or more partners based on one or more fee parameters upon loading the workbook data, wherein the one or more fee parameters comprise: federal holidays and weekends;
wherein each rule for the one or more proof sheet rulebooks are loaded, parsed, and executed, wherein the one or more rules correspond to semantic rules, the one or more rules are parsed and converted to machine-readable formulas and applied to a dataset and the output is applied to a target cell;
evaluating the machine-readable formulas, wherein the machine-readable formulas are interpreted in a machine-readable language and apply the evaluated machine-readable formulas on the data dynamically to detect one or more data issues;
one of: including and excluding transactions based on one of: when the transactions are handled by each of the one or more partners and where the transactions are in process of money movement; and
storing the proof sheet templates, proof sheet rulebooks, proof sheet configurations, financial data defined in the rulebook, the dynamic workbook, the interim fee, and the one or more exceptions in cloud storage buckets,
wherein obtaining the financial data and processing the dynamic workbook, are configured to be controlled through a no-code configuration interface for defining source criteria and dynamically generating the one or more rules associated with financial operations, without programming input, by:
providing a graphical user interface comprising visual selection tools for specifying connections of the one or more data sources from the one or more adapters without requiring code syntax;
generating one or more configuration files in one or more financial formats based on user selections made through dropdown menus, forms, and point-and-click selections, for each of the one or more data sources;
adapting semantic rule authoring through a visual rule builder that accepts business terminology input and converts one or more semantic expressions into machine-readable rule definitions;
automatically translating the semantic rules into executable formulas using the rule parser and compiler without manual code generation;
providing real-time rule validation and syntax checking to determine whether the semantic rules conform to supported logic patterns;
adapting dynamic modification of the source criteria and rules through the graphical user interface without requiring at least one of: system restart and developer intervention;
storing one or more configuration parameters and the machine-readable rule definitions in the cloud storage buckets for persistent access across reconciliation sessions; and
automatically applying updated configurations and rules to subsequent proof sheet generation processes without manual code deployment;
detecting one or more exceptions in the loan reconciliation by aggregating the one or more proof sheets based on the obtained financial data and the updated dynamic workbook, wherein detecting the one or more exceptions comprises:
extracting output values from the one or more proof sheets and integrating the extracted output values into final accounting statements and portfolio activity;
monitoring transactions and files received from the one or more partners and the bank to orchestrate timing of creation of the one or more proof sheets;
identifying the one or more exceptions based on the extracted output values, and the monitored transactions and files, by combining the one or more proof sheets; and
persisting the identified one or more exceptions separately based on configuration-driven output and scheduling, by combining the one or more proof sheets,
wherein the reconciliation engine further comprises a dynamic script executor configured to inject runtime code for handling the one or more exceptions and computing one or more complex formulas associated with the one or more exceptions; and
providing the generated interim fee, the created one or more proof sheets and the detected one or more exceptions, as an output, on graphical user interface screen of the one or more electronic devices, wherein the detected one or more exceptions are outputted in one or more output formats for allowing the one or more operators to handle the one or more exceptions and one or more aged reconciliation issues.

20. The non-transitory computer-readable storage medium of claim 19, wherein generating the interim fee for the one or more partners based on the one or more fee parameters, comprises:
identifying the one or more partners who are active and eligible for interim fee computations from the loaded workbook data, based on partner-specific fee agreements;
extracting transaction data associated with each of the one or more partners from the dynamic workbook, wherein the transaction data comprises at least one of: loan amounts, processing dates, and settlement timing information;
determining applicable fee computation periods by analyzing transaction processing dates against a federal holiday calendar to identify one or more transactions processed on the federal holidays, identifying the one or more transactions processed on the weekends by comparing the transaction processing dates against one or more weekend date patterns, and categorizing the one or more transactions into business day transactions, weekend transactions, and federal holiday transactions;
applying partner-specific fee rate structures based on the categorized one or more transactions, wherein the business day transactions are assessed standard fee rates, the weekend transactions are assessed premium fee rates higher than the assessed standard fee rates, the federal holiday transactions are assessed holiday premium rates;
determining the interim fee for each partner by multiplying one or more transaction amounts by applicable fee rates for each transaction category, aggregating fee amounts across the categorized one or more transaction for each partner, and applying at least one of: partner-specific fee caps, minimums, and adjustment factors, to determine the interim fee for each partner;
validating the determined interim fee against one or more predefined rules and one or more partner agreement parameters to determine fee accuracy;
generating one or more interim fee records comprising partner identification, fee amount, calculation basis, and applicable time period; and
storing the generated interim fee records in the cloud storage buckets for subsequent reconciliation and partner settlement processes.
